(19) United States
(12) Patent Application Publication
(10) Pub. No.: US 2026/0352516 A1
(43) Pub. Date: Nov. 5, 2026

(54) CHANNEL ESTIMATION AND SECURITY ENHANCEMENT OF NARROW BAND MODULATED SIGNALS

(71) Applicants: DENSO International America, Inc., Southfield, MI (US); DENSO CORPORATION, Kariya (JP)

(72) Inventors: Kyle Golsch, Pontiac, MI (US); Eric Smith, Holland, MI (US); Mitchell Johnson, Grand Rapids, MI (US)

(21) Appl. No.: 19/574,961

(22) Filed: Mar. 23, 2026

Related U.S. Application Data
(60) Provisional application No. 63/794,538, filed on Apr. 25, 2025.

(51) Int. Cl. H04L 25/02; H04W 12/121

(52) U.S. Cl. CPC H04L 25/0202; H04W 12/121

(57) ABSTRACT

A system and method for securing a communication channel between devices are disclosed. A plurality of transmit signals are transmitted over the communication channel at different carrier frequencies. Corresponding receive signals are received and are used to estimate frequency-domain channel responses associated with the respective carrier frequencies. The frequency-domain channel responses are combined to generate a unified frequency-domain channel response spanning multiple carrier frequencies. An independently derived channel model, obtained using a channel measurement method independent of the transmitted signals, is also obtained. The unified frequency-domain channel response is compared with the independently derived channel model to detect differences in channel characteristics, including phase, slope, group delay, or amplitude. When a detected difference exceeds a threshold indicative of channel manipulation, a security action may be initiated.

### TECHNICAL FIELD

The present disclosure provides a system and method for estimating and securing a communication channel between devices, and for detecting security threats.

### BACKGROUND

Wireless systems typically transmit signals that consist of symbols. These symbols are often changed by a channel through which they pass, as the symbols propagate through an environment. An ideal channel can cause a time delay proportional to the distance of the channel divided by the speed of light, a phase delay proportional to the distance of the channel and the carrier frequency times a constant, and a loss of amplitude following generally the inverse square law in an open free space environment. Such a channel often does not alter the shape of the symbols, but instead causes a delayed copy of the signal with a reduced amplitude. Such a channel is often considered a linear channel, as it may have a linear phase response. However, most real channels consist of several paths, with each path having its own amplitude and phase. The phase response of the real channel can be the summation of each of the contributor paths and can be non-linear in its phase response. Such a real channel often causes a distortion of the shape of the symbol.

### SUMMARY

In general, one innovative aspect of the subject matter described herein can be embodied in a method of securing a communication channel between a first device and a second device. The method may include transmitting, by the first device, a plurality of transmit signals over the communication channel, the plurality of transmit signals including at least a first transmit signal at a first carrier frequency and a second transmit signal at a second carrier frequency different from the first carrier frequency. The method may include receiving, by the second device, corresponding plurality of receive signals resulting from propagation of the plurality of transmit signals over the communication channel, the plurality of receive signals including at least a first receive signal resulting from propagation of the first transmit signal over the communication channel and a second receive signal resulting from propagation of the second transmit signal over the communication channel. The method may include estimating, based on at least the first receive signal, a first frequency-domain channel response associated with the first carrier frequency, and estimating, based on at least the second receive signal, a second frequency-domain channel response associated with the second carrier frequency.

The method may include generating an estimated channel model by combining the first frequency-domain channel response and the second frequency-domain channel response into a unified frequency-domain channel response characterizing channel behavior across a frequency range spanning at least the first carrier frequency and the second carrier frequency. The method may include obtaining an independently derived channel model for the communication channel, and comparing the estimated channel model with the independently derived channel model.

The foregoing and other embodiments can each optionally include one or more of the following features, alone or in combination. In particular, one embodiment includes all the following features in combination.

In some aspects, estimating the first frequency-domain channel response may include computing a frequency-domain relationship between an estimated first transmit signal and the first receive signal.

In some aspects, the estimated first transmit signal may be based on demodulated data from the first receive signal.

In some aspects, the frequency-domain relationship may include a ratio of a frequency-domain representation of the first receive signal to a frequency-domain representation of the estimated first transmit signal.

In some aspects, the plurality of transmit signals may include round-trip time (RTT) packets exchanged between the first device and the second device.

In some aspects, combining the first frequency-domain channel response and the second frequency-domain channel response may include determining a first line of best fit representing the first frequency-domain channel response over a first frequency band associated with the first carrier frequency. The method may include determining a second line of best fit representing the second frequency-domain channel response over a second frequency band associated with the second carrier frequency, and applying an offset to at least one of the first line of best fit and the second line of best fit to reduce a phase discontinuity at a boundary between the first frequency band and the second frequency band. The method may include joining, after applying the offset, the first line of best fit and the second line of best fit across the first frequency band and the second frequency band.

In some aspects, comparing the estimated channel model with the independently derived channel model may include detecting that a difference in at least one of a channel phase, channel slope, channel group delay, and channel amplitude between the estimated channel model and the independently derived channel model exceeds a threshold indicative of channel manipulation.

In some aspects, the method may include initiating a security action when the threshold indicative of channel manipulation is exceeded.

In some aspects the method may include updating the estimated channel model based on the comparison between the estimated channel model and the independently derived channel model.

In some aspects, the method may include determining a confidence metric for the communication channel based on the comparison between the estimated channel model and the independently derived channel model.

In some aspects, the independently derived channel model may be generated using channel measurements obtained independently of the plurality of transmit signals.

In some aspects, the independently derived channel model may be generated using phase-based ranging.

In general, one innovative aspect of the subject matter described herein can be embodied in a system for securing a communication channel. The system may include a receiver configured to receive a plurality of receive signals resulting from propagation of a plurality of transmit signals over the communication channel. The plurality of transmit signals may include at least a first transmit signal at a first carrier frequency and a second transmit signal at a second carrier frequency different from the first carrier frequency, and the plurality of receive signals may include including at least a first receive signal resulting from propagation of the first transmit signal over the communication channel and a second receive signal resulting from propagation of the second transmit signal over the communication channel. The system may include a control system coupled to the receiver and configured to perform one or more of the following: estimate, based on at least the first receive signal, a first frequency-domain channel response associated with the first carrier frequency; estimate, based on at least the second receive signal, a second frequency-domain channel response associated with the second carrier frequency; generate an estimated channel model by combining the first frequency-domain channel response and the second frequency-domain channel response into a unified frequency-domain channel response characterizing channel behavior across a frequency range spanning at least the first carrier frequency and the second carrier frequency; obtain an independently derived channel model for the communication channel; and compare the estimated channel model with the independently derived channel model.

The foregoing and other embodiments can each optionally include one or more of the following features, alone or in combination. In particular, one embodiment includes all the following features in combination.

In some aspects, estimating the first frequency-domain channel response may include computing a frequency-domain relationship between an estimated first transmit signal and the first receive signal.

In some aspects, the estimated first transmit signal may be based on demodulated data from the first receive signal.

In some aspects, the frequency-domain relationship may include a ratio of a frequency-domain representation of the first receive signal to a frequency-domain representation of the estimated first transmit signal.

In some aspects, the plurality of transmit signals may include round-trip time (RTT) packets.

In some aspects, combining the first frequency-domain channel response and the second frequency-domain channel response may include determining a first line of best fit representing the first frequency-domain channel response over a first frequency band associated with the first carrier frequency. The method may include determining a second line of best fit representing the second frequency-domain channel response over a second frequency band associated with the second carrier frequency, and applying an offset to at least one of the first line of best fit and the second line of best fit to reduce a phase discontinuity at a boundary between the first frequency band and the second frequency band. The method may include joining, after applying the offset, the first line of best fit and the second line of best fit across the first frequency band and the second frequency band.

In some aspects, comparing the estimated channel model with the independently derived channel model may include detecting that a difference in at least one of a channel phase, channel slope, channel group delay, and channel amplitude between the estimated channel model and the independently derived channel model exceeds a threshold indicative of channel manipulation.

In general, one innovative aspect of the subject matter described herein can be embodied in a method of securing a communication channel. The method may include receiving a plurality of receive signals resulting from propagation of a plurality of transmit signals over the communication channel. The plurality of transmit signals including at least a first transmit signal at a first carrier frequency and a second transmit signal at a second carrier frequency different from the first carrier frequency, and the plurality of receive signals including at least a first receive signal resulting from propagation of the first transmit signal over the communication channel and a second receive signal resulting from propagation of the second transmit signal over the communication channel. The method may include estimating, based on at least the first receive signal, a first frequency-domain channel response associated with the first carrier frequency, and estimating, based on at least the second receive signal, a second frequency-domain channel response associated with the second carrier frequency. The method may include generating an estimated channel model by combining the first frequency-domain channel response and the second frequency-domain channel response into a unified frequency-domain channel response characterizing channel behavior across a frequency range spanning at least the first carrier frequency and the second carrier frequency. The method may include obtaining an independently derived channel model for the communication channel; and comparing the estimated channel model with the independently derived channel model.

The foregoing and other embodiments can each optionally include one or more of the following features, alone or in combination. In particular, one embodiment includes all the following features in combination.

These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components. Any reference to claim elements as “at least one of X, Y and Z” is meant to include any one of X, Y or Z individually, and any combination of X, Y and Z, for example, X, Y, Z; X, Y; X, Z; and Y, Z.

### BRIEF DESCRIPTION OF THE DRAWINGS

FIG. 1 is a schematic diagram illustrating an exemplary Round-Trip Time (RTT) estimation method between an Initiator device and a Reflector device.

FIG. 2 is a graphical representation of multi-frequency phase measurements and corresponding two-way and one-way channel responses derived from Phase Based Ranging (PBR).

FIG. 3 is a graphical representation illustrating an inverse Fourier transform (IFFT) recovery of path distances and amplitudes from a complex channel response.

FIG. 4 is a graphical representation illustrating improved IFFT-based path estimation using increased bandwidth.

FIG. 5 is a graphical representation illustrating further improved IFFT-based path resolution using additional bandwidth.

FIG. 6 is a graphical representation illustrating mirroring of a channel response to improve transform resolution.

FIG. 7 is a graphical representation illustrating conjugation of a concatenated channel response to improve distance resolution.

FIG. 8 is a schematic diagram illustrating a channel acting as a filter on transmitted packets.

FIG. 9 is a graphical representation illustrating a channel acting as a filter on transmitted packets, illustrating slope and delay characteristics of a channel response.

FIG. 10 is a graphical representation of a GFSK phase-modulated transmit signal x(t).

FIG. 11 is a schematic diagram illustrating transformation of a transmit signal x(t) into a received signal y(t) through a channel.

FIG. 12 is a graphical representation illustrating a delayed version of a transmit signal under a linear channel assumption.

FIG. 13 is a graphical representation illustrating phase shift effects introduced by a channel.

FIG. 14 is a schematic diagram illustrating time-domain transmit and time-domain receive signal representations.

FIG. 15 is a schematic diagram illustrating a signal model including transmitter noise and channel noise, which can be used for extraction of transmitter noise with channel compensation.

FIG. 16 is a graphical representation illustrating the relationship between time delay and frequency-domain slope of a channel response.

FIG. 17 is a schematic diagram illustrating propagation delay between a transmitter and receiver.

FIG. 18 is a graphical representation illustrating piecewise reconstruction of packet-derived frequency-domain channel responses across multiple carrier frequencies to form a unified frequency-domain channel response.

FIG. 19 is a zoomed-out graphical representation illustrating piecewise reconstruction of packet-derived frequency-domain channel responses across multiple carrier frequencies to form a unified frequency-domain channel response.

FIG. 20 is a full-band graphical representation illustrating piecewise reconstruction of packet-derived frequency-domain channel responses across multiple carrier frequencies to form a unified frequency-domain channel response.

FIG. 21 is a graphical representation illustrating estimated delay values as a function of frequency.

FIG. 22 is a graphical representation illustrating channel amplitude variation across frequency.

FIG. 23 is a graphical comparison of slope between a reconstructed channel response and an independently derived channel response.

FIG. 24 is a graphical representation illustrating phase of a GFSK signal which can be used for phase extraction.

FIG. 25 is a graphical representation illustrating phase shift and delay introduced by a propagation path.

FIG. 26 is a graphical representation illustrating time-varying phase difference between transmit and receive signals.

FIG. 27 is a graphical representation illustrating phase stabilization after timing alignment.

FIG. 28 is a graphical comparison between a reconstructed channel response and real channel phase response.

FIG. 29 is a zoomed-in graphical comparison illustrating reconstruction accuracy.

FIG. 30 is a graphical representation illustrating systematic DC phase offset.

FIG. 31 is a graphical representation illustrating timing error effects on slope discontinuity.

FIG. 32 is a graphical representation illustrating timing error in an opposite direction as FIG. 31.

FIG. 33 is a graphical representation illustrating increased timing error magnitude.

FIG. 34 is a graphical representation illustrating channel reconstruction using an idealized waveform with varying delay hypotheses.

FIG. 35 is a zoomed-in graphical representation of FIG. 34 illustrating curvature and slope differences under delay variation.

FIG. 36 is a block diagram from the Bluetooth specification illustrating a Normalized Attack Detector Metric (NADM) processing chain.

FIG. 37 is a graphical representation illustrating channel-induced distortion of symbol frequency.

FIG. 38 is a zoomed-in graphical representation of symbol overshoot caused by channel distortion.

FIG. 39 is a graphical comparison of time-aligned reference and distorted received signals.

FIG. 40 is a graphical comparison of a channel-corrected reference signal and received signal.

FIG. 41 is a zoomed-in graphical comparison illustrating improved symbol alignment after channel correction.

FIG. 42 is a graphical representation of channel phase and amplitude responses for a multi-path example.

FIG. 43 is a graphical representation illustrating improved symbol shape alignment after channel compensation.

FIG. 44 is a graphical frequency-domain comparison of corrected and uncorrected signals.

FIG. 45 is a graphical representation illustrating time-aligned but uncorrected pulse shapes.

FIG. 46 is a graphical representation illustrating corrected pulse shapes after channel compensation.

FIG. 47 is a graphical representation illustrating timing difference between corrected reference and received signals.

FIG. 48 is a graphical representation illustrating path estimation from a channel response sampled over a sufficient bandwidth.

FIG. 49 is a schematic diagram illustrating a transmit signal, transmitter noise, channel noise, and the resulting received signal after propagation through a channel.

FIG. 50 is a graphical comparison of reference and noisy delayed signals.

FIG. 51 is a zoomed-in graphical comparison of reference and noisy delayed signals.

FIG. 52 is a graphical representation illustrating timing alignment of reference and noisy signals.

FIG. 53 is a zoomed-in graphical comparison of reference and noisy delayed signals.

FIG. 54 is a graphical representation of extracted phase noise over time.

FIG. 55 is a graphical comparison of an extracted phase noise spectrum and an expected transmitter noise profile.

FIG. 56 is a graphical representation of concatenated unwrapped phase across multiple packets.

FIG. 57 is a graphical representation illustrating improved frequency resolution after packet concatenation.

FIG. 58 is a graphical representation of an extended phase noise spectrum after concatenating multiple packets.

FIG. 59 is a graphical representation illustrating channel filter bandwidth effects.

FIG. 60 is a graphical representation illustrating channel filter bandwidth effects, but with thermal noise impact.

FIG. 61 is a graphical representation illustrating channel filter bandwidth effects, but with elevated noise floor conditions.

FIG. 62 is a schematic diagram of an attacker attempting to advance symbol timing.

FIG. 63 is a graphical comparison of a true reference, a legitimate transmitter, an attacker input, and attacker output signals.

FIG. 64 is a graphical illustration of waveform glitches introduced by an attacker.

FIG. 65 is a graphical comparison of an expected transmitter noise profile and a measured transmitter noise profile under attack conditions.

FIG. 66 is a graphical comparison of an expected transmitter noise profile and a measured transmitter noise profile under attack conditions, illustrating frequency regions of deviation that indicate potential manipulation.

FIG. 67 is a graphical illustration of a measured transmitter noise profile under attack conditions.

FIG. 68 is a graphical comparison of a filtered attack waveform and reference signals.

FIG. 69 is a schematic representation of a negative group delay attack structure.

FIG. 70 is a schematic representation of an alternative negative group delay configuration.

FIG. 71 is a graphical representation of a notch-induced timing distortion at a selected frequency.

FIG. 72 is a graphical representation of channel amplitude exhibiting a deep fading notch.

FIG. 73 is a graphical representation of group delay behavior near a notch frequency.

FIG. 74 is a graphical representation of a RTT-extracted channel amplitude near a notch center frequency.

FIG. 75 is a graphical representation of a RTT-extracted channel phase near a notch center frequency.

FIG. 76 is a graphical representation of RTT-extracted channel amplitude at an offset frequency near a notch.

FIG. 77 is a graphical representation of RTT-extracted channel phase at an offset frequency near a notch.

FIG. 78 is a graphical representation illustrating effective bandwidth for valid channel extraction.

FIG. 79 is a system diagram illustrating sources of channel measurement data.

FIG. 80 is a block diagram illustrating conversion of channel measurement data into alternative channel representations.

FIG. 81 is a block diagram illustrating reconstruction of a channel model from delay, amplitude, or phase inputs.

FIG. 82 is a block diagram illustrating comparison between an estimated channel model and an independently derived channel model to one or more similarity or quality metrics.

FIG. 83 is a block diagram illustrating generation of an attack metric used to initiate corresponding security actions.

FIG. 84 shows a system in accordance with one embodiment of the present disclosure.

FIG. 85 shows a system in accordance with one embodiment.

FIG. 86 shows a device of the system in one embodiment.

FIG. 87 shows a portion of the device of the system in accordance with one embodiment.

FIG. 88 shows the system in accordance with one embodiment.

FIG. 89 shows the system in accordance with one embodiment.

FIG. 90 shows a device of the system in accordance with one embodiment.

### DETAILED DESCRIPTION

As indicated above, the present disclosure provides systems and methods for extracting a channel and confirming the channel from received modulated data.

### I. DEFINITIONS

As used herein, the following terms and definitions may be used.

The signal x(t) can be the time domain representation of a signal where t represents time in seconds. The signal x(t) can be the phase of a signal at particular time for Gaussian Frequency Shift Keying (GFSK) modulated signals.

The signal y(t) can be the time delayed (absolute time or real time) time domain representation of a signal where t represent time in seconds.

The value T can be the absolute time delay in seconds of a system, channel, or a system comprised of various components and a channel.

The relationship between x(t) and y(t) can be:

y(t)=x(t−T)

y(t+T)=x(t)

Radio Frequency signals are often modeled using complex numbers known as In-phase and Quadrature-phase abbreviated as IQ.

The signal x(t) can be the time domain real valued signal whereas s(t) can be the complex (IQ) representation of x(t) such that:

x(t)= [symbol] (s(t))

The function R returns the real values of a complex signal. Further:

s(t)=A*exp^{j*∠x(t)}

The function L above can return the angle of a signal in radians, and A encodes the amplitude. The amplitude could be time varying, in which case it would be denoted A(t). The constant j can represent the imaginary value i, where j=\sqrt{−1}.

In this specification, x(t) and y(t) often refer to s(t). x(t) and y(t) also often refer to the phase, frequency or amplitude of s(t), and may be discrete time. A typical radio may receive I and Q in discrete samples. When s(t) is the transmit signal, it is typically referred to as x(t). When s(t) is the receive signal, it is typically referred to as y(t).

### II. SYSTEM OVERVIEW

### II.A. Location System Overview

A system and method for determining location information of a remote device relative to an object based on a phase-based range or a time of flight may be provided in one embodiment. The system and method may determine a location of the remote device based on a range for first communications between a first object device (e.g., a sensor [also described as an anchor]) and the remote device and a range for the first communications monitored by a second object device (e.g., a sensor [also described as an anchor]). A clock difference may be determined between the first device and the second device, and the clock difference may form the basis for a range determination for the first communications monitored by the second object device. The clock difference may be determined repeatedly. The range may be based on a signal characteristic of communication determined with respect to the first communications, such as a determined phase rotation of the first communications between the remote device and the first object device, or a time of flight of communications between the remote device and the first object device.

In one aspect, the location of the remote device may be determined based on a range for second communications between the second object device and the remote device.

The object in one embodiment may be mobile, such that its environment may change depending on the location of the object. For instance, in the case of the object being a vehicle, the vehicle may be stored in an enclosed garage with a movable barrier at night, and then driven to and parked in an open-air parking lot, with one or more other vehicles in proximity thereto. The environmental configuration of these locations can vary in significant ways relative to RF or wireless communications, and the environmental configuration may vary in time even when the object is not moving relative to the environment. Such changes in the environment, as well as possible additional factors, may affect a clock difference between the first device on the second device relative to wireless communications. Additional examples of a system with adapting for environmental conditions is described in U.S. Pat. No. 10,869,161, entitled SYSTEM AND METHOD OF DETERMINING REAL-TIME LOCATION, issued Dec. 15, 2020, to Smith.

In one embodiment, a locator may be provided to determine the location information about the remote device relative to the object based on a signal characteristic of communications with the remote device. It should be understood that the present disclosure is not limited to determining the location information based on a single signal characteristic of communications; one or more additional signal characteristics of the communications may be used as a basis by the locator to determine the location information.

A locator 1310, as depicted in FIG. 87, may include a core function 1312 operable in conjunction with one or more parameters 1314 to determine the location information based on one or more inputs 1316, such as at least one signal characteristic of wireless communications, and to generate one or more outputs 1318 indicative of a location of a remote device 1020 relative to an object 1010. The values of the one or more parameters may be selected to yield location information for the remote device relative to the object with a degree of confidence for a given environment. For instance, the locator 1310 may be configured to determine the location of the remote device relative to the object in an open-air parking lot with no vehicles in proximity thereto or within 4 inches with a degree of confidence of 90% or better. In one embodiment, selecting the values of the one or more parameters may be based on empirical analysis, including obtaining truth data pertaining to an actual location of the remote device relative to the object along with, for each actual location, at least one sample of at least one signal characteristic. As discussed herein, the system may include a plurality of object devices disposed at different locations on the object, such that a plurality of signal characteristics of wireless communications can be obtained with respect to different positions on the object. The plurality of signal characteristics may be correlated with truth data pertaining to an actual location of the remote device relative to the object, and one or more parameters in conjunction with the core location function may be trained or selected to yield location information that approximates the truth data within a degree of confidence.

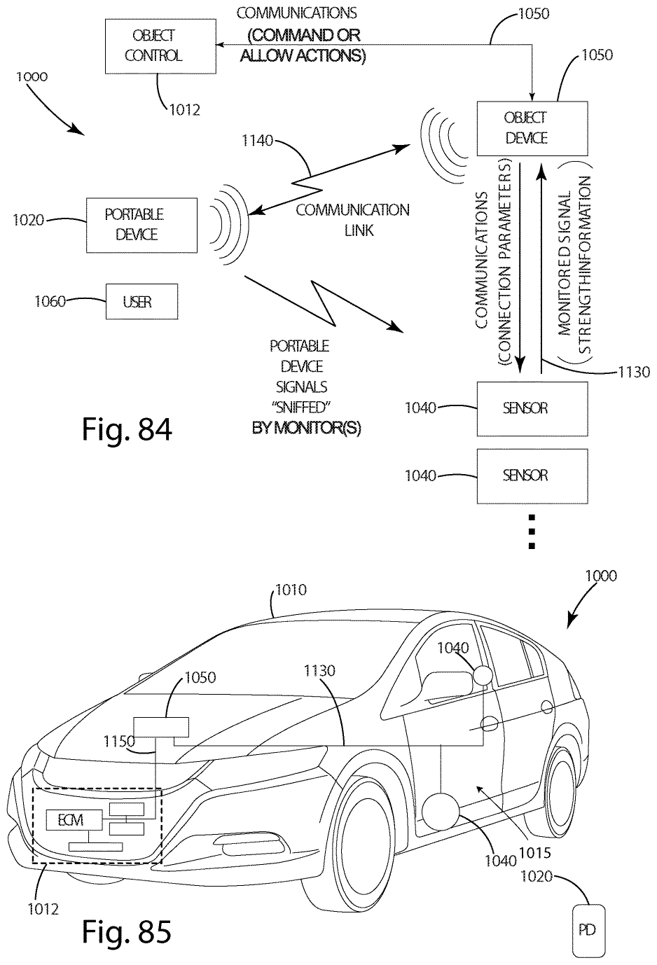

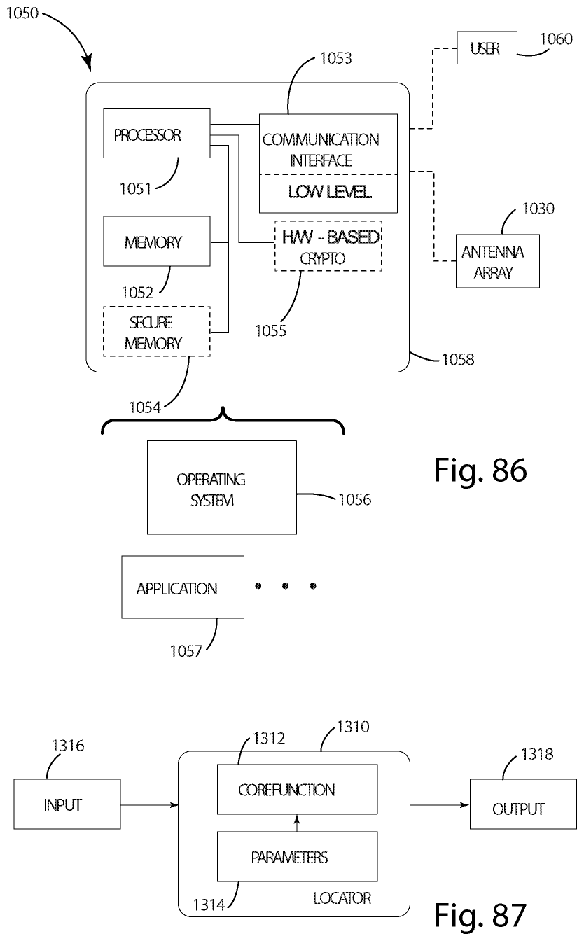

A system in accordance with one embodiment is shown in the illustrated embodiment of FIGS. 84, 85, and 88 and generally designated 1000. The system 1000 may include one or more system components as outlined herein. A system component may be a user 1060 or an electronic system component, which may be the remote device 1020, a sensor 1040, or an object device 1050, or a component including one or more aspects of these devices. The underlying components of the object device 1050, as discussed herein, may be configured to operate in conjunction with any one or more of these devices. In this sense, in one embodiment, there may be several aspects or features common among the remote device 1020, the sensor 1040, and the object device 1050. The features described in connection with the object device 1050 depicted in FIG. 86 may be incorporated into the remote device 1020 or the sensor 1040, or both. In one embodiment, the object device 1050 may form an equipment component disposed on an object 1010, such as a vehicle or a building. The object device 1050 may be communicatively coupled to one or more systems of the object 1010 to control operation of the object 1010, to transmit information to the one or more systems of the object 1010, or to receive information from the one or more systems of the object 1010, or a combination thereof. For instance, the object 1010 may include an object controller 1012 configured to control operation of the object 1010. The object 1010 may include one or more communication networks, wired or wireless, that facilitate communication between the object controller 1012 and the object device 1050. The communication network for facilitating communications between the object device 1050 and the object controller 1012 is designated 1150 in the illustrated embodiment of FIG. 85 and provided as a CAN bus; however, it is to be understood that the communication network is not so limited. The communication network may be any type of network, including a wired or wireless network, or a combination of two or more types of networks.

In the illustrated embodiment of FIG. 86, the object device 1050 may include a control system or controller 1058 configured to control operation of the object device 1050 in accordance with the one or more functions and algorithms discussed herein, or aspects thereof. The system components, such as the remote device 1020 or the sensor 1040, or both, may similarly include a controller 1058.

The controller 1058 may include electrical circuitry and components to carry out the functions and algorithms described herein. Generally speaking, the controller 1058 may include one or more microcontrollers, microprocessors, and/or other programmable electronics that are programmed to carry out the functions described herein. The controller 1058 may additionally or alternatively include other electronic components that are programmed to carry out the functions described herein, or that support the microcontrollers, microprocessors, and/or other electronics. The other electronic components include, but are not limited to, one or more field programmable gate arrays, systems on a chip, volatile or nonvolatile memory, discrete circuitry, integrated circuits, application specific integrated circuits (ASICs) and/or other hardware, software, or firmware. Such components can be physically configured in any suitable manner, such as by mounting them to one or more circuit boards, or arranging them in other manners, whether combined into a single unit or distributed across multiple units. Such components may be physically distributed in different positions in the object device 1050, or they may reside in a common location within the object device 1050. When physically distributed, the components may communicate using any suitable serial or parallel communication protocol, such as, but not limited to, CAN, LIN, Vehicle Area Network (VAN), FireWire, I2C, RS-232, RS-485, and Universal Serial Bus (USB).

As described herein, the terms locator, module, model, and generator designate parts of the controller 1058. For instance, a model or locator in one embodiment is described as having one or more core functions and one or more parameters that affect output of the one or more core functions. Aspects of the model or locator may be stored in memory of the controller 1058, and may also form part of the controller configuration such that the model is part of the controller 1058 that is configured to operate to receive and translate one or more inputs and to output one or more outputs. Likewise, a module or a generator are parts of the controller 1058 such that the controller 1058 is configured to receive an input described in conjunction with a module or generator and provide an output corresponding to an algorithm associated with the module or generator.

The controller 1058 of the object device 1050 in the illustrated embodiment of FIG. 86 may include one or more processors 1051 that execute one or more applications 1057 (software and/or includes firmware), one or more memory units 1052 (e.g., RAM and/or ROM), and one or more communication interfaces 1053, amongst other electronic hardware. The object device 1050 may or may not have an operating system 1056 that controls access to lower-level devices/electronics via a communication interface 1053. The object device 1050 may or may not have hardware-based cryptography units 1055—in their absence, cryptographic functions may be performed in software. The object device 1050 may or may not have (or have access to) secure memory units 1054 (e.g., a secure element or a hardware security module (HSM)). Optional components and communication paths are shown in phantom lines in the illustrated embodiment.

The controller 1058 in the illustrated embodiment of FIG. 86 is not dependent upon the presence of a secure memory unit 1054 in any component. In the optional absence of a secure memory unit 1054, data that may otherwise be stored in the secure memory unit 1054 (e.g., private and/or secret keys) may be encrypted at rest. Both software-based and hardware-based mitigations may be utilized to substantially prevent access to such data, as well as substantially prevent or detect, or both, overall system component compromise. Examples of such mitigation features include implementing physical obstructions or shields, disabling JTAG and other ports, hardening software interfaces to eliminate attack vectors, using trusted execution environments (e.g., hardware or software, or both), and detecting operating system root access or compromise.

For purposes of disclosure, being secure is generally considered as being confidential (encrypted), authenticated, and integrity-verified. It should be understood, however, that the present disclosure is not so limited, and that the term “secure” may be a subset of these aspects or may include additional aspects related to data security.

The communication interface 1053 may be any type of communication link, including any of the types of communication links described herein, including wired or wireless. The communication interface 1053 may facilitate external or internal, or both, communications. For instance, the communication interface 1053 may be coupled to or incorporate the antenna array 1030. The antenna array 1030 may include one or more antennas configured to facilitate wireless communications, including Bluetooth Low Energy (BTLE) communications.

As another example, the communication interface 1053 may provide a wireless communication link with another system component in the form of the remote device 1020, such as wireless communications according to the Wi-Fi standard. In another example, the communication interface 1053 may be configured to communicate with an object controller 1012 of a vehicle (e.g., a vehicle component) via a wired link such as a CAN-based wired network that facilitates communication between a plurality of devices. The communication interface 1053 in one embodiment may include a display and/or input interface for communicating information to and/or receiving information from the user 1060.

In one embodiment, the object device 1050 may be configured to communicate with one or more auxiliary devices other than another object device 1050 or a user. The auxiliary device may be configured differently from the object device 1050—e.g., the auxiliary device may not include a processor 1051, and instead, may include at least one direct connection and/or a communication interface for transmission or receipt, or both, of information with the object device 1050. For instance, the auxiliary device may be a solenoid that accepts an input from the object device 1050, or the auxiliary device may be a sensor (e.g., a proximity sensor) that provides analog and/or digital feedback to the object device 1050.

The system 1000 in the illustrated embodiment may be configured to determine location information in real-time with respect to the remote device 1020. In the illustrated embodiment of FIGS. 84, 85, and 88, the user 1060 may carry the remote device 1020 (e.g., a smartphone). The system 1000 may facilitate locating the remote device 1020 with respect to the object 1010 (e.g., a vehicle) in real-time with sufficient precision to determine whether the user 1060 is located at a position at which access to the object 1010 or permission for an object command should be granted.

For instance, in an embodiment where the object 1010 is a vehicle, the system 1000 may facilitate determining whether the remote device 1020 is outside the vehicle but in close proximity, such as within 5 feet, 3 feet, or 2 feet or less, to the driver-side door 1015. This determination may form the basis for identifying whether the system 1000 should unlock the vehicle. On the other hand, if the system 1000 determines the remote device 1020 is outside the vehicle and not in close proximity to the driver-side door (e.g., outside the range of 2 feet, 3 feet, or 5 feet), the system 1000 may determine to lock the driver-side door. As another example, if the system 1000 determines the remote device 1020 is in close proximity to the driver-side seat but not in proximity to the passenger seat or the rear seat, the system 1000 may determine to enable mobilization of the vehicle. Conversely, if the remote device 1020 is determined to be outside close proximity to the driver-side seat, the system 1000 may determine to immobilize or maintain immobilization of the vehicle.

The object 1010 may include multiple object devices 1050 or variant thereof, such as an object device 1050 including a sensor 1040 coupled to an antenna array 1030, in accordance with one or more embodiments described herein.

Micro-location of the remote device 1020 may be determined in a variety of ways, such as using information obtained from a global positioning system, one or more signal characteristics of communications from the remote device 1020, and one or more sensors (e.g., a proximity sensor, a limit switch, or a visual sensor), or a combination thereof. An example of microlocation techniques for which the system 1000 can be configured are disclosed in U.S. Nonprovisional patent application Ser. No. 15/488,136 to Raymond Michael Stitt et al., entitled SYSTEM AND METHOD FOR ESTABLISHING REAL-TIME LOCATION, filed Apr. 14, 2017—the disclosure of which is hereby incorporated by reference in its entirety.

In one embodiment, in the illustrated embodiment of FIGS. 84-90, the object device 1050 (e.g., a system control module (SCM)) and a plurality of sensors 1040 (coupled to an antenna array 1030 as shown in FIG. 86) may be disposed on or in a fixed position relative to the object 1010. Example use cases of the object 1010 include the vehicle identified in the prior example, or a building for which access is controlled by the object device 1050.

The remote device 1020 may communicate wirelessly with the object device 1050 via a communication link 1140. The plurality of sensors 1040 may be configured to monitor (e.g., sniff) the communications of the communication link 1140 between the remote device 1020 and the object device 1050 to determine one or more signal characteristics of the communications, such as a phase characteristic, a signal strength, a time of arrival, a time of flight, or an angle of arrival, or a combination thereof. The determined signal characteristics may be communicated or analyzed and then communicated to the object device 1050 via a communication link 1130 separate from the communication link between the remote devices 1020 and the object device 1050. Additionally, or alternatively, the remote device 1020 may establish a direct communication link with one or more of the sensors 1040, and the one or more signal characteristics may be determined based on this direct communication link.

The one or more sensors 1040 may be disposed in a variety of positions on the object 1010, such as the positions described herein, including for instance, one or more sensors 1040 in the door panel and one or more other sensors in the B pillar.

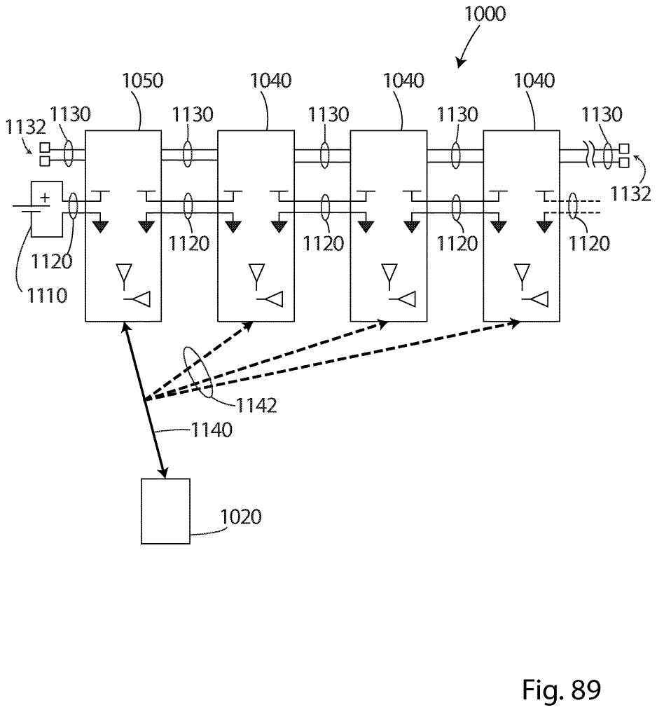

The object device 1050 and the one or more sensors 1040 may be powered via a power bus 1120. The power bus 1120 may be daisy chained from one device to the next as depicted in the illustrated embodiment of FIG. 89. Alternatively, the power bus 1120 may be provided in the form of a star connection with power being supplied from one location to multiple locations via separate connections. Power supply and associated architecture is not limited to any one type for instance, power may be distributed via both daisy chain and star connection configurations. The power bus 1120 may be coupled to a power supply 1110 to facilitate distributing power to devices in the system 1000.

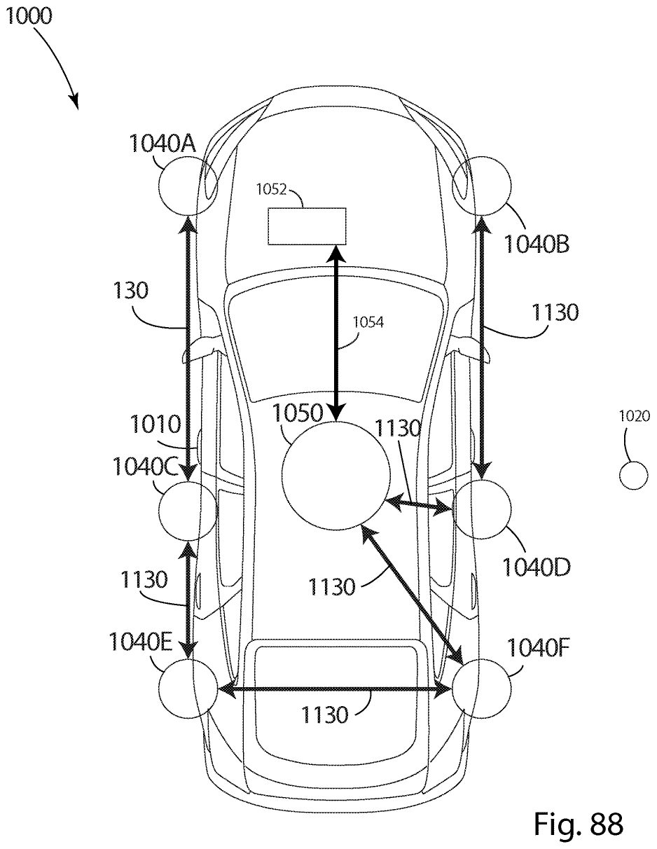

The system 1000 in the illustrated embodiment may be configured to determine location information in real-time with respect to the remote device 1020. In the illustrated embodiment of FIG. 88, a user may carry the remote device 1020 (e.g., a smartphone). The system 1000 may facilitate locating the remote device 1020 with respect to the object 1010 (e.g., a vehicle) in real-time with sufficient precision to determine whether the user is located at a position at which access to the object 1010 or permission for an object 1010 command should be granted.

In the illustrated embodiment of FIG. 89, the communication link 1130 is distributed from one device to another and includes a terminator 1132 at each end. The communication link 1130 among the devices may be a shared link or a separate link for each device, or a combination thereof. For instance, the communication link 1130 may be shared among two or more devices as depicted, and additionally or alternatively, the communication link 1130 may be established separately from one device to another device. A device may communicate via more than one separate communications link 1130, and may be configured to relay communications from one communication link 1130 to another communication link 1130.

The remote device 1020 may communicate wirelessly with the object device 1050 via a communication link 1140, such as a BLE communication link or an Ultra-Wideband (UWB) communication link. The plurality of sensors 1040 may be configured to monitor (sniff) the communications of the communication link 1140 between the remote device 1020 and the object device 1050 as shown in phantom lines 1142. The monitored communications or transmissions may correspond to a tone exchange (one-way or two-way) between the object device 1050 and the remote device 1020. Based on the monitored communications, a sensor 1040 may determine one or more signal characteristics of the communications as described herein, including a phase characteristic of the communications. Additional or alternative signal characteristics include a signal strength, time of arrival, time of flight, angle of arrival, or a combination thereof. The determined signal characteristics may be communicated or analyzed and then communicated to the object device 1050 via the communication link 1130 separate from the communication link 1140 between the remote device 1020 and the object device 1050.

Additionally, or alternatively, as described herein, the remote device 1020 may establish a direct communication link with one or more of the sensors 1040, and the one or more signal characteristics may be determined based on this direct communication link. For instance, as described herein, the remote device 1020 and a sensor 1040 may perform a tone exchange as a basis for determining a distance between the sensor 1040 and the remote device 1020. The direct communication link may be established according to the BLE protocol; however, the present disclosure is not so limited—the direct communication link may be any type of link or links, including Ultra-Wideband (UWB).

It is to be understood that an object 1010, such as a vehicle, may include a number of sensors 1040 (A-F) that can be greater than or less than the number shown in the illustrated embodiment of FIGS. 84 and 85. Depending on the implementation, some number of sensors 1040 may be integrated in a vehicle.

As described herein, one or more signal characteristics, such as a phase characteristic, a signal strength, time of arrival, time of flight, and angle of arrival, may be analyzed to determine location information about the remote device 1020 relative to the object 1010, as an aspect of the object 1010, or the object device 1050, or a combination thereof. For instance, a phase rotation of a tone transmission, and optional re-transmission, or a phase characteristic indicative of a phase rotation may form the basis for determining a distance between an object device 1050 or a sensor 1040 and the remote device 1020. Additional examples of signal characteristics include time difference of arrival or the angle of arrival, or both, among the sensors 1040 and the object device 1050 may be processed to determine a relative position of the remote device 1020. The positions of the one or more antenna arrays 1030 relative to the object device 1050 may be known so that the relative position of the remote device 1020 can be translated to an absolute position with respect to the antenna arrays 1030 and the object device 1050.

Additional or alternative types of signal characteristics may be obtained to facilitate determining position according to one or more algorithms, including a distance function, trilateration function, a triangulation function, a lateration function, a multilateration function, a fingerprinting function, a differential function, a time of flight function, a time of arrival function, a time difference of arrival function, an angle of departure function, a geometric function, or any combination thereof.

### II.B. System Device Overview

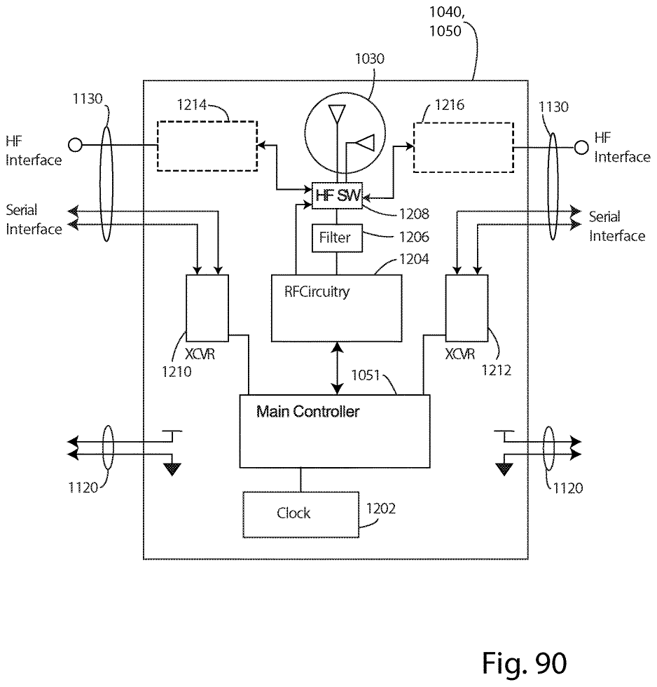

In the illustrated embodiment of FIG. 90, the object device 1050 in one aspect is shown in further detail. The structure and configuration of described in conjunction with FIG. 90 may be incorporated into a sensor 1040 or an object device 1050—but for purposes of disclosure, the structure and configurations described in conjunction with the object device 1050.

The object device 1050 in the illustrated embodiment of FIG. 90 includes several components, one or more of which may be provided in a commercial embodiment. The object device 1050 in some instances may be described as an anchor disposed on the object 1010.

The object device 1050 may include RF circuitry 1204 operable to control transmission and reception of HF signals. The RF circuitry 1204 may be operably coupled to an antenna array 1030, which may include one or more antennas. An example configuration of an antenna array 1030 is described in U.S. Nonprovisional patent application Ser. No. 18/096,666 to Osman Ahmed et al., entitled SYSTEM AND METHOD FOR COMMUNICATING, filed Jan. 13, 2023—the disclosure of which is incorporated herein by reference in its entirety.

The RF circuitry 1204 may be configured to supply or receive high-frequency signals from the antenna array 1030 via filter circuitry 1206 and a HF switch 1208. The filter circuitry 1206 may condition the signal output from the RF circuitry 1204 for driving the antenna array 1030. Conversely, the filter circuitry 1206 may condition a signal received from the antenna array 1030 for processing by the RF circuitry 1204. The HF switch 1208 may selectively direct input and output of HF signals, including HF supplied to and received from the antenna array 1030.

In one embodiment, the RF circuitry 1204 may be configured according to one embodiment to transmit and receive signals via a high-frequency interface of the communication link 1130. Transmission and reception of HF signals in one embodiment may enable an object device 1050 to communicate via a physical medium according to a communication protocol that is the same or similar to the one utilized by the antenna array 1030 in the RF circuitry 1204. For instance, the object device 1050 may transmit and receive communications via a physical medium defined by the high-frequency interface that correspond to the BTLE communications, while also transmitting and receiving communications via the antenna array 1030 that correspond to BTLE communications.

The HF switch 1208 may selectively direct output from the RF circuitry 1204 to the high-frequency interface of the communication link 1130, and selectively direct input from the high-frequency interface of the communication link 1130 to the RF circuitry 1204. In one embodiment, the HF interface may be a single ended configuration, such as a coaxial conductor arrangement. Alternatively, the HF interface may be differential, and optionally include conditioning circuitry 1214, 1216 (e.g., a balun and/or an impedance transformer) for translating between a single ended output from the HF switch 1208 and a differential output of the high-frequency interface of the communication link 1130.

In one embodiment, the high frequency switch 1208 and the conditioning circuitry 1214, 1216 may be absent, such that the communication link 1130 is provided via a serial interface or another type of communication interface, as described herein.

In the illustrated embodiment, the object device 1050 is configured to transmit and receive communications via separate high-frequency interfaces provided by separate communication links 1130. In other words, the two communication links 1130 in the illustrated embodiment are isolated from each other, such that communications received on one communication link 1130 are not inherently transmitted or seen on the other communication link 1130. As discussed herein, the object device 1050 may be configured to relay communications from one of the communication links 1130 to the other of the communication links 1130. For example, communications received via one high-frequency interface may be directed to the RF circuitry 1204, and may be related to the other high-frequency interface via the RF circuitry 1204. The HF switch 1208 may be in transition from one state to another state to facilitate relaying of such communications. It is to be understood, however, that in one or more embodiments described herein, communications transmitted via one of the communication links 1130 may inherently pass to the other of the communication links 1130.

The object device 1050 may include a main controller 1051 and may be configured to direct operation of the RF circuitry 1204, as described herein. In one embodiment, the main controller 1051 may control a tone exchange via the antenna array 1030 to facilitate determining a one-way range or two-way range determination with respect to the remote device 1020. Additionally, or alternatively, the object device 1050 may sniff communications that pertain to a tone exchange and that occur between another object device (e.g., a sensor 1040) and the remote device 1020. In one embodiment, a sensor 1040 may be configured to monitor or sniff communications that pertain to a tone exchange and that occur between the object device 1050 and the remote device 1020.

The main controller 1051 may further direct transmission and reception of communications via the HF interface of the one or more communication links 1130. As an example, the main controller 1051 may direct transmission and reception of BTLE communications via the HF interface of the communication link 1130. Information transmitted via the high-frequency interface of the communication links 1130 may relate to one or more signal characteristics obtained with respect to communications received and/or transmitted via the antenna array 1030. As an example, the information transmitted via the communication link 1130 may be indicative of a range determined with respect to communications received and/or transmitted via the antenna array 1030.

Additionally, or alternatively, the main controller 1051 may utilize the high-frequency interface of the communication links 1130 for time synchronization or time offset determination purposes. As discussed herein, a phase characteristic of a tone exchange is based at least in part on a time reference of the device. And because time is translatable to distance (and conversely distance to time) with respect to electromagnetic waves, determining the reference time of the sensor 1040 may facilitate enhancing accuracy with respect to determining the phase characteristic and distance between the remote device 1020 and the object device 1050.

The object device 1050 may include a clock 1202 that operates an oscillator for the sensor 1040 and generates one or more timing signals for operation of aspects of the object device 1050, including the main controller 1051 and the RF circuitry 1204. In one embodiment, the clock 1202 may be configured to generate a timing signal that the main controller 1051 and/or the RF circuitry 1204 may use as a basis for transmitting a tone exchange signal (e.g., an initiator signal). As described herein, the tone exchange signal may include transmissions according to a plurality of frequencies and a phase rotation with respect to such transmissions and may form the basis for a distance determination with respect to the object device 1050 and the remote device 1020.

In one embodiment, the object device 1050 includes first and second transceivers 1210, 1212 coupled respectively to serial interfaces of the communication links 1130. The transceivers 1210, 1212 may be CAN transceivers, but the present disclosure is not so limited. The transceivers 1210, 1212 may facilitate any type of serial or non-serial communications via the communication links 1130, including but not limited to RS-485, LIN, Vehicle Area Network (VAN), FireWire, I2C, RS-232, RS-485, and Universal Serial Bus (USB).

The first and second transceivers 1210, 1212 may enable communications among devices (e.g., the object device 1050 and a sensor 1040). For instance, the object device 1050 may transmit to a sensor 1040, via the serial interface of the communication link 1130, connection parameters for the communication link 1140 to enable the sensor 1040 to monitor communications between the object device 1050 and the remote device 1020. A sensor 1040 may receive such communications via the first transceiver 1210 and relay the communications to another device (e.g., another sensor 1040) via the second transceiver 1212.

Optionally, the object device 1050 may include a communication link 1130 configured with a serial interface without the high-frequency interface or a high-frequency interface without the serial interface. Communications described herein with respect to one interface and not the other may be communicated via the interface provided by the communication link 1130. For instance, the communication link 1130 may include a high-frequency interface without the serial interface, and communications described in connection with the serial interface may be transmitted via the high-frequency interface. The high frequency interface and/or the serial interface may be wired or wireless.

The communication interface of the main controller 1051 may facilitate any type of communication link, including any of the types of communication links described herein, including wired or wireless. The communication interface may facilitate external or internal, or both, communications. For instance, the communication interface may be coupled to the RF circuitry 1204 to enable communications via one or more of the antenna array 1030 and the HF interface of the communication link 1130.

As another example, the communication interface of the main controller 1051 may facilitate a wireless communication link with another system component in the form of the remote device 1020, such as wireless communications according to the Wi-Fi standard or UWB, or any combination thereof. As another example, the communication interface of the main controller 1051 may include a display and/or input interface for communicating information to and/or receiving information from the user.

### III. INDEPENDENT CHANNEL MEASUREMENT METHODS

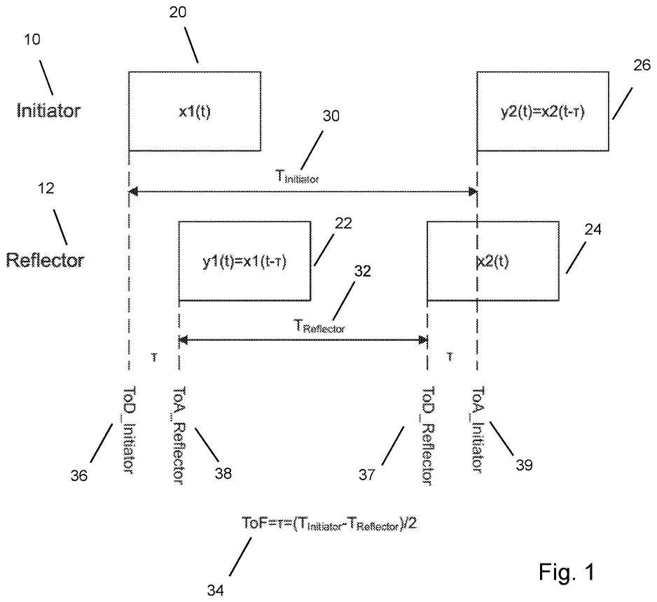

One independent channel measurement method is Round-Trip Time (RTT) estimation. RTT estimation may be used in systems such as Ultrawide Band or Bluetooth Channel Sounding. An exemplary RTT estimation method is depicted in FIG. 1, in which an initiator 10 communicates with a reflector 12. The initiator 10 and the reflector 12 may correspond to devices in the system 1000, and the role of the initiator 10 and the reflector 12 for devices in the system 1000 may be static or dynamic depending on the configuration. For instance, the remote device 1020 may be operable as the initiator 10, and the object device 1050 or a sensor 1040 may be operable as the reflector 12. The initiator 10 and the reflector 12 may be reversed in some modes, for example, with the remote device 1020 being operable as the reflector 12 and the object device 1050 or a sensor 1040 being operable as the initiator 10.

In a RTT system, a device known as the initiator 10 may transmit first and listen second, and a device known as the reflector 12 may listen first and transmit second. The initiator 10 can be aware of its transmit time (ToD_Initiator 36) in its local clock of a transmit packet x1(t) 20. The reflector 12 can receive a time delayed copy of x1(t) 20 known as y1(t) 22 and can perform a timing estimation of the receive time of y1(t) 22 (ToA_Reflector 38) in its local clock. The roles may then be reversed, and the reflector 12 can be aware of its transmit time (ToD_Reflector 37) in its local clock of a transmit packet x2(t) 24. The initiator 10 can receive a time delayed copy of x2(t) 24 known as y2(t) 26 and can perform a timing estimation of the receive time of y2(t) 26 (ToA_Initiator 39) in its local clock. The difference between ToA_Initiator 39 and ToD_Initiator 36 is known as T_{Initiator} 30 and the difference between ToA_Reflector 38 and ToD_Reflector 37 is known as T_{Reflector} 32. In many implementations, the propagation delay between the initiator 10 and reflector 12 and between the reflector 12 and the initiator 10 can be assumed to be symmetric; therefore, the following equation may be true:

$$ToF 34 = τ = \frac{{T}_{{Initiator}^{30}} - {T}_{{Reflector}^{32}}}{2} .$$

If the initiator 10 and reflector 12 share their local time stamps with each other or any third party device, τ can be estimated, and τ can be equivalent to the Time of Flight (ToF) 34. Therefore, the initiator 10 and reflector 12 can have an expectation about the delay of the channel through which the corresponding x1(t) 20 and x2(t) 24 signals have passed. This process is depicted in FIG. 1.

To solve for the Time of Flight (ToF) 34, each receiver often must estimate the time of arrival of the signal. In a typical Channel Sounding system, the series of symbols to be exchanged may be known a priori via a cryptographic random number generation process. However, even if the symbols are not known a priori, the symbols can still be timed based upon demodulation of the received signal. Once the set of expected/received symbols is known, a reference signal can be produced. By using a correlation method such as cross correlation, a peak correlation can be determined. A brief description of an exemplary timing estimation is described below:
1. Convert x(t) into xf(t), which is a time domain signal of the frequency, by differentiating the phase
2. Convert y(t) into yf(t), which is a time domain signal of the frequency, by differentiating the phase
3. Perform a cross correlation of xf(t) and yf(t), where the correlation peak is the timing offset.

Often, the sampling rate of x(t) and y(t) in discrete time form is insufficiently precise; therefore, an interpolation technique or best peak fit of the samples nearby the peak may be used to estimate the true peak. A polynomial fit may be used. The result of the timing estimation can be the Time of Flight estimate. When τ is used in this specification, it is often equivalent to the Time of Flight, or the Time of Flight is often a reasonable estimate of τ.

Another independent channel measurement method is Phase Based Ranging (PBR) estimation. An example of Phase Based Ranging is defined in the Bluetooth Core Spec 6.0 under the Channel Sounding subsections. In such a system, a carrier wave can be transmitted in a Mode-2 packet from an Initiator Device to a Reflector Device. The Reflector can take a phase measurement of the incoming Carrier Wave and then responds with its own Carrier Wave to the Initiator. The Initiator can take a phase measurement of the incoming Carrier Wave. The local phase measurements of the Initiator and Reflector can be aggregated onto an arbitrary computing node, which may be the Initiator, the Reflector, both, or any set of third-party computing nodes. The two-way channel model for a given frequency can be derived by adding the Initiator and Reflector phase. In the complex IQ domain, addition can be achieved by multiplication of the two IQ measurements, which can result in adding the phase. This process can be repeated across multiple frequencies, which can have the effect of removing the difference in the phase of the Initiator and Reflector. The one-way channel model can therefore be computed by solving the square root of the two-way channel model, handling any ambiguities. Methods for computing the one-way channel model from the Initiator and Reflector measurements are well known within the Channel Sounding community, and is the basis for functional Channel Sounding systems. This process is known as Channel Reconstruction.

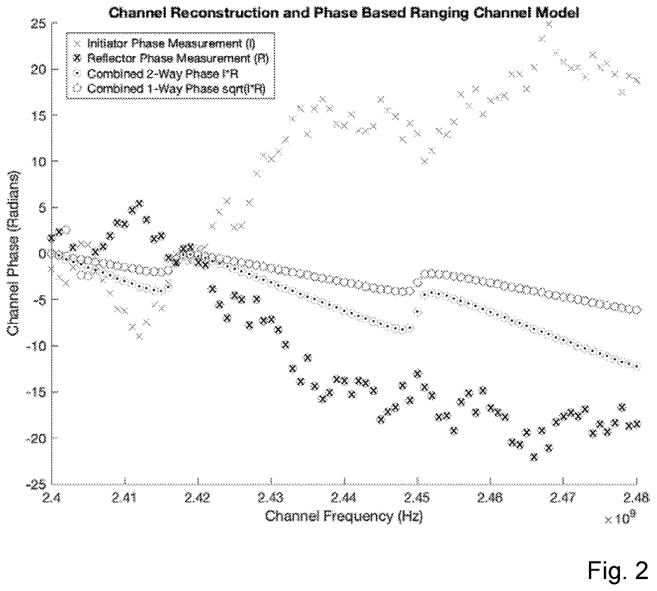

FIG. 2 depicts an exemplary Phase Based Ranging estimation method and respective Initiator and Reflector phase measurement values. In the exemplary PBR method of FIG. 2, a path of 3 meters with an amplitude of 1.0 is combined with a path of 12 meters with an amplitude of 0.9. The ‘x’ marks are the phase measurements of the Initiator, and the ‘ox’ marks are the phase measurements of the Reflector. The x-axis is the frequency of the channel, and the y-axis is the phase. The random jumps may be caused by the Initiator and Reflector radios not having a synchronized phase, and the relative phase offset between the Initiator and Reflector may be changed each time the radios change their frequency. The ‘o-dot’ markers represent the two way phase response of the channel, which may be obtained by multiplying (adding the phase of) the Initiator's and Reflector's phase measurements. The ‘o’ markers represent the one-way phase, or simply Channel Response or Channel Model, which may be obtained by taking the square root of the two-way phase response.

FIG. 2 depicts the phase representation of the channel. The respective amplitude representation of the channel is not shown. The phase representation has a local slope, which when multiplied by −1 may be the group delay of the channel for the given frequency.

Channel Sounding may work by converting the phase measurements or group delays into an estimated distance. One common technique to do so is to compute the inverse-FFT (IFFT) of the complex channel response. The complex channel response may consist of several individual paths mixing.

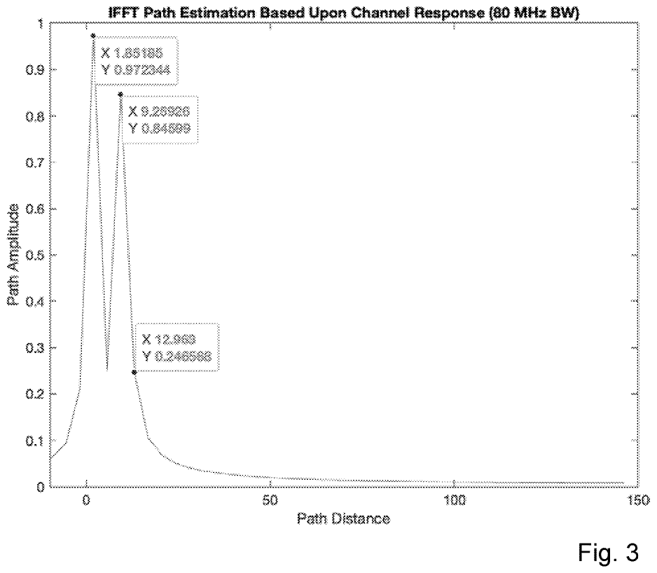

FIG. 3 depicts an exemplary IFFT path estimation that converts the phase measurements or group delays into an estimated distance. FIG. 3 illustrates that an IFFT algorithm can recover a reasonable estimation of original path distances and amplitudes. Each path may add a rotational component to the complex channel response.

The channel response for any given frequency may be represented by the following equation:

$${ChannelResp}_{Complex} ( f ) = {\sum }_{p = 1}^{N} {exp}^{- j 1 * \frac{2 π f * {D}_{p} + {φ}_{p}}{c}}$$

In the above equation, f is the channel frequency in Hz, c is the speed of light through the medium (~300e6 m/s for a vacuum), Dₚ is the distance in meters for the path p, and φₚ is a phase shift associated with path p that can model both phase shift due to propagation delays and phase shifts due to reflections that are independent from the distance. For each frequency f, the complex channel value can be a super-position of all the contributions from each path. The above equation may be referred to as the ChannelResp_{Complex}(f) function or the Complex Channel Response function.

The Complex Channel Response function is a frequency domain representation of the channel. Each measurement is the amplitude and phase response organized by frequency. The frequency domain representation can be converted into a time domain representation using the Inverse Fourier Transform, in discrete systems. Typically this is performed using the Inverse Fast Fourier Transform (IFFT).

The maximum observable distance may be given by the frequency spacing of the channel measurements. This is a similar concept as the Nyquist rate for discrete time signals. The larger the frequency spacing, the shorter the distance will be that may cause an overflow in phase of the Channel Response.

The maximum measurable time delay can be represented by the following equation:

$${T}_{max} = \frac{1}{Δ f}$$

In the above equation, Tₘₐₓ is the maximum time delay given the channel frequency spacing, Δf. The channel frequency spacing, Δf, for a typical Channel Sounding system may be 1 MHz; therefore, the maximum observable time delay in a one-way channel response may be 1 μs, which can correspond to approximately 300 meters in distance, when approximating the speed of light as 300e6 meters per second. Because there is an intermediate step involving the measurement of a two-way channel response, the typical ambiguity distance may be 150 meters one-way.

The resolution of each time bin may be set by the number of frequencies that are measured. Given a fixed frequency spacing, the number of frequencies may also determine the bandwidth of the channel measurement. The bandwidth of the channel may be given by the following equation:

BW=Δf×N

In the above equation, BW is the bandwidth. The larger the bandwidth, the better the frequency resolution will be. The frequency resolution of each bin may be given by the following equation:

$$Δ τ = \frac{{T}_{max}}{N}$$

In the ISM band and in Channel Sounding, N may be ~=80 due to the 80 MHz of available bandwidth. Channel Sounding may use slightly fewer N, for example to avoid frequencies at the band edge. In many of the examples described herein, frequencies from 2400 to 2480 MHz inclusive on a 1 MHz grid are used, which may lead to N=81. However, it should be understood that other frequencies and N may be used.

To compute the time, and therefore the distance, of each frequency bin, the following equation can be used:

dₖ=c·k·Δτ

In the above equation, dₖ is the distance for frequency bin k.

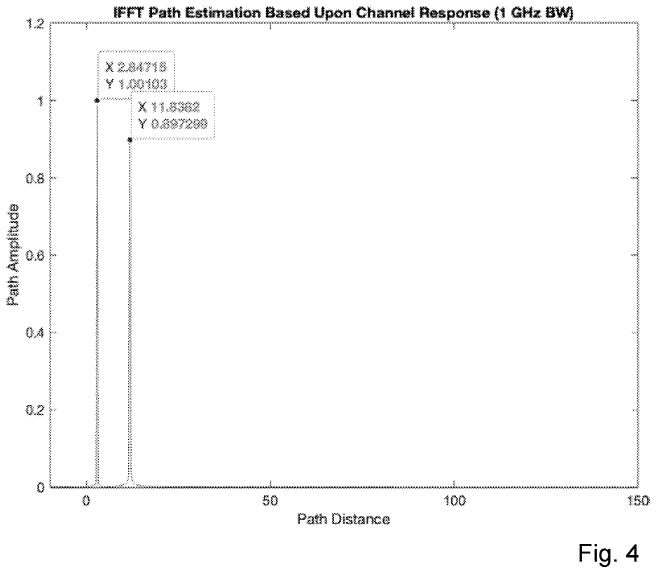

FIG. 3 depicts a result of taking the IFFT for the exemplary 3 and 12 meter path example from FIG. 2. The correct distances are expected to be 3 and 12 meters, and the amplitudes are expected to be 1.0 and 0.9. As depicted in FIG. 3, the limited frequency resolution causes energy to leak into adjacent bins. FIG. 4 depicts an improved result of taking the IFFT for the exemplary 3 and 12 meter path example from FIG. 2, but using 1 GHz of bandwidth instead of 80 MHz.

With the additional bandwidth, the resolution can be greatly improved with less leakage. However, the peaks may still be in the incorrect position, as depicted in FIG. 4.

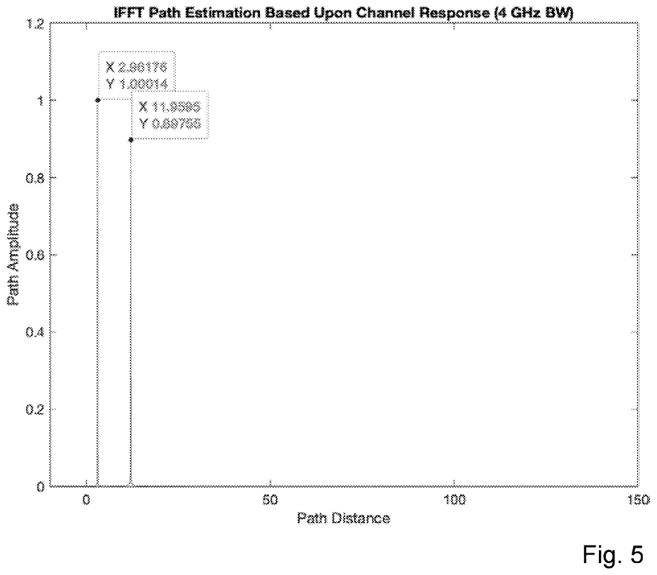

FIG. 5 depicts an improved result of taking the IFFT for the exemplary 3 and 12 meter path example from FIG. 2, but using 4 GHz of bandwidth instead 1 GHz or 80 MHz. FIG. 5 depicts that by increasing the bandwidth to 4 GHz, the peak detection may be nearly perfect. Therefore, IFFT can recover the path model correctly from the channel response.

The IFFT method described above demonstrates that the relative path distances and power or amplitude of the respective paths can be estimated from the channel. That is, the system can have an expectation of the channel from a PBR measurement.

The IFFT method, a time/frequency technique, is not the only technique that can be used to estimate the channel. For example, Least Squares of Pilot Wave or Minimum Mean Squared Error of noise and channel covariance are other examples. Subspace methods, such as Multiple Signal Classification (MUSIC) or ESPIRIT, are another family of algorithms that can be used to estimate the channel. The Bayesian family of algorithms such as Kalman filters, Particle filters, or Compressed sensing may be helpful for time varying channels. Machine learning algorithms such as Neural networks could also be used to estimate the channel parameters. The phase-based ranging measurements in Channel Sounding can be passed to an algorithm that estimates which paths are present in the channel.

Mirroring is a technique that may improve the resolution of a Discrete Fourier Transform. By mirroring, the number of data points may be doubled, and the spectral content may be unchanged since the mirrored data is identical to the original data. By concatenating the complex channel response with a frequency reversed channel response, a mirrored channel response can be computed using the following equation:

ChannelResp_{mirrored1}=concatenate(ChannelResp_{Complex},fliplr(ChannelResp_{Complex}).

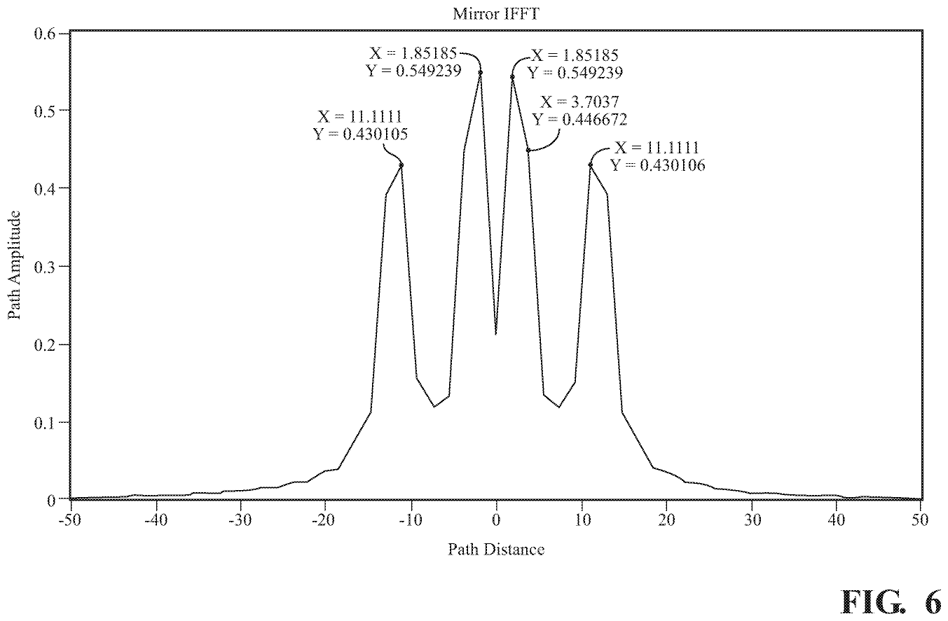

FIG. 6 depicts the result of mirroring. As depicted, there may be a slight improvement in the bin size, the rotational components are positive and negative in frequency, and the amplitude is cut in half which may be due to half of the energy being assigned to the negative distances. However, as is also depicted in FIG. 6, a peak interpolation technique may provide a reasonable estimate for the true paths.

It is possible to shift the negative distances to the positive side of the axis as expected in a real system where the distances cannot be negative. Before concatenating, the original channel response data may be flipped left to right and conjugated before concatenating with the original unmodified channel response per the following equation:

ChannelResp_{mirrored}=concatenate(ChannelResp_{Complex},conj(fliplr(ChannelResp_{Complex}))

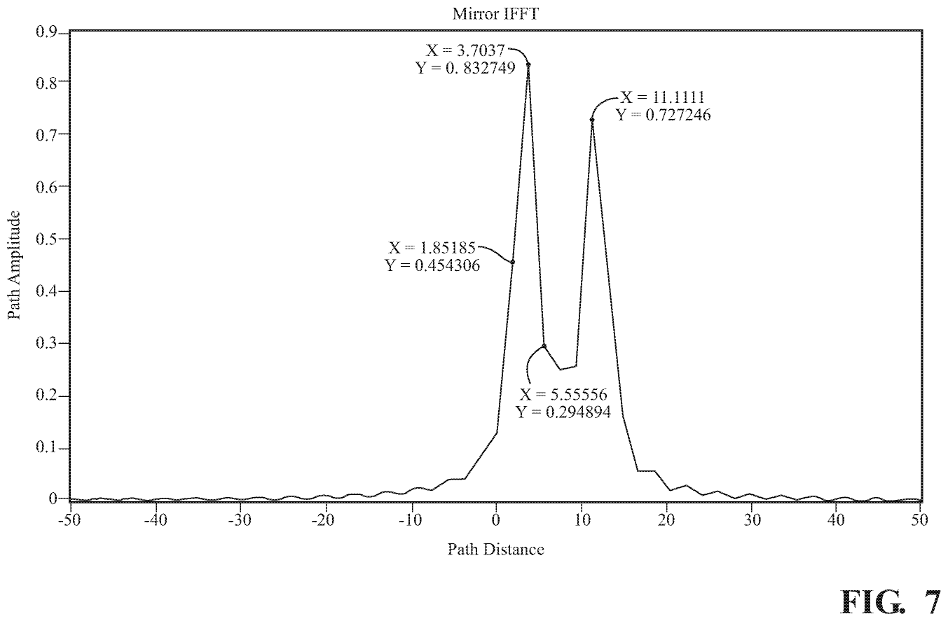

FIG. 7 depicts the result of conjugation of the concatenated channel response. By doing so, distance resolution can be improved compared to when mirroring is not used and peak interpolation would provide a reasonable estimate of the true peak. For the peak closest to 3 meters, a value −1.85 meters to the left and −1.85185 meters to the right is depicted. As shown, there is more energy in the bin at −1.85 meters when compared to the bin at −5.55 meters, so the true peak should be less than the bin at ~3.7 meters.

As explained above, Phase Based Ranging estimates the channel response of a RF system, and the IFFT (or other) algorithm can be used to estimate relative path distances and amplitudes. However, the channel can also impact round-trip time measurements, and there are security aspects of securing round-trip time and phase based ranging measurements.

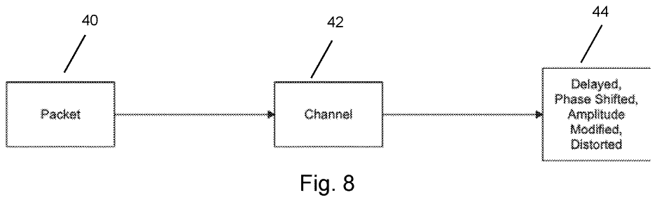

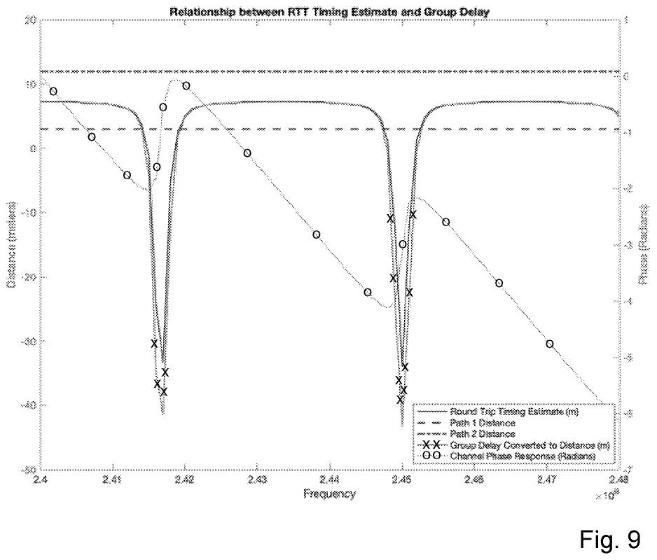

As depicted in FIGS. 8-9, a packet 40 transmitted through a channel 42 can emerge as a modified signal 44. This illustrates that the channel 42 can act like a filter upon a packet 40 that is transmitted through the channel 42. FIG. 9 illustrates the corresponding slope and delay characteristics of the channel response. Exemplary equations for slope and D are depicted below.

$$Slope = - \frac{2 π D}{c}$$

$$D = - \frac{Slope * c}{2 π}$$

An alternative method to obtaining the channel model is directly from an Ultrawide Band (UWB) Radio configured to perform ranging. A typical UWB may provide the complex channel response at various distances, known as taps. The phase and the power of the channel can be obtained at various distances. The Channel Sounding Phase Based Ranging is an alternative method.

Other independent channel measurement methods include: the use of pilot tones or pilot waves, such as Orthogonal Frequency Division Multiplexing (OFDM) pilot tones used in LTE or similar systems; Minimum Mean Squared Error (MMSE) or other channel-estimation algorithms used in 5G base stations; or Wi-Fi Fine Timing Measurement (FTM) or similar ranging techniques.

It should be understood that the independently derived channel model could be obtained using any of the methods described above or any other known technique.

It should also be understood that the independently derived channel model may represent all or only a portion of an operational frequency band. The independently derived channel model may be full-band, partial-band, single-frequency, multi-frequency, time-domain, frequency-domain, or path-based. The independently derived channel model may also be communicated from a third device, computed at a different time than the modulated packet under evaluation, or derived from historical measurements.

As used herein, an “independently derived channel model” can refer to a channel representation derived from a process that is independent from the modulated data packets used to generate the estimated channel model described below. The independently derived channel model may be obtained, for example, using phase-based ranging (PBR), ultra-wideband channel impulse response (CIR) measurements, pilot-tone analysis, minimum mean squared error (MMSE) estimation, Wi-Fi fine timing measurements, subspace methods, or other channel sounding or suitable techniques. The independently derived channel model may be time-domain, frequency-domain, path-based, or any reduced or transformed representation thereof.

### IV. CHANNEL VERIFICATION

As described in further detail below, a channel model obtained using any independent channel measurement method can be verified by using additional information contained in RTT packets or other modulated data packets for which timing or phase information may be extracted. That is, a channel that has been estimated by any method, including the independent channel measurement methods described above, can be verified by RTT packets or other modulated data packets. These packets pass through the same channel being verified, and therefore, embedded in the RTT packets or other modulated packets is the channel itself. The channel characteristics may be extracted directly or indirectly from the received signal, including through time-domain analysis, frequency-domain analysis, correlation analysis, slope estimation, amplitude analysis, or other signal processing techniques. If the original transmit signal can be estimated, measured or reconstructed, then certain properties of the channel can be measured. In one embodiment, a frequency-domain relationship between a reconstructed transmit signal and a received signal can be computed to obtain a packet-derived channel response. In other embodiments, channel properties may be inferred without full reconstruction of the transmit signal.

In one embodiment, verification includes estimating a first frequency-domain channel response from a first receive signal associated with a first carrier frequency and estimating a second frequency-domain channel response from a second receive signal associated with a second carrier frequency. As used herein, a “frequency-domain channel response” can refer to any representation of channel behavior expressed as a function of frequency. Such a representation may include, without limitation, complex-valued responses, magnitude responses, phase responses, slope or group delay representations, reduced-order models, or other derived metrics organized by frequency.

The first and second frequency-domain channel responses may be combined to generate a unified frequency-domain channel response spanning multiple carrier frequencies. The unified frequency-domain channel response may be compared with an independently derived channel model to detect differences in channel phase, channel slope, channel group delay, or channel amplitude. As used herein, the term “unified frequency-domain channel response” can refer to a frequency-dependent channel representation formed by combining two or more frequency-domain channel responses associated with different carrier frequencies. The unified response may include any set or subset of channel characteristics represented as a function of frequency. The unified frequency-domain channel response may be continuous, piecewise continuous, stitched, interpolated, slope-derived, phase-integrated, amplitude-derived, or otherwise reconstructed across multiple carrier frequencies.

In some embodiments, the modulated data packets are round-trip time (RTT) packets exchanged between devices. In other embodiments, the modulated data packets may be one-way packets, channel sounding packets, pilot-tone packets, authentication packets, or any other communication signals for which a transmit signal model can be reconstructed or estimated. The modulated data packets may be transmitted at one or more carrier frequencies, and may be transmitted sequentially, simultaneously, periodically, or during normal communication operation. The verification techniques described herein are not limited to RTT exchanges and apply generally to any transmitted signal from which channel-dependent characteristics can be derived.

### IV.A. Introduction

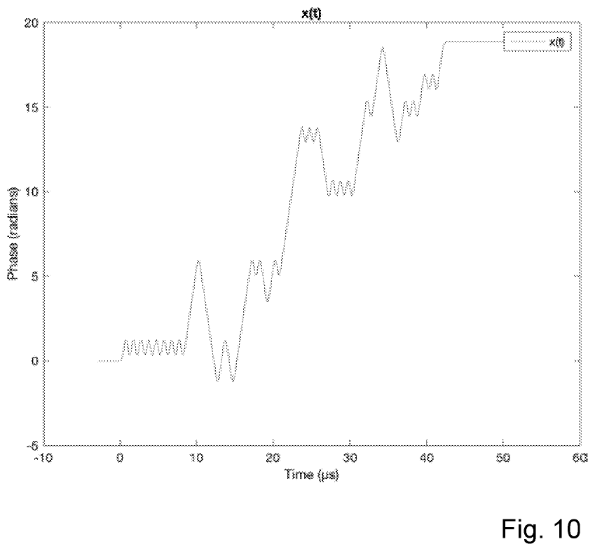

The signal x(t) for a GFSK signal can be the phase of the encoded message. FIG. 10 depicts the phase versus time of a GFSK modulated signal.

In this section, x(t) can be a complex value signal, which can be equivalent to s(t) in the definitions section.

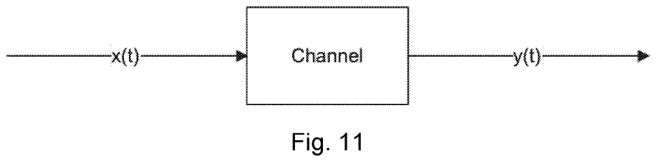

If the signal x(t) passes through a channel, the channel can modify x(t) into y(t). FIG. 11 illustrates that y(t) is the time domain output of the time domain signal x(t) passing through a channel. Although certain examples described below reference Round-Trip Time (RTT) packets, the signal modeling and channel extraction techniques described in this section apply to any modulated data packet transmitted over the communication channel.

If the channel is linear, meaning that the phase response of the channel is linearly dependent upon the frequency, y(t) can be a delayed and a phase shifted version of x(t). This is assuming that the channel is lossless.

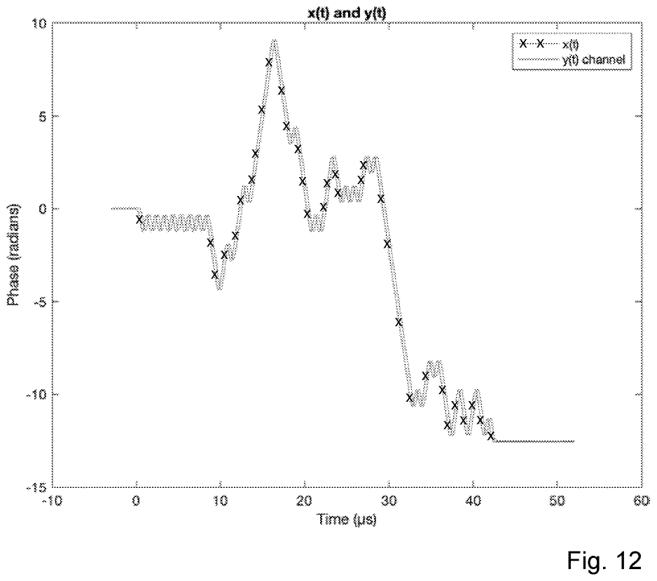

As shown in FIG. 12, assuming that the Channel is lossless, the signal y(t) can be a delayed copy of x(t); this would simulate x(t) passing through a linear channel with only a delay and no loss in amplitude. This can be roughly equivalent to a signal passing through a high-quality RF cable with very little loss of power.

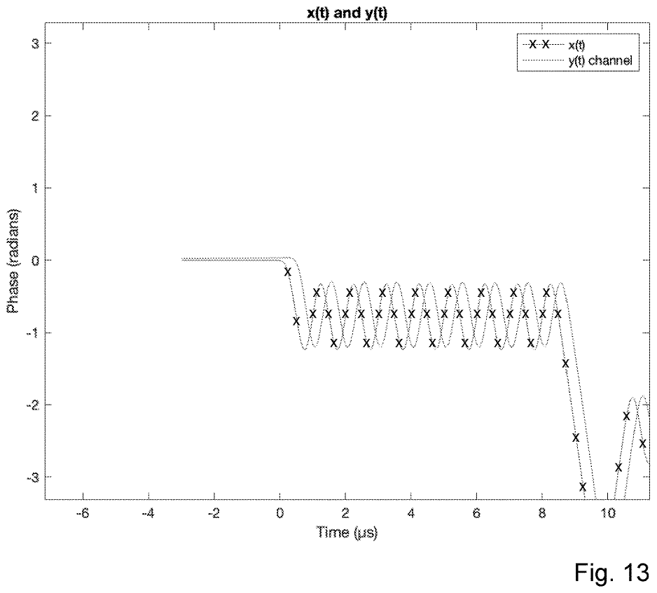

FIG. 13 depicts that there can be a slight phase shift of the signal y(t) compared to x(t) caused by the channel.

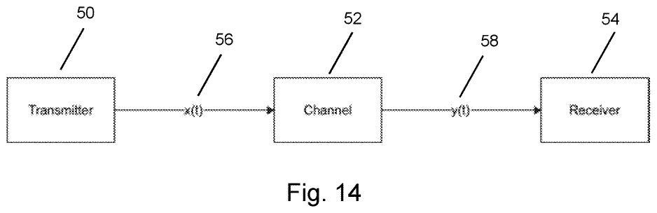

Another way to view x(t) and y(t) is that x(t) is the time domain transmitted signal 56 transmitted by a transmitter 50 through a channel 52, and y(t) is the time domain received signal 58 received at a receiver 54, as depicted in FIG. 14.

An exemplary method for computing y(t) from x(t) in the time domain is by estimating or measuring the impulse response of the channel h(t). That is, y(t) can be the result of convolving the transmitted signal x(t) by the channel h(t).

However, an alternative method for calculating y(t) from the channel is by estimating or measuring H(f), where H(f) is the frequency domain representation of the channel.

As previously shown, the equation ChannelRespComplex(f) can be converted into a path model where the amplitude, distance, and phase of each path is estimated by the Inverse Fourier Transform. Therefore, ChannelRespComplex(f) can represent the channel.

Due to the convolutional theorem, the frequency domain representation of y(t), also known as Y(f), can be calculated by the multiplication of the frequency domain representation of x(t), known as X(f), and the frequency domain representation of the channel, H(f). The following equation represents how the channel can modify X(f) into Y(f).

Y(f)=H(f)·X(f)

X(f) can be calculated using the Fourier Transform, or in digital system using the Discrete Fourier Transform (DFT). The Fast Fourier Transform (FFT) is a commonly used implementation of a DFT. The following equation describes how to calculate X(f) from x(t).

X(f)=FFT(x(t))

The Channel Response, H(f), can be measured or estimated, as described previously in this document.

Y(f) can be converted back into the time domain by the Inverse Fourier operation, commonly implemented as the Inverse Fast Fourier Transform (IFFT) in digital systems. The time domain signal y(t) can be calculated according to the following equation:

y(t)=IFFT(Y(f))

The foregoing paragraphs demonstrate that x(t) can be converted into y(t) by way of the channel. In the time domain, the channel can be convolved with the time domain signal h(t); however, an alternative representation is to use the convolutional theorem to perform multiplication in the frequency domain and convert back into the time domain.

Three key implications of this include the following.

First, the time delay and shape distortion of y(t) can be caused by the channel. If x(t) can be known exactly, or a reasonable estimate of x(t) can be determined within the receiver, the channel itself can be calculated by way of reversing the equations above into the equation below:

$$H ( f ) = \frac{Y ( f )}{X ( f )}$$

A receiver that can calculate a reasonable estimate of X(f) can compute a reasonable estimate of H(f). The computation of H(f) using this method may be helpful for securing Phase Based Ranging (PBR) systems as will be described.

Second, if some shaping correlation or timing estimation is performed on y(t), and if H(f) is reasonably estimated, the distortion caused by H(f) can be incorporated into the timing estimation or correlation. That is, for example, if a mathematical operation is performed to ensure the shape of y(t) matches the shape of x(t) when the two signals are timing re-aligned by the receiver, the channel H(f) could lower the correlation of the shape matching due to distortions caused by the channel. However, having an estimate of H(f) can allow the receiver to update the expected shape of y(t). Also, if a timing estimation algorithm is used to compute the timing alignment (potentially optimal timing alignment) of x(t) to y(t), the timing estimation algorithm can use H(f) to update its behavior to accommodate for the pulse shape differences.

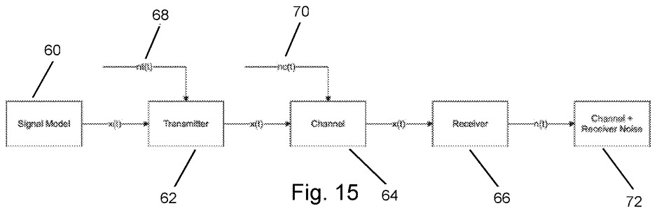

Third, spectral noise introduced by the transmitter can be estimated by the receiver by performing a time alignment and removing any effects from the channel, as depicted in FIG. 15. FIG. 15 illustrates a signal model 60, a transmitter 62, a channel 64, and a receiver 66, where transmitter noise nt(t) 68 and channel noise nc(t) 70 contribute to a resulting signal 72 with channel noise+receiver noise.

### IV.B. Calculating the Channel from Y(T) and X(T)

The following equation is repeated for H(f):

$$H ( f ) = \frac{Y ( f )}{X ( f )}$$

Using this equation, a receiver can estimate the channel from its received signal y(t) and an appropriate model of the transmitted signal x(t). In one embodiment, estimating the frequency-domain channel response comprises computing a frequency-domain relationship between a frequency-domain representation of the received signal Y(f) and a frequency-domain representation of an estimated transmit signal X(f).

In one embodiment, the frequency-domain relationship used to estimate the channel response comprises a ratio:

$$H ( f ) = \frac{Y ( f )}{X ( f )}$$

where Y(f) is a frequency-domain representation of a receive signal and X(f) is a frequency-domain representation of an estimated transmit signal. The estimated transmit signal may be reconstructed from demodulated symbols, from a known cryptographic symbol sequence, from a stored reference waveform, or from other transmit signal knowledge.

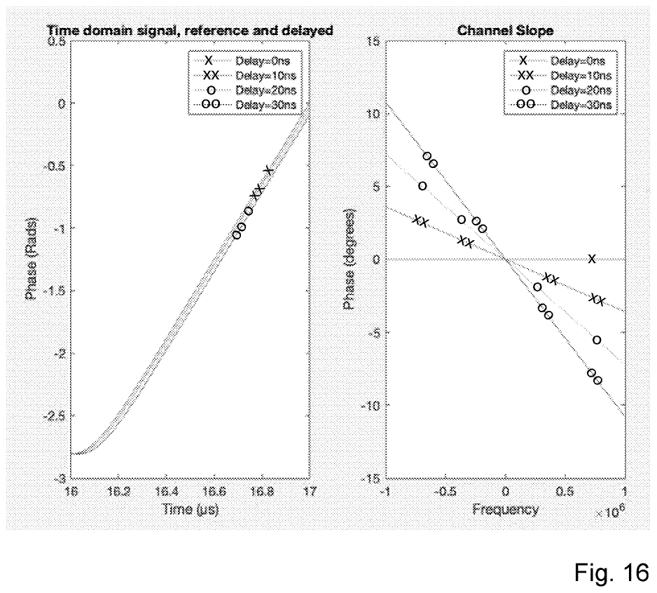

FIG. 16 depicts a reference signal x(t) in ‘x’, and delayed versions by 10 ns to 30 ns in ‘xx’, ‘o’, and ‘oo’, on the left; and on the right, the slope of the channel H(f) is shown from −1 MHz to +1 MHz, where zero Hz represents the carrier frequency. The +/−1 MHz corresponds to the 2 MHz of bandwidth that the GFSK signal can occupy. As depicted in FIG. 16, the slope of the channel H(f) can be proportional to the time delay of the signal on the left. That is, the larger the delay on the left, the more negative the slope can be on the right. When there is no delay, the slope can be zero.

The slope on the right in FIG. 16 can be calculated with a system with near perfect knowledge such that x(t) can be constructed with the correct delay value of 0. In such a case, signal x(t) and its true time representation are known. The received signal y(t) can be represented as y(t)=x(t−τ), where τ is the time delay. The time delay τ in this example can be a member of 0, 10, 20, or 30 nanoseconds. The frequency representation of x(t), X(f), can be calculated by computing the DFT of x(t) such that X(f)=FFT(x(t)). Likewise, the frequency representation of y(t), Y(f), can be calculated by computing the DFT of y(t) such that Y(f)=FFT(y(t)). The channel H(f) can be computed by the equation:

$$H ( f ) = \frac{Y ( f )}{X ( f )} .$$

The channel can be a complex valued signal organized by frequency. The signals x(t) and y(t) can occupy the channel with a bandwidth. In this example, the signals x(t) and y(t) have a bandwidth of 2 MHz. The local slope of H(f) within the bandwidth of the signal can be proportional to the delay. This delay can be equivalent to the slope described previously. When the delay, τ, is zero, the channel can have zero slope. The larger the value of τ, the steeper the slope of the channel can be descending. The slope multiplied by a factor of −1 can be known as the group delay of the channel.

In one embodiment, estimating a frequency-domain channel response comprises computing a frequency-domain relationship between a frequency-domain representation of a receive signal and a frequency-domain representation of an estimated transmit signal. In one example, the frequency-domain relationship comprises a ratio of the frequency-domain representation of the receive signal to the frequency-domain representation of the estimated transmit signal.

A true receiver often does not know x(t) directly, nor the exact value of τ. In general, a true receiver often needs to estimate or validate τ as well as estimate or validate the slope of the channel from y(t) and possible other estimations of τ and channel slope. The signal x(t) can be reconstructed by the receiver by way of demodulation of the symbols in y(t) and reconstructing mathematically the purported value of x(t). The value of τ used to compute x(t) from y(t) can be zero. The value of τ can be derived from an RTT measurement, a PBR slope, or other measurement. Multiple candidate values of τ can be used to generate multiple versions of x(t) to determine which candidate τ has the best fit to the measurements. The symbols in y(t) could also be known a priori to the receiver because the symbols could be part of a cryptographic sequence.

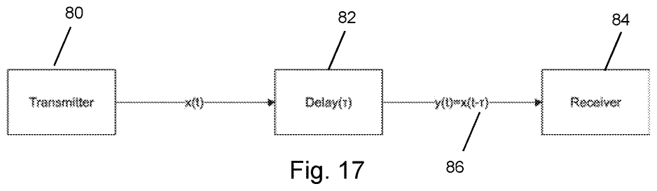

For example, with respect to FIG. 17, a transmitter 80 can emit a signal x(t) that passes through a channel 82 with a propagation delay of τ 86 and is received by a receiver 84, where τ is unknown.

The receiver can receive a time delayed version of x(t), which can be represented as y(t)=x(t−τ), which can be rearranged: y(t+τ)=x(t). Although not included, a phase delay of the carrier could be represented in these equations. As previously explained, the Receiver can estimate the Time of Flight value, which can be equivalent to τ in the equations of this paragraph and in FIG. 17. Therefore, the receiver's Time of Flight measurement can be an estimate for τ.

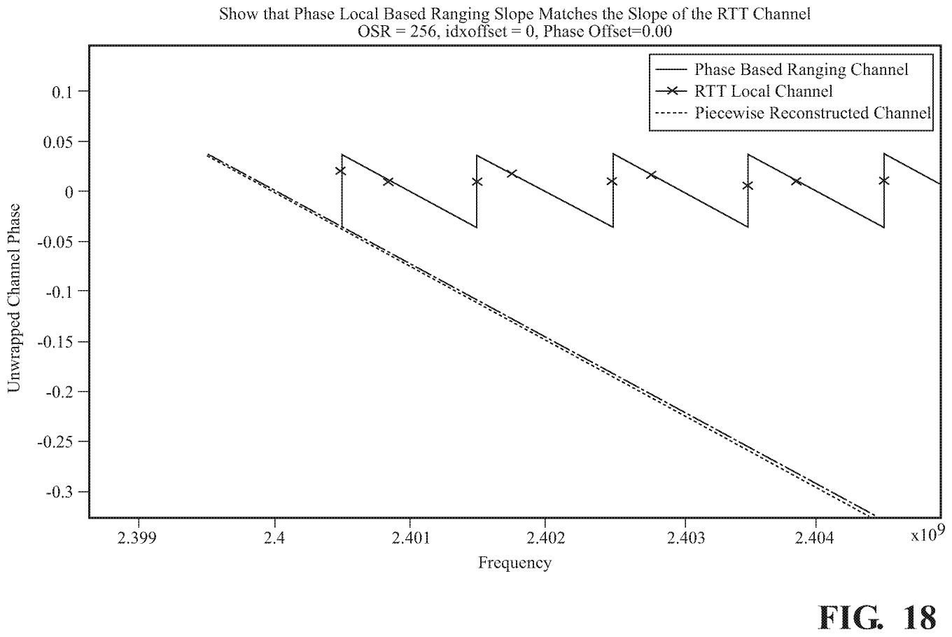

The receiver may validate τ, or it may verify that τ corresponds to the expectation of the channel. FIG. 18 depicts in solid lines an exemplary real channel through which x(t) has passed and a piecewise reconstructed signal. If Phase Based Ranging, for example, perfectly measured the exemplary channel, the result would be the real channel. The ‘x’ signal is the local slope of the RTT channel. The center of each RTT channel segment is approximately zero. This can be due to the phase rotation of the channel not being modeled, or x(t) being reconstructed with the same phase as y(t), for example. This may occur when the phase rotation of the channel is not known. The phase rotation of a RTT packet is not defined by the Channel Sounding specification. It can be seen in FIG. 18 that the slope of the piecewise reconstructed channel is nearly identical to the slope of the real channel. The saw-tooth nature of the piecewise reconstructed signal can be a result of the ‘x’ signal being computed on individual Round-trip time (RTT) packets on each channel frequency f. Each section of the ‘x’ signal can come from an individual RTT packet. The solid line signal nearly identical to the solid line real channel is a piecewise reconstruction of the channel, which in some embodiments forms the unified frequency-domain channel response spanning multiple carrier frequencies. It can be computed by stacking the individual RTT packet local channels one after another (concatenation). This can be achieved by computing the best line fit for each RTT packet and accumulating the total phase shift over the slope and the bandwidth. Other concatenation strategies could also be used and are conceivable. As depicted in FIG. 18, it can be observed that the piecewise reconstructed signal, which is an estimate of the phase response of the channel, obtained only from the RTT packets, is nearly identical to the true phase response of the channel.

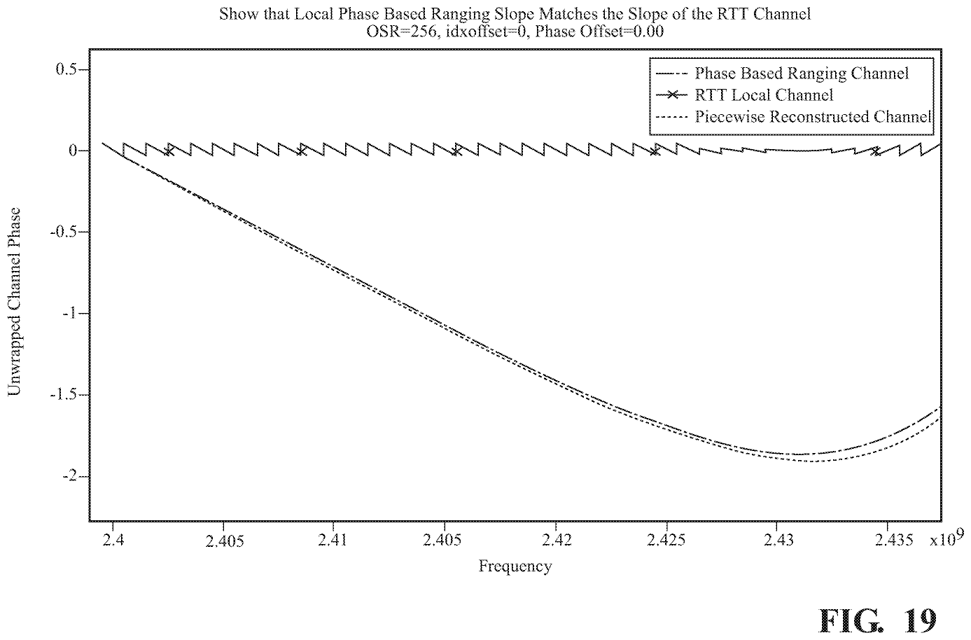

FIG. 19 is a zoomed-out version of FIG. 18. As depicted in FIG. 19, the solid line signals track each other well, but not always perfectly. This can be due to the estimation of τ not always being correct, which can result in a slight mismatch in slope between the piecewise signal and the real channel. Although not depicted in FIG. 19, the magnitude of the RTT packets also can increase and decrease with the amplitude of the channel response for each frequency. Therefore, it should be understood that the systematic error in the timing estimation can be estimated and compensated for by characterizing the error based on local slope and/or amplitude off nominal. For example, in the example of FIG. 19, the error tends to be the most significant starting in the region where the slope is zero and continues when the slope is positive. This is the region where τ is zero or negative or below an expected value. This is also the region where the phase based ranging and RTT packet amplitudes are significantly attenuated. The timing estimation algorithm itself could compensate for the bias if provided the slope and magnitude error information. Alternatively, a correction factor could be applied to remove this systematic error, based on the slope and/or amplitude. When accumulated over multiple packets, the error can grow. As also depicted in FIG. 19, the piecewise reconstructed signal has a zero slope in the region where the slope of the real channel signal is zero. Moreover, the slope of the segments of the piecewise reconstructed signal is positive when the slope of the real channel signal is positive.

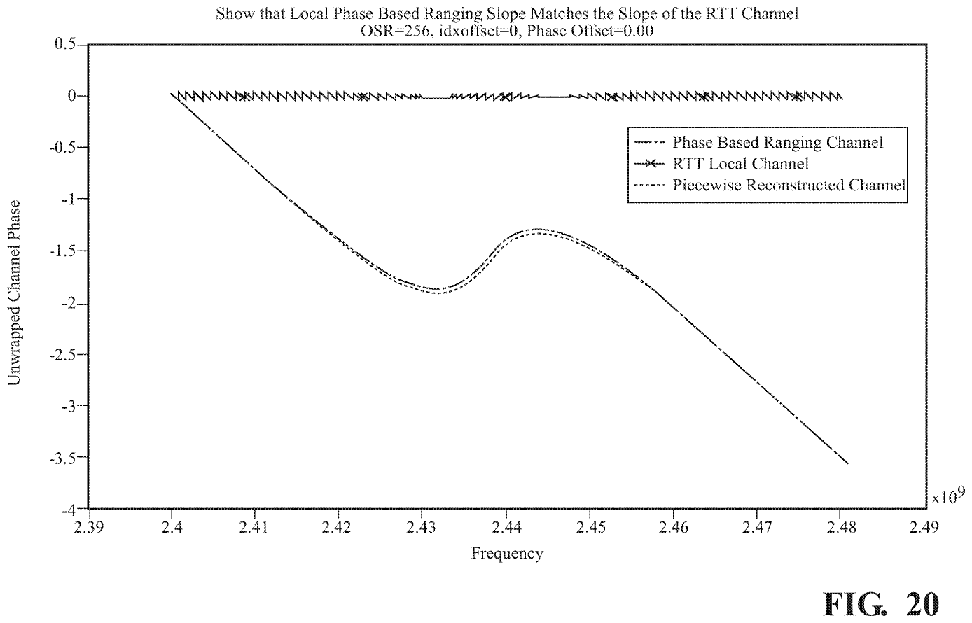

FIG. 20 depicts a further zoomed-out version of FIGS. 18-19 and covers the entire ISM band. As depicted in FIG. 20, the systematic errors reverse starting before the second time the real channel signal (solid line) approaches zero slope and by the time the real channel signal and the piecewise reconstructed signal (both solid lines) resume their negative slope path a second time, the total accumulated error nearly approaches zero. The piecewise reconstructed signal is a decent estimate of the real channel signal, and thus the channel can be extracted from the RTT packets using only the packets themselves and the estimate value of τ.

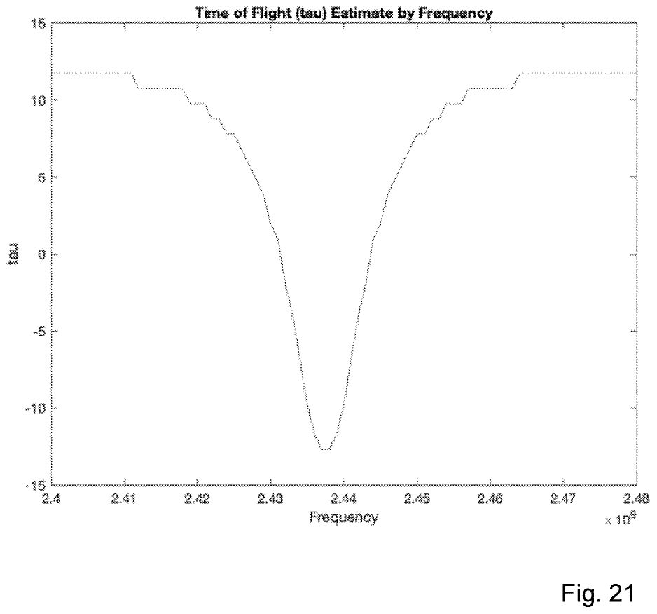

FIG. 21 illustrates exemplary estimated values of τ by frequency. Known a priori, the correct value of τ is 10 ns in the example of FIG. 21, which can be estimated using IFFT of the channel as shown previously. The error is most significant in the area of the notch in chart.

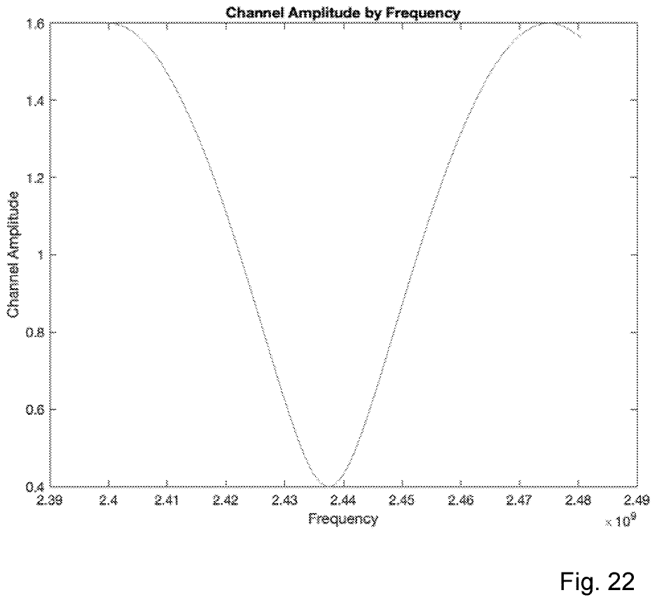

FIG. 22 depicts exemplary channel amplitudes by frequency. As shown in FIGS. 21-22, the error in τ can be closely related to the amplitude. The maximum possible amplitude is 1.6, which is the summation of the two paths, and the minimum is 0.4, which is the destructive interference of the two paths. It can be seen that a prediction about the error, and therefore a prediction in the timing estimation algorithm/estimated τ can be further refined by taking into account the additional channel information of amplitude and local slope.

The following description is the process by which a receiver can produce the piecewise reconstructed signal line in the previous figures and estimate the phase/amplitude of the channel response using only RTT packets.

The signal x(t) can be transmitted from the transmitter and can pass through the channel H(f), and by the convolutional theorem can result in the received signal y(t). If this process is repeated in a Round-Trip Time fashion and the receiver receives all the time stamps from a partner device according to the methods described previously, the receiver can estimate the value of τ for the channel with frequency f. The receiver may compute y(t) in IQ format, and may compute an estimate for τ; therefore, an estimate of x(t) can be calculated. The receiver can calculate an estimate of x(t), which can be called xe(t), from y(t) and τ, such that xe(t) arrives τ units earlier. That is, xe(t) can be further to the left than y(t) per the following equation.

xe(t)=y(t+τ)

The received signal is often discrete instead of continuous time. An approximation of the discrete samples that a sub-sample can be obtained using fractional delay techniques involving the sinc function.

Once xe(t) is calculated, the local channel can be computed by the following equation:

$$H ( f ) = \frac{Y ( f )}{XE ( f )}$$

In the above equation, Y(f) can be computed using the FFT of y(t), and XE(f) can be obtained by taking the FFT of xe(t).

This process can be repeated over the desired frequency range, and as described previously, the channel can be piecewise reconstructed by concatenating the individual local RTT channel measurements. In one embodiment, each local RTT channel measurement represents a frequency-domain channel response associated with a respective carrier frequency. By combining a first frequency-domain channel response associated with a first carrier frequency and a second frequency-domain channel response associated with a second carrier frequency, an estimated channel model can be generated as a unified frequency-domain channel response spanning a frequency range that includes both carrier frequencies.

In one embodiment, combining multiple frequency-domain channel responses comprises determining a first line of best fit representing a first frequency-domain channel response over a first frequency band, determining a second line of best fit representing a second frequency-domain channel response over a second frequency band, applying an offset to reduce a phase discontinuity between the bands, and joining the adjusted responses into a unified channel response.

### IV.B.1 Confirming Round-Trip Time

In another application of the figures in the previous section, the local slope extracted from an individual RTT packet should often closely match the slope from an independent channel estimation method. A security check can be performed to determine if either τ or the slope of the channel response extracted from the modulated data packets matches the τ or the slope of the independent channel estimation. In one embodiment, the comparison comprises comparing the unified frequency-domain channel response with an independently derived channel model and determining whether a difference in channel phase, channel slope, channel group delay, or channel amplitude exceeds a threshold indicative of channel manipulation.

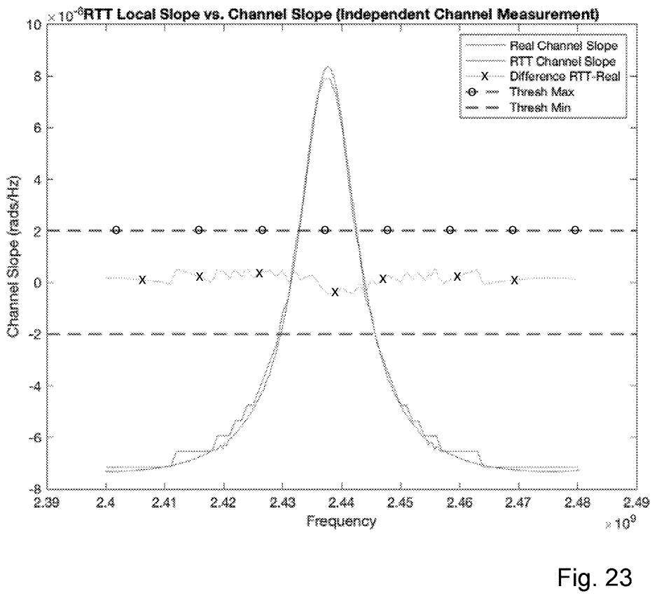

In FIG. 23, the slope from the Real Channel (the solid line signal in FIGS. 18-22) is shown again in solid. The solid line signal in FIG. 23 is obtained by differentiating the real channel signal from FIGS. 18-22. The slope from the RTT Channel (the ‘x’ line, saw tooth signal in FIGS. 18-20) is plotted in solid as well. It can be observed that the RTT Channel signal can closely approximate the Real Channel signal, as explained previously. Therefore, if the difference between the Real Channel Slope and the RTT Channel Slope is calculated, the ‘x’ signal can be produced. It can be seen that the ‘x’ signal contains some slightly positive and slightly negative values but is contained within a small range around 0. To confirm if either the RTT Channel Measurement or the Phase Channel Measurement is suspected of being incorrect, either due to noise in the measurement, fault of the system, or evidence of manipulation of the channel by an attacker, a correlation of slopes to a set of thresholds can be applied. In one embodiment, a difference between the estimated channel model and the independently derived channel model is compared to a threshold indicative of channel manipulation. The threshold may be predetermined, dynamically adjusted based on signal-to-noise ratio, derived from calibration data, frequency-dependent, statistically adaptive, or based on historical channel measurements.

### IV.B.2 Confirming Round-Trip Time and Phase Based Ranging

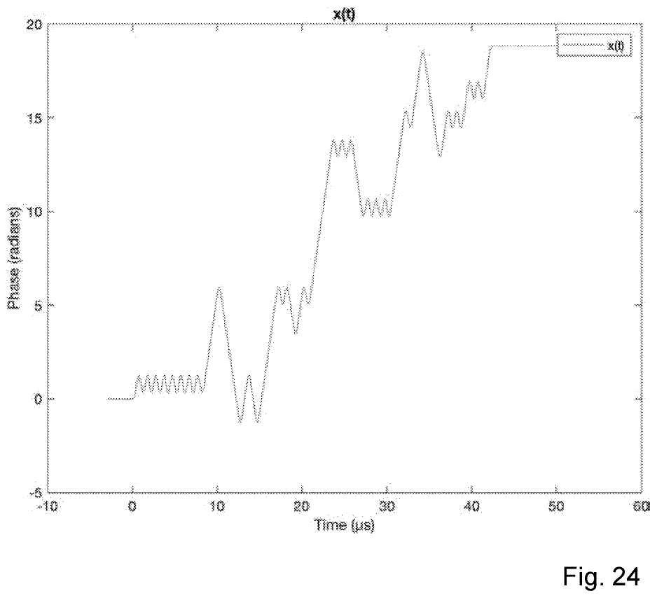

Phase can be extracted from RTT packets, as disclosed, for example, in U.S. application Ser. No. 18/619,380, entitled SYSTEM AND METHOD FOR RANGING WITH CHANNEL SOUNDING, filed Mar. 28, 2024, to Golsch et al.—the disclosure of which is incorporated herein by reference in its entirety. FIG. 24 shows the signal x(t) which is the phase of a GFSK signal. The phase of x(t) is known at t=0; in this case it is zero. The receiver can receive the signal y(t) with both a phase shift and a time offset. The time offset can be estimated by using a two-way RTT transaction as described herein. It is also possible for the Initiator and Reflector to take a phase measurement.

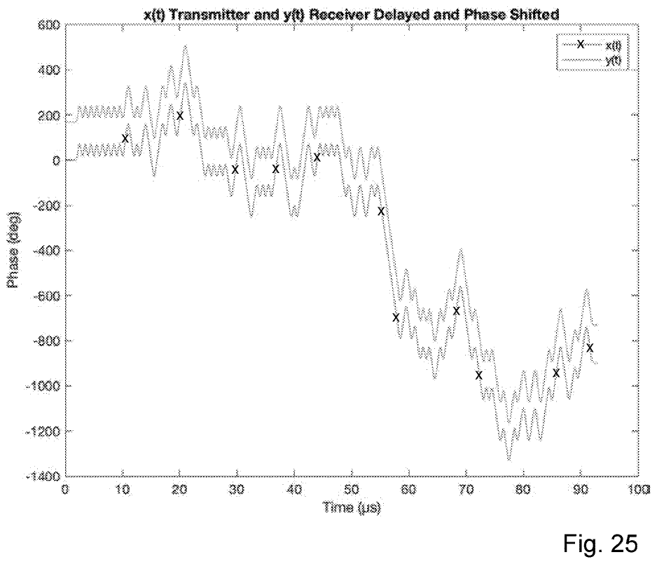

FIG. 25 illustrates an exemplary phase shift and time delay of y(t) compared to x(t) as if y(t) passed through a lossless 8-meter-long path. That is, y(t) is both shifted in phase and delayed compared to x(t).

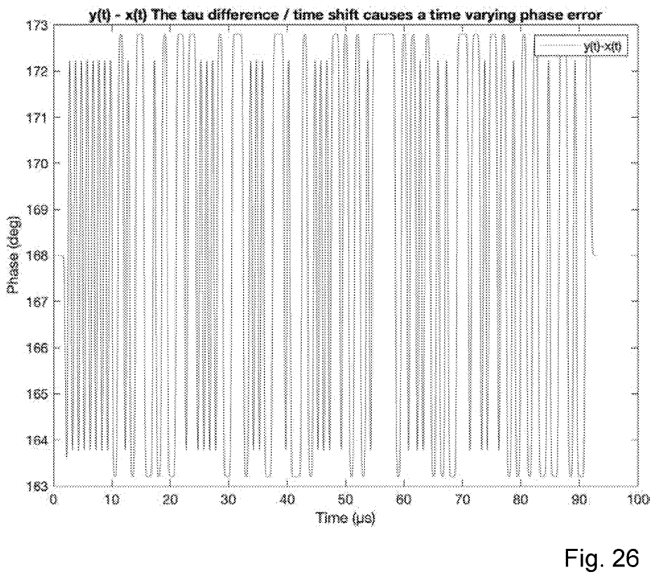

If through round trip phase (e.g., determined through Phase Based Ranging or Phase Extraction of RTT Phase) the truth about the Local Oscillator Phase (LO) between the Transmitter of x(t) and the Receiver of y(t) can be canceled, the difference in LO Phase can be ignored. The phase may not be directly extracted due to the difference in time base between x(t) and y(t). FIG. 26 illustrates an exemplary effect of the delay of the 8-meter path on the difference in phase between x(t) and y(t). Here, the difference in phase is not a constant, as one might expect with a carrier wave, and has a time varying component that spans several degrees.

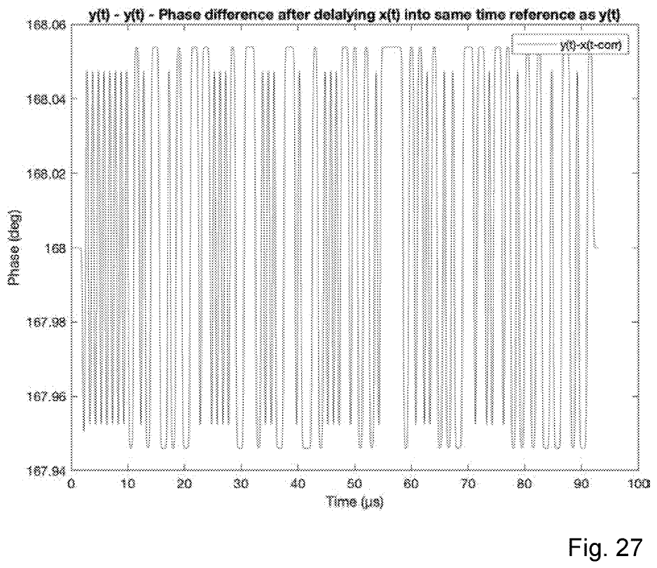

To extract the phase, the signals may be time aligned. Time alignment can be performed any number of ways. For example, one such way is to directly use the Time of Flight value measured in Round-trip time Packets. Another method is to use the group delay of the channel. Yet another method is to compute time delay by correlation to a reference and look for the maximum correlation by peak interpolation as described previously. Yet another method is to compute delays in x(t) such that the minimum variance of y(t)−x(t−corr) is minimized; the corr value that minimizes the variation is the optimal time offset. FIG. 27 is computed by taking the timing estimate from the RTT, where x(t) is delayed by the Round-Trip Time Estimate. It can be seen that there is a stable phase difference with fractions of a degree of variation; the phase difference is approximately 168 degrees. This is the phase of the channel response.

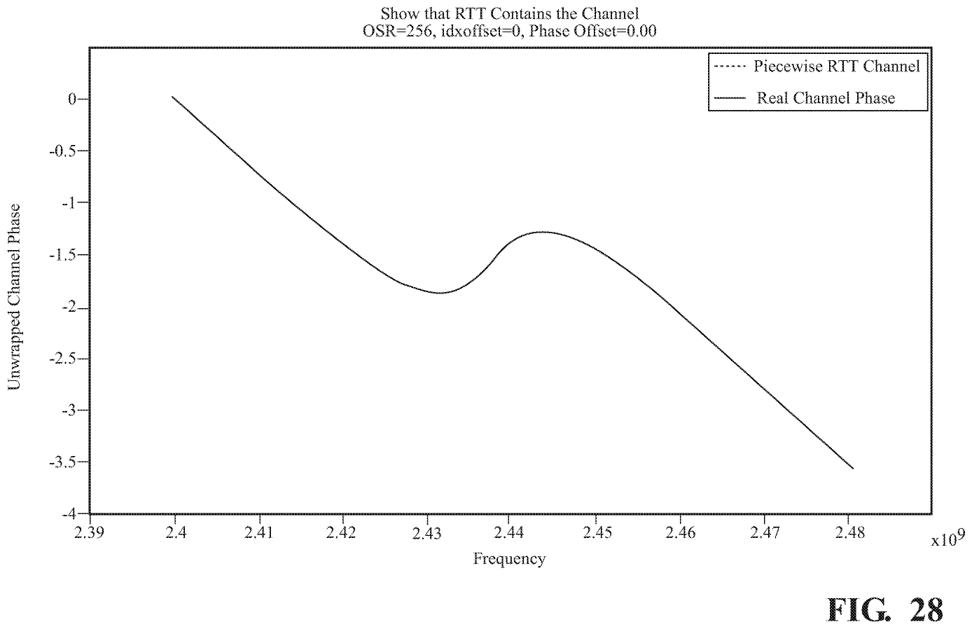

The following paragraphs pre-suppose that Phase of the channel is measured either by the method above, the Phase Based Ranging estimate, or an independent other method. The correlation between the Round-trip time estimate and the Channel Phase can be cross checked. FIG. 28 shows that if the Phase of the Round-trip time packet either naturally has the phase of the channel by special radio properties, or is corrected to be in the channel by way of PBR or RTT Phase extraction, if the value of the RTT delay is correct, a smooth continuous phase transfer function that is the channel can be reproduced from individual RTT packets.

In FIG. 28, it may be challenging to see the difference between the Piecewise RTT Channel and the Real Channel. The piecewise channel can be computed by the methods described herein, taking the bandwidth of the RTT packet at the channel. Since the phase rotation of the channel is also known or estimated, x(t) can be perfectly constructed in both time delay and in phase. That is, the channel may be nearly perfectly estimated by the equation below if x(t) can be calculated perfectly.

$$H ( f ) = \frac{Y ( f )}{X ( f )}$$

Therefore, any difference between the estimated channel and the real channel may be a result of measurement errors. The measurement errors can, for example, either be legitimate errors or due to an attack of one or both of the measurements (Phase and time).

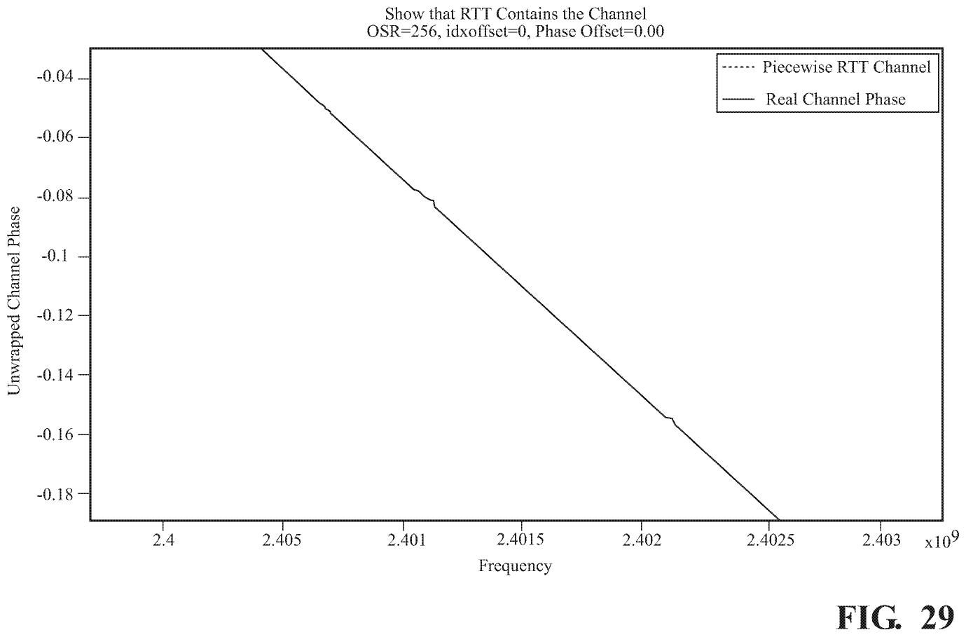

FIG. 29 shows a greatly zoomed in version of FIG. 28, depicting that there can be some slight noise due to the FFT operation on x(t) and y(t), but it can be nearly perfect.

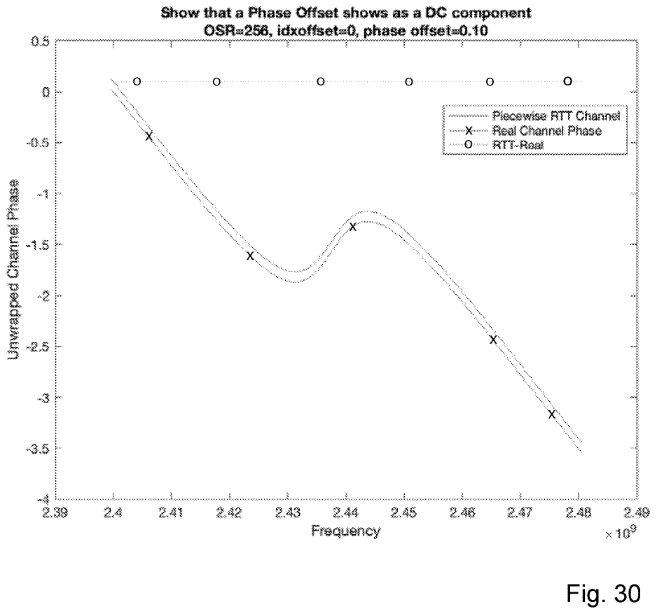

FIG. 30 shows an exemplary effect of a systematic DC phase error, for example if the system estimates a systematic error in the phase that is consistent for each channel. It can be seen that the solid line and the ‘x’ lines are the same, but with a DC offset. The ‘o’ line is the DC offset. From this, it can be seen that absolute errors in the channel response can be estimated by comparing the Phase of the Channel to the Phase of the Reconstructed Channel.

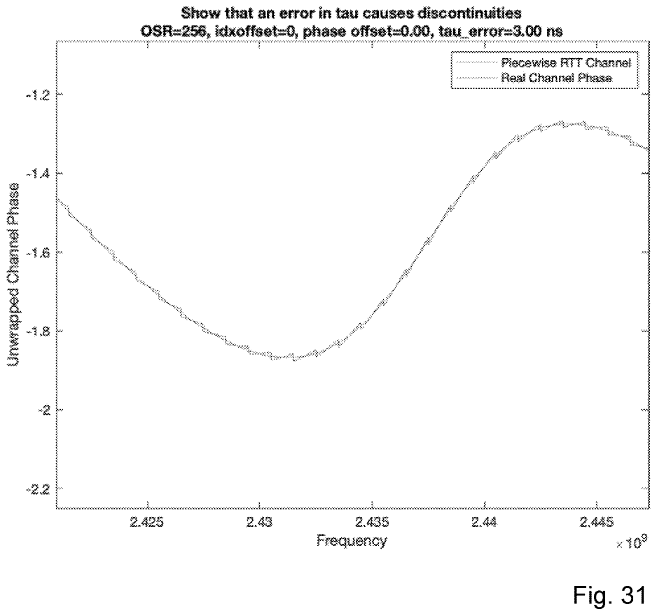

FIG. 31 shows an exemplary consistent 3 ns error in estimating the timing offset between x(t) and y(t). This error makes x(t) 3 ns later and therefore can be viewed as y(t) 3 ns earlier than expected. In FIG. 31, it is apparent that the piecewise RTT Channel consists of 1 MHz wide segments that consistently have a slope that is more positive than the ‘x’ real channel. The error of the slope can correspond to the group delay of 3 ns. The vertical jumps in the solid signal can be caused by the ending phase of one channel estimation using RTT not lining up with the starting phase of the subsequent RTT channel estimation. It is apparent that a system could use metrics describing the absolute value, variation/variance, mean, or other statistical measures of this discontinuity as a metric to describe the confidence of the fit and correlation between the phase and the time value. The time value can be estimated/corrected by minimizing the discontinuities.

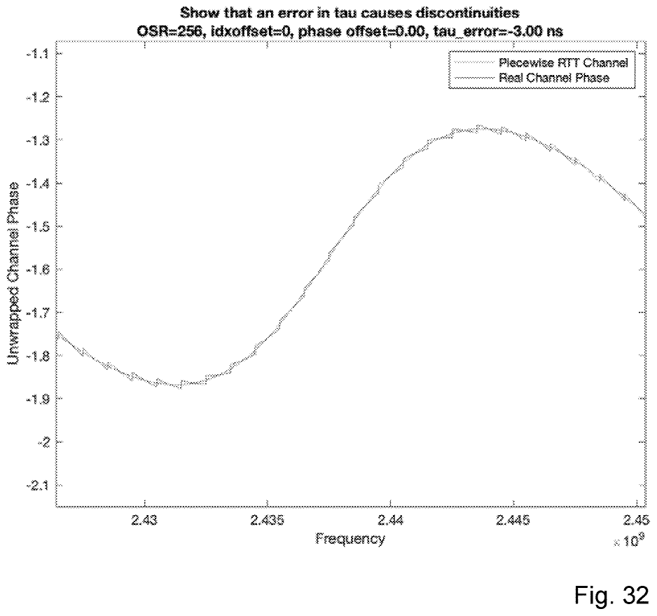

FIG. 32 shows the opposite direction error as FIG. 31. The slope of the piecewise error is now consistently more negative than the real channel signal. The absolute magnitude of the slope difference now corresponds to the −3 ns.

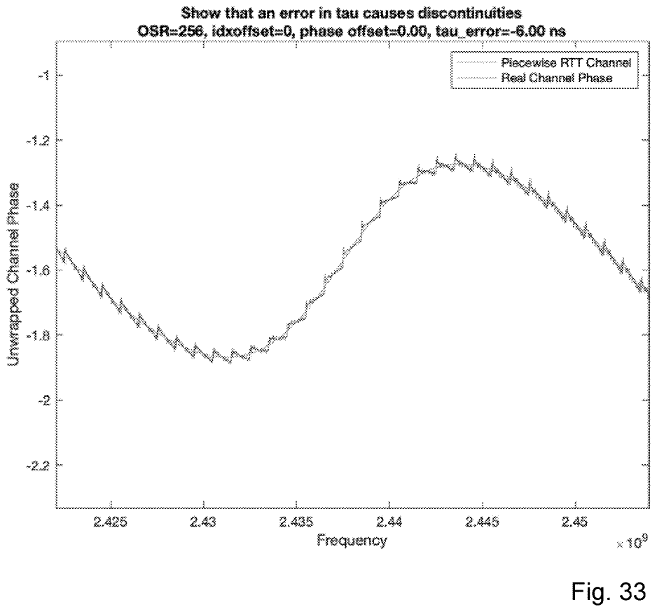

FIG. 33 doubles the timing error of FIG. 32 to −6 ns. In such a case, it is apparent that there is a corresponding doubling of the undershoot of the slope signal compared to the slope of the real channel signal. This further illustrates that the slope can encode the error in timing estimate.

From the previous figures, it is also apparent that the piecewise channel segments, although they have a slope error, can indicate the mismatch between the group delay of the channel and the RTT timing estimate. The center point of each piecewise channel segment intersects the corresponding real channel segment. If there is an error in the phase measurement, the piecewise channel line can have a vertical offset. There are many methods for determining if the RTT phase matches the phase of the channel, for example determining DC offset of the piecewise channel signal to the real channel signal by offset of the center, determining mean difference within the segment, or correcting for the slope then computing the difference in mean. Therefore, the RTT phase and the PBR phase can be compared by looking for DC offsets, and the RTT timing and the PBR slope can be compared by comparing the slope. The quality of the fit can be measurable by determining the smoothness of the curve taking into account, for example, both segment wise offsets and slope errors. A good fit can have center-channel intersections and smooth transitions from one segment to the subsequent segment.

In the previous descriptions and FIGS. 24-33, x(t) was created by creating a time shifted version of y(t). This can result in x(t) and y(t) having the same general shape; i.e., any symbol shape distortion present in y(t) caused by the channel will also be present in x(t). This is why all the line segments are approximately linear. This can also be one of the major sources of error when attempting to reconstruct the channel. This is also why τ can be converted into group delay, which can be expressed in radians/Hz, which can be integrated over the bandwidth of the channel spacing. Therefore, the channel can be reconstructed with only a list of τ values by frequency and piecewise constructing the slope by conversion of each τ into a slope. However, as shown, there can be errors in this approach.

In one configuration, x(t) may be reconstructed to be the idealized version of the signal, what can be anticipated to be actually transmitted from the receiver, free of the impairments of the channel. In order to reconstruct the idealized x(t), a mathematical model of the modulation of the signals can be used, and any known impairments of the transmitter can either be exchanged between the transmitter and receiver or be estimated by the receiver in real-time or as part of a previous or ongoing calibration routine. By creating the idealized reference, the effect of the channel and an estimate of the noise can be observed. Also, this can change slightly the method to reconstruct the channel; this is because each packet may now contain a non-linear segment of the channel, and simply stacking linear segments may no longer lead to an optimal or acceptable result.

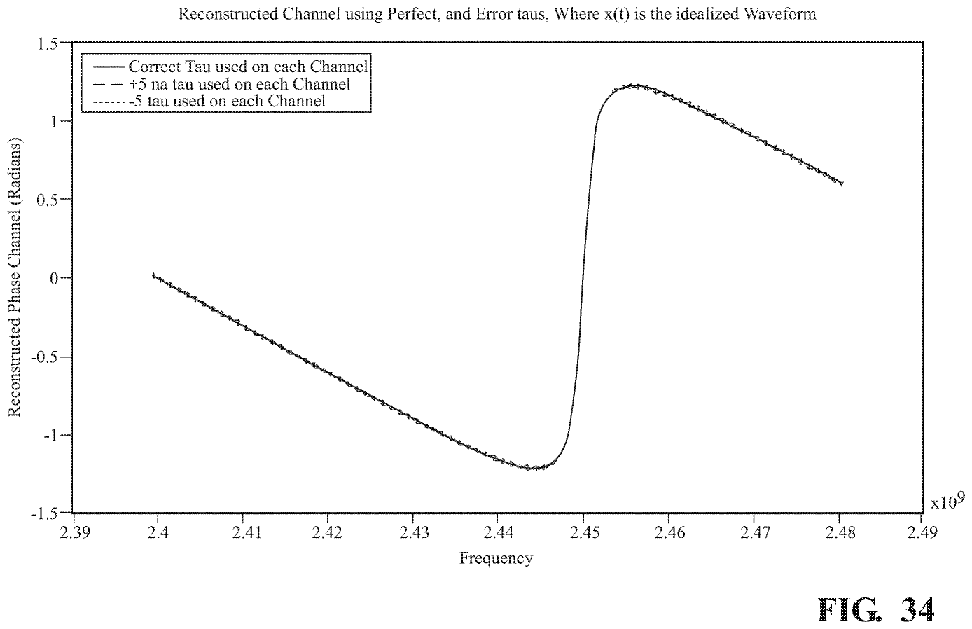

FIG. 34 shows the channel reconstruction using the idealized waveform. There are three lines (all similar at the depicted scale): the first solid line is created using the correct τ, the second line is created where τ is 5 ns larger than the correct value, and the third solid line is created where τ is 5 ns lower than the correct value. What can be seen is the overall shape of the channel is calculated correctly. However, the correct τ can have the smoothest transition from one segment to another. Any metric describing the smoothness of the curve can be used to confirm the best fit for τ. In one embodiment, the metric may be used to determine a confidence metric for the communication channel based on agreement between the estimated channel model and the independently derived channel model. The confidence metric may be derived from one or more of slope deviation, phase discontinuity, curvature mismatch, amplitude deviation, frequency-dependent error, noise profile deviation, boundary discontinuity, or combinations thereof. The confidence metric may be expressed as a scalar value, a vector of metrics, a weighted aggregate score, or a probabilistic confidence estimate.

Any metric describing the smoothness of the curve can be used as a metric to describe how closely the selected value of τ matches the data. Examples include the following. 1) Smooth the fit by filtering, find a curve fit best match, and then perform a cross correlation to determine the degree of match on the unfiltered version of the curve to the best fit model. 2) Look at the value discontinuity between adjacent segments at the boundary. 3) Look at the slope discontinuity across the boundary; that is, take the derivative of the segments, and the samples near the boundary of one segment and the adjacent segment should be similar. 4) Look for curvature discontinuity by taking the second derivative of the segments; the samples near the segment boundaries when compared to the boundary samples of the adjacent segment should closely match. 5) Other examples include Finite Difference Estimation, Spline Smoothness Penalty, and Total Variation and Wavelet Decomposition. The value of τ can be obtained by solving the Phase Based Ranging shortest distance using any algorithm such as IFFT described within this document, MUSIC, or any similar super resolution algorithm. The value τ can also be obtained by selecting the best, or any candidate, τ from Round-trip time measurements. The value of τ can also simply be guessed until a best value of τ is found. The value of τ could also be obtained by an independent measurement, such as by Ultra Wide Band, sensing via Lidar, Radar, etc.

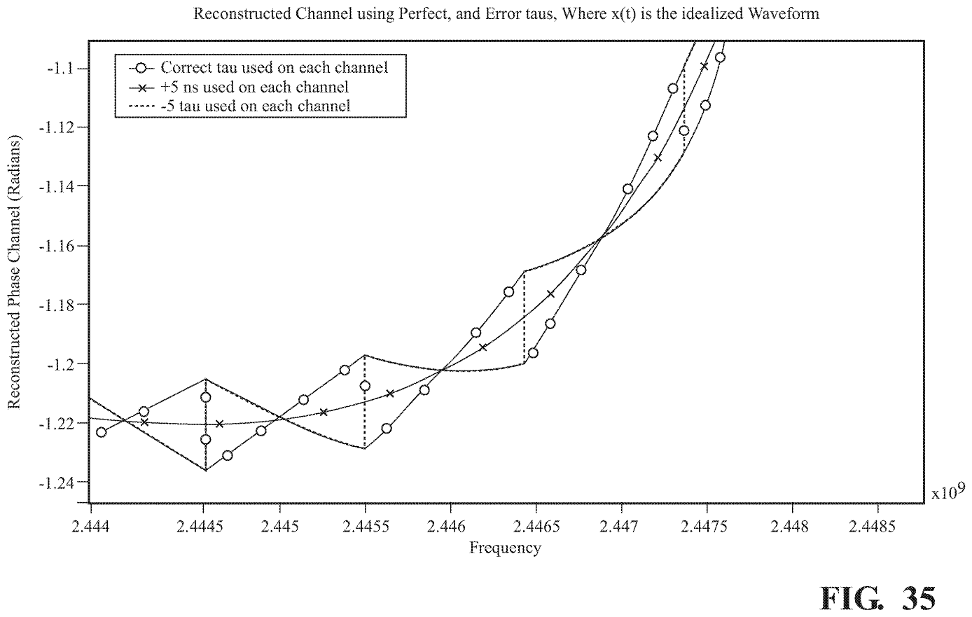

FIG. 35 is a zoomed in version of FIG. 34. In FIG. 35, it can be seen that the segments themselves are curved, and that just like the linear segments, the average slope error can be caused by an incorrect τ value, and the direction and magnitude of the slope error can be related to the error in τ. Similar to FIG. 34, as depicted in FIG. 34, the first line is the ‘x’ line in FIG. 34 and is created using the correct τ, the second line is the solid only line and is created where τ is 5 ns larger than the correct value, and the third line is the ‘o’ line and is created where τ is 5 ns lower than the correct value.

### IV.B.3 Updating Round-Trip Time Detector Based on Multipath

Multipath can distort the shape of symbols. The symbol shape used in the timing and security estimator can be modified. A core principle in the Bluetooth Core 6.0 Specification is the concept of Normalized Attack Detector Metric (NADM). NADM is an intrusion detection method that can rely on comparing an expected signal (reference) to the received signal. Pearson correlation is one of the methods described in the Bluetooth Specification; vendors are able to implement any mathematical check, so long as the compliance test vectors are passed. There is an expected symbol shape encoded into the reference signal.

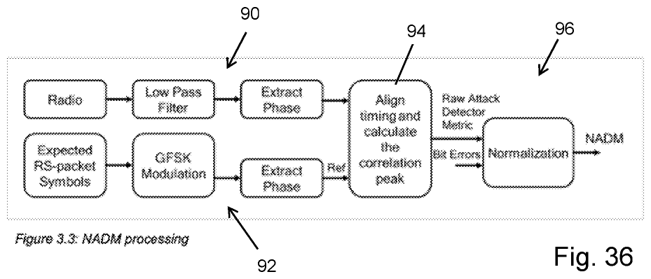

FIG. 36 is a figure in the Bluetooth Core Specification version 6.0, Part H, Section 3.5.1 Normalized attack detector metric. FIG. 36 includes two processing chains 90, 92 that come together at a correlation stage 94 to be analyzed and produce an attack metric output 96. In the first, topmost chain 90, the Radio can receive a signal, can apply a Low Pass Filter, and can extract the phase. This can be equivalent to y(t) when y(t) refers to the phase only of the received signal, and not the complex IQ version of y(t). In the second, bottommost chain 92, the receiver can apply a GFSK Modulation based upon the expected set of symbols, which can be known a priori due to, for example, cryptographic Deterministic Random Bit Generator (DRBG). The phase of the modulated reference signal can be extracted. The reference can be like x(t) when x(t) refers to the phase and not the Complex IQ version of x(t), but it is not in the time domain of the transmitter. In the Bluetooth Specification, the phase only of optimally time aligned signals may be compared.

FIG. 36 may be insufficient because converting the IQ value of the typical radio signal into a real valued phase may discard information, such as the magnitude of the signal. It may also be lacking because there can be additional information in the spectrum of the signal. It can be shown that aligning the reference signal and the received signal and inspecting the spectrum of both can be helpful for measuring the noise of the legitimate transmitter and channel. This concept may be helpful for securing the channel, by confirming the noise of the transmitter and of the channel. The following discussion focuses on the fact that FIG. 36 does not take into account distortions that the channel causes. The reference signal can be computed using a static model of GFSK Modulation. In this case, GFSK is merely an example, since this technique is applicable to other modulation techniques. The Radio can receive a signal that has passed through a channel, which the channel may have modified the shape of the symbols. The distortion of the symbols can lead to both an incorrect time alignment as well as sub-optimal peak correlation. Since a low correlation could indicate a low quality or manipulated signal, the expectation of the reference signal shape may be modified based upon expectations of the channel through which the signal has passed.

For example, consider the channel model below and represented by the following equation:
Path 1=1.0 Amplitude and 0 meters in distance.
Path 2=0.6 Amplitude and 4 meters in distance.

$${ChannelResp}_{Complex} ( f ) = {\sum }_{p = 1}^{N} {exp}^{- j 1 * \frac{2 π f * {D}_{p} + {φ}_{p}}{c}}$$

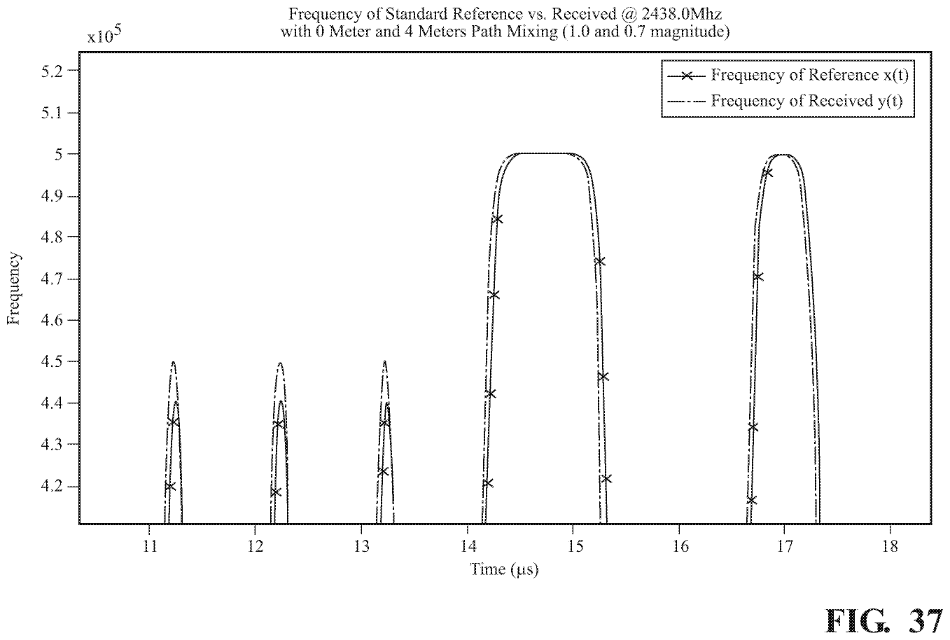

FIG. 37 shows the frequency of an exemplary reference signal x(t) and an exemplary received signal y(t) on the carrier frequency of 2438.0 MHz. The frequency of x(t) and y(t) were obtained by frequency differentiation and taking into account the sampling rate. Although there is a 0 meter path which may cause no delay of y(t) compared to x(t), and a 4 meter path which may cause a delay in y(t) compared to x(t), the summation of these two paths and the relative phases can combine in a way that makes y(t) appear earlier. This can be because the phase slope is positive at 2348 MHz; in other words, the group delay is positive. It is also shown that the y(t) signal, shown in solid line only, overshoots the frequency of x(t) signal identified as the ‘x’ signal, which can be due to the distortion of the channel. A detector algorithm may look at, for example:
the frequency overshoot,
the change in the slope of y(t) compared to x(t),
the change in zero crossings depending on the sequence of symbols, or
the height and width of the pulses based on the number of consecutive same symbols in the pulse.

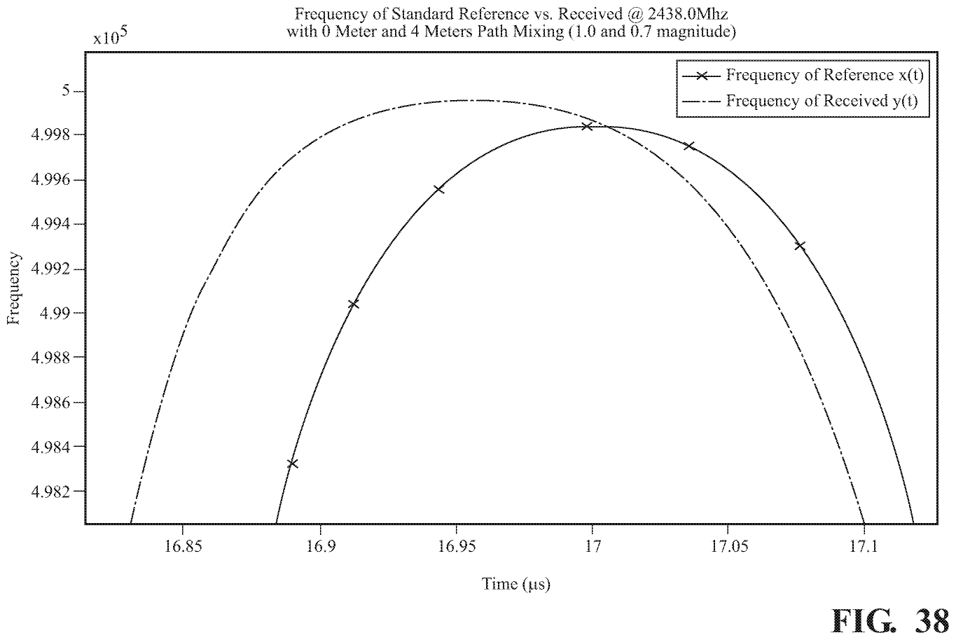

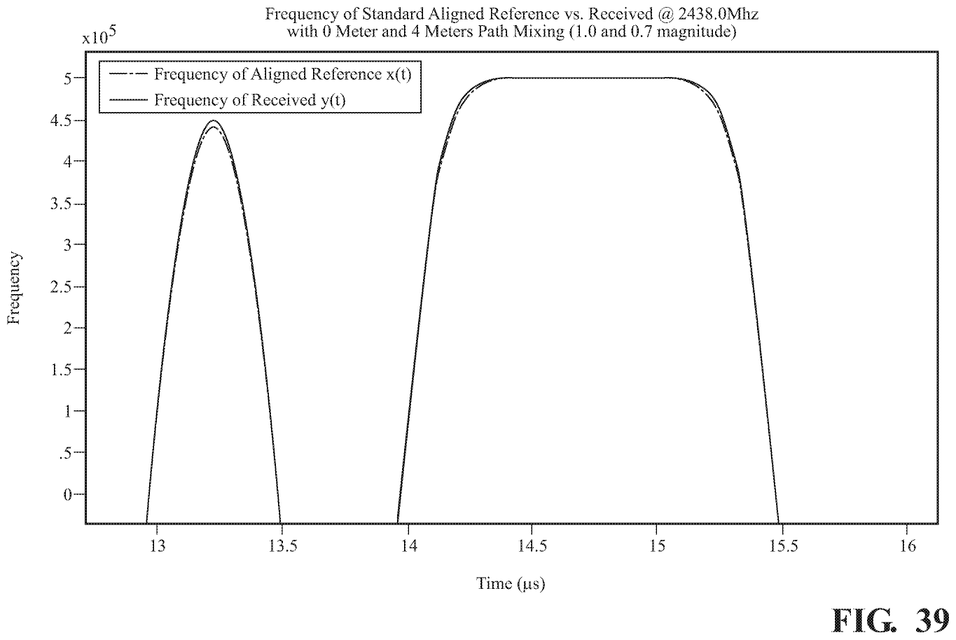

FIG. 38 illustrates the overshoot from FIG. 37 in more detail. The intrusion detection algorithm, known as NADM, can rely on a timing alignment and a correlation. In FIG. 39, the reference signal x(t) has been time aligned with the received signal y(t). The distortion of y(t) is apparent. Between 13 and 13.5 μs, the received signal overshoots the frequency of the reference. Regarding the bend slightly after 14 μs, the received signal appears earlier with a higher frequency than the reference. Regarding the opposite falling bend between 15 and 15.5 μs, the received signal appears delayed by remaining at a higher frequency than the reference. These statements indicate one method of detecting the distortion. Based on the number of consecutive repeated bits and a given threshold frequency, there can be an expected width to the pulse. It can be seen that the y(t) signal is wider than the x(t) reference signal (‘x’ signal) at higher frequencies, and nearly the same width at the zero crossing frequencies. Between ~14 to 15.5 μs, there are three consecutive 1 symbols. Take for instance 400 kHz in frequency; the width of the reference can be compared to the width of the received signal y(t). It can be seen that a difference or a ratio can be calculated. Such a metric can be used to detect the distortion caused by the channel. In reality, there may be a minor difference in the zero crossing positions that is also detectable.

Another feature is that the absolute value of the derivative of the received signal may be too high in some segments of the curve when compared to the derivative of the reference. If the center of each of the pulses is calculated, an offset to either direction can be calculated. For example, in FIG. 39, an approximate center is around 14.75 μs. Applying an offset of ~0.45 μs moves to the shoulders of the pulse. There can be a measurable difference in the derivatives of the signals in this region. Nearer the zero crossing and nearer the top of the pulses, there can be less difference in the delta.

The distortion of the y(t) signal when compared to the original x(t) as y(t) passes through the channel can cause two effects. First, it can create a timing error in the Round-Trip Time estimation as shown in previous figures. The distortion, and therefore the timing error, can be a frequency dependent phenomenon, as it can depend on the curve of the channel near the bandwidth of the modulated signal. The areas with significant multipath interference where the interference is largely destructive in nature can lead to a reversal of the group delay, and therefore can distort the signal y(t) into a shape that appears earlier than expected. However, since the channel can be estimated via an independent channel measurement method, a correction can be applied. And the second effect is that even after attempting to time align the signals, there can be some mismatch in x(t) and y(t) caused by the non-linearity of the channel. It may be advantageous in some situations to perform analysis on the mismatch in order to detect it. However, it also may be advantageous in some situations to correct for the shape distortion.

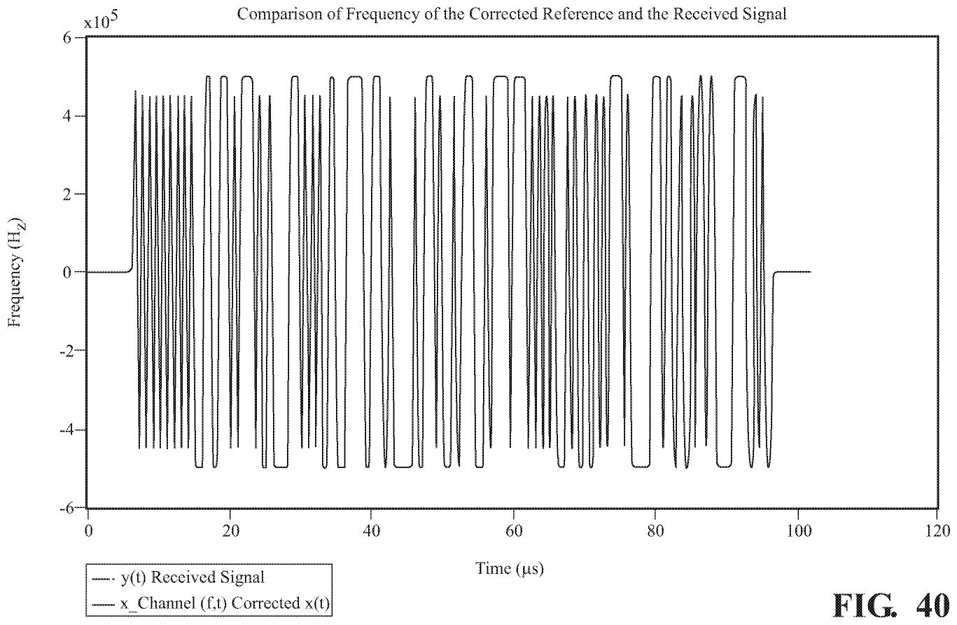

As an example, if a correlation method such as Pearson Correlation is applied to the time aligned x(t) and y(t), the distortion could necessarily create a mismatch in the shape or phase of the waveforms. This mismatch could lower the correlation. This lowering of the correlation may artificially trigger an intrusion alarm, or it may degrade the margin for determining an alarm such that a higher Signal to Noise Ratio (SNR) is required to achieve the level of confidence that no attack is present. In either case, false alarms or degraded margin for securing the system are undesirable. In some situations, it may be preferred to correct for the expected channel distortion before performing the timing analysis, and/or the intrusion detection. That is, if the frequency response of the channel is estimated via an alternative method such as through Phase Based Ranging measurements or through the Channel Impulse Response information of UWB radios, then it is possible to modify x(t) such that the shape is modified by the channel. The modified x(t) is called x_channel(f, t), where f is the frequency of the channel, and t is time as in x(t). FIG. 40 shows the phase of y(t) and x_channel(f,t) for frequency 2340 MHz. It is apparent that there are only minor differences in the x_channel(f, t) and x(t). That is, the plots of these signals are substantially the same.

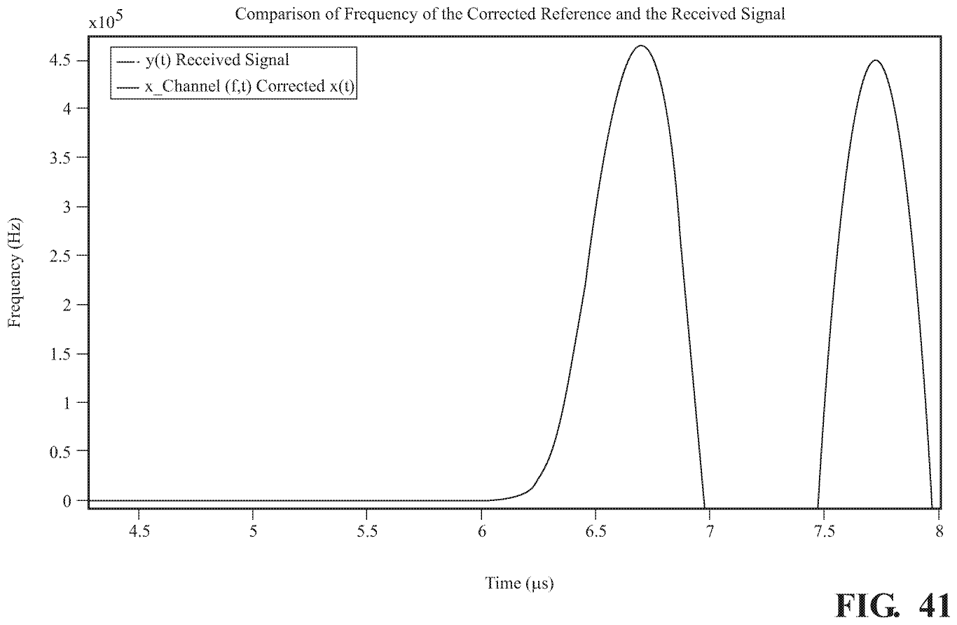

FIG. 41 shows the detail of FIG. 40; again, the y(t) received signal is barely noticeable behind the x_channel (f, t).

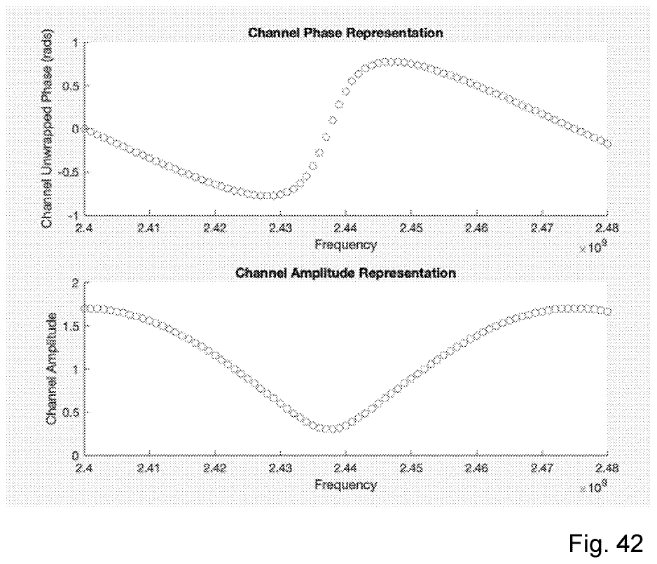

In FIG. 41, x(t)-based plot was produced using a time domain simulation of the various path lengths and amplitudes—that is, the 0 meter, 1.0 amplitude path, and the 4 meter 0.7 amplitude path. The phase rotation by the distance was calculated using the equations herein; a time delay according to the path length and the speed of light was added. Then, the time domain signal was created by summing the delayed and phase shifted versions of each path. The signal y_channel(f, t) was computed using a frequency domain simulation from the reference channel model. FIG. 42 shows the channel model of the 0 and 4 meter paths mixing at a receiver. 0 meters is contrived, and the mathematics may work with any set of path lengths. However, 0 meters was selected as a convenience to show that the true signal may not exhibit any time delay either positive or negative, but the channel can distort the signal to create a negative delay in this instance. In FIG. 42, the top figure shows the phase response of the channel, and the bottom figure shows the amplitude response. Together these values can be encoded into a single complex number organized by frequency.

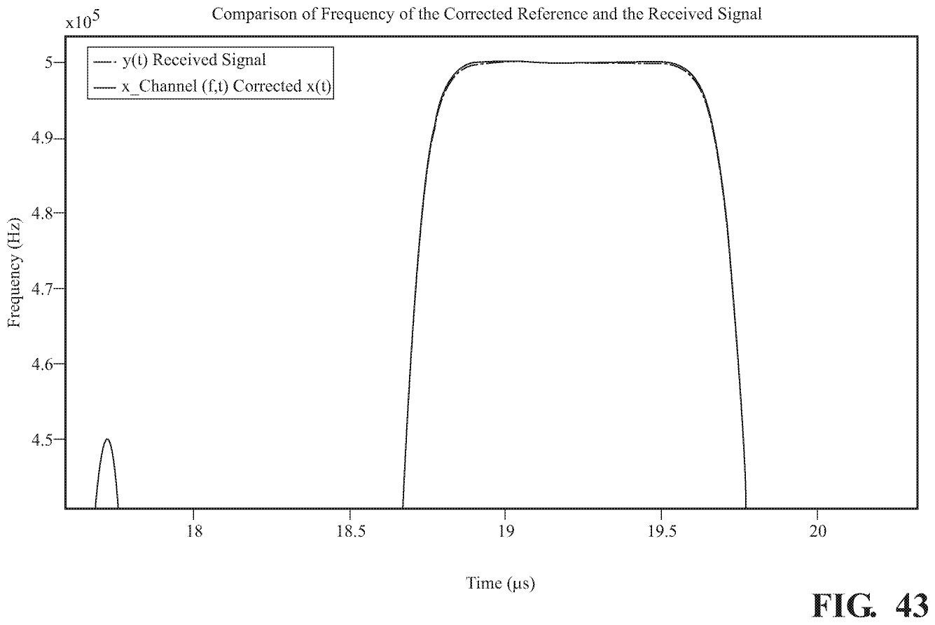

The selected frequency for the foregoing figures is 2340 MHz (2.40 GHz, 2.4e9 Hz) and is roughly in the center of FIG. 42. This may correspond to the region where the amplitude is lower (around 0.3) and the slope of the phase response is positive. These factors can cause the most significant distortion to the signal symbol shape as described herein. By recreating the effect of the channel and reconstructing x_channel(f, t), the near perfect alignment of symbol shape can be achieved, as depicted in FIG. 43. FIG. 43 shows only minor frequency variations between the signals because the symbol shapes have been adjusted to match the expected channel. The signal x_channel(f,t) can be calculated by the following:
1. Compute x(t) in the usual fashion; this can be a baseband signal that is carried through a channel with some center frequency, Fc. Fc can be either one of the samples or can be interpolated from the samples in FIG. 42. That is, the measured channel could contain Fc, or Fc could be interpolatable from the measured channel.
2. The signal x(t) can be converted into a discrete sampled version; or x(t) can be generated as a discrete sample signal. The spectral frequency spacing of x(t) can be computed using the sampling frequency Fs, and the number of samples N: f_baseband=(−floor(N/2):ceil(N/2)−1)*(Fs/N). This is a standard method to compute the spectral content of the FFT operation given the length N of the samples and the sampling frequency Fs.
3. The spectral content X(f) can be computed by taking the FFT of x(t): X(f)=FFT(x(t)). In this, t can be a stand in for the typical n of the discrete version. As used herein, t can stand in for n.
4. The DC value of f_baseband can correspond to Fc in the channel model. Accordingly, the channel frequencies can be computed by adding Fc to the f_baseband frequency vector: f_channel=f_baseband+Fc.
5. For every frequency in f_channel, the channel response can be computed by interpolating within the measured channel response—that is, by interpolating the values in FIG. 42. If the current frequency is outside of the channel, zero can be substituted, or the end of the table, or an attempt to interpolate beyond the edge of the measured channel can be made. Any suitable substitute can be made. H(f)=interpolate(f_channel, channel_response_complex, channel_frequencies, ‘linear’, 0) may be a reasonable implementation in matlab, for example. The response_complex vector can be interpolated that contains the phase and amplitude information of the channel, organized by frequencies channel_frequencies. A linear interpolation can be done for all frequencies in f_channel, substituting a zero if a frequency f_channel is not within the channel_frequencies vector.
6. The frequency domain representation of X_Channel(f) can be computed by multiplying H(f) by X(f)—that is, X_Channel(f)=H(f)·*X(f).
7. The time domain representation of x_channel(f, t) can be computed by taking the inverse Fourier Transform: x_channel(f, t)=IFFT(X_Channel(f)). The time domain representation can then be dependent on time and the frequency of the carrier (f).

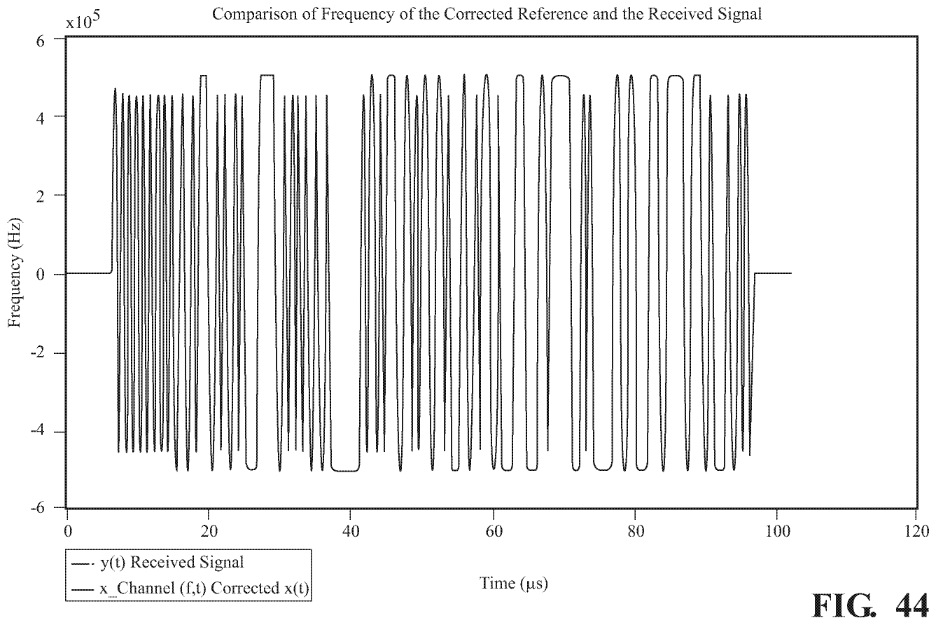

FIG. 44 shows a zoomed-out version of the frequency comparison.

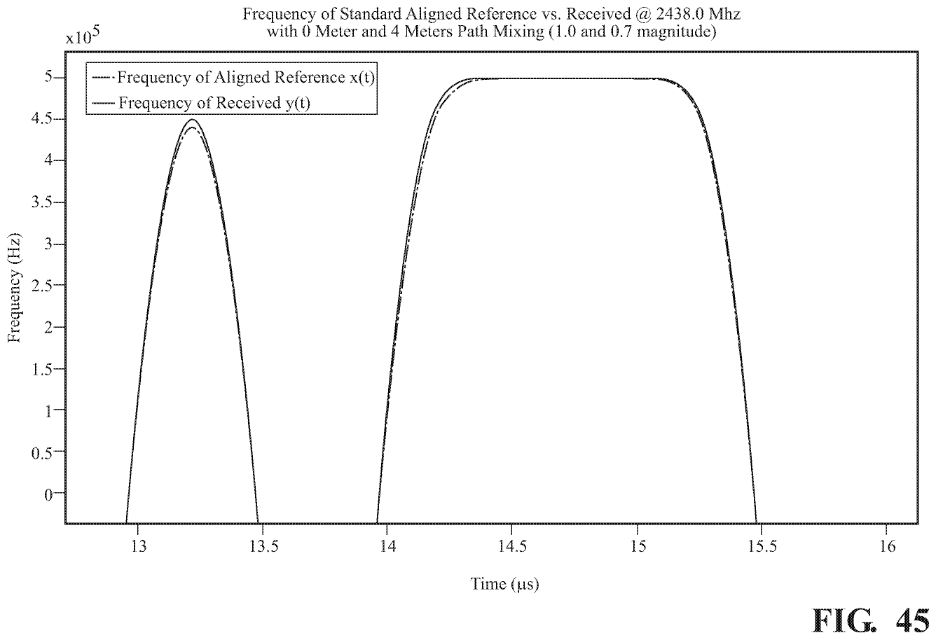

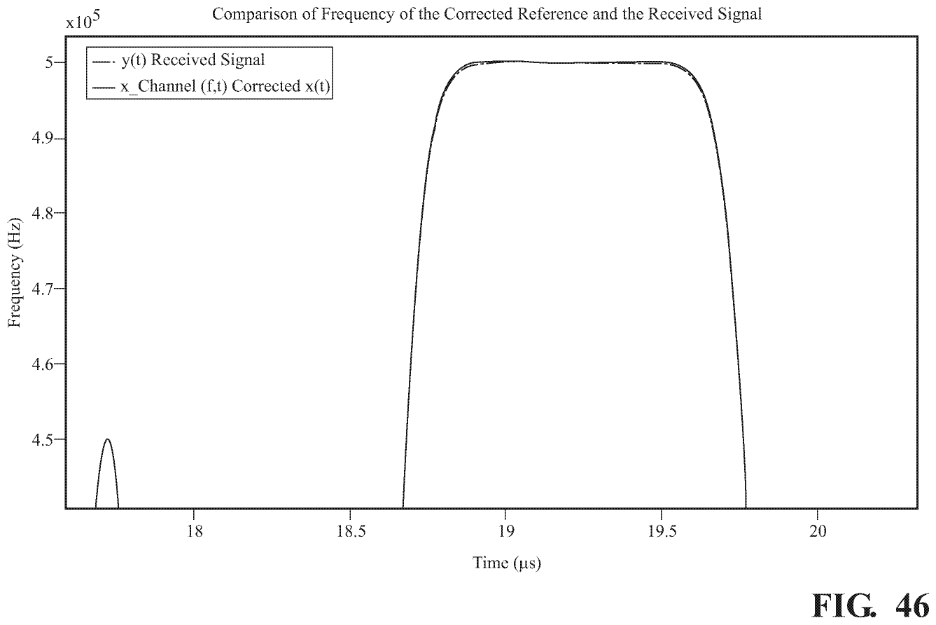

FIG. 45 shows the time aligned and uncorrected pulse shape figure, and FIG. 46 shows the corrected pulse shape. It should be understood that some distortion can exist in both figures, but the corrected shape figure can be a much closer match. This means that by correcting the pulse shape, a more accurate timing estimation can be obtained, since the timing shift can be encoded in the x_channel(f,t) signal; this is shown in FIG. 47. Further, any type of correlation metric, such as the Pearson Correlation, can be higher for the corrected pulse shapes. This can allow for higher margin and better ability to detect glitches an attacker might leave in the signal.

FIG. 46 is the corrected pulse shape x_channel(f,t) and y(t); as shown, there can be far less discrepancy between the pulse shapes until the very top of the pulse, and much less overshoot.

FIG. 47 shows the timing comparison difference between x_channel(t,f) and y(t). It can be seen that most of the time, the difference is zero, and on the edges the error increases to about +/−15 ns. The error on the edges can be created by the fact that the spectral content of x(t) exceeds the frequency range of the measured channel; in this case, 0 may not be a suitable interpolated value. This can be improved upon by measuring more frequencies, or by interpolating beyond the measured channel edges. However, in the worst case, it can mean that this technique may not be used when the bandwidth of the signal is not measured or estimated.

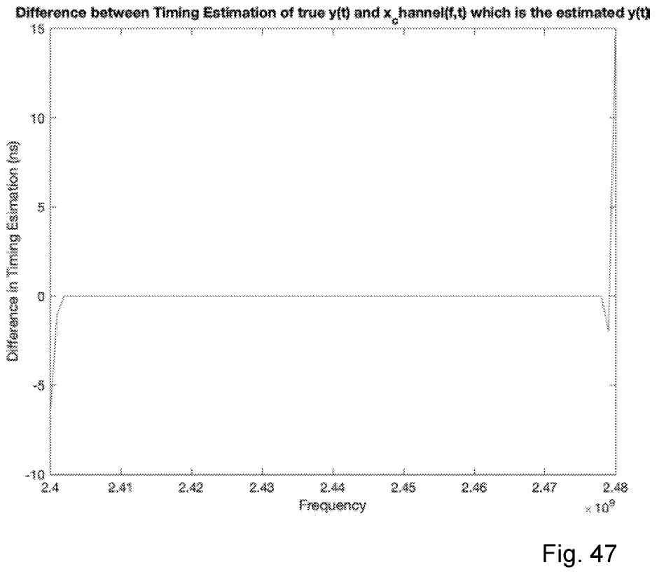

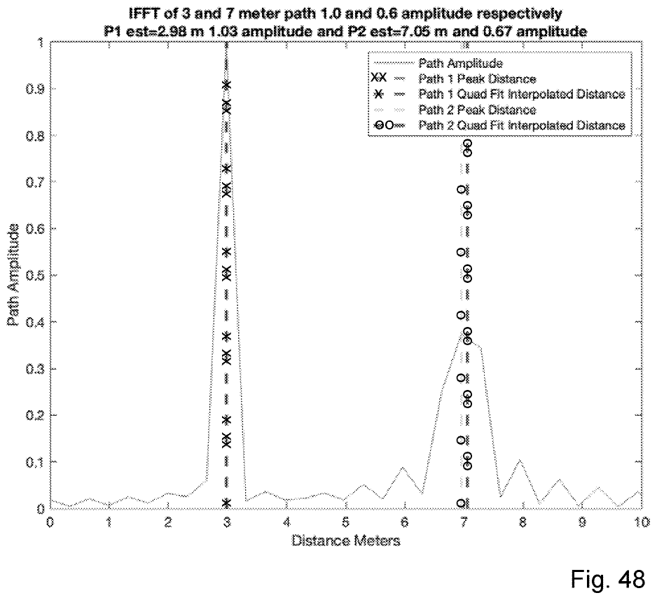

FIG. 48 shows that if the channel is sampled over a sufficient bandwidth, taking the IFFT of the channel response can produce easy to estimate path distance and amplitude information. Excluded from FIG. 48 is the phase of each path, which can also be obtainable by interpolation of the phase in the nearest bins to the peak. In fact, the estimated peaks and amplitudes shown in FIG. 48 can be a result of interpolation or averaging of the nearest bins.

The resultant estimated channel model may indicate there are two significant paths:
Path 1 Estimate: 2.98 meters with an Amplitude of 1.03, and
Path 2 Estimate: 7.05 meters with an Amplitude of 0.67.

The channel model can be built from the time domain model as previously described.

For each frequency/path in the path model, the following steps may be taken.
1. Compute the phase rotation of the path, combining the IFFT information of the path phase and the phase rotation by frequency and distance.
2. Compute the amplitude from the IFFT information.
3. Sum all paths; the complex valued result can be the channel response for the given frequency.

The channel model described above can be used to modify the pulse shape.

In some situations, the channel model or path model may not be known exactly. A maximum correlation value can be used to determine the best fit. The following steps may be repeated across multiple candidate channel models: use a channel model to modify the pulse shape, then perform a time alignment, then perform a correlation. The model that has the best fit can be selected as the most accurate channel model. In this way, even if the channel model is not known, it can be measured by the best fit of the pulse shape change.

### IV.C. Confirming Legitimate Transmitter Noise

In this section:

The signal x(t) is the ideal transmitted signal.

The signal nₜ(t) is the noise of the transmitter, which can be described as a noise profile in dBc/Hz at various frequency offsets from the carrier frequency.

The signal n_{c}(t) is the noise within the channel itself and ideally may be a low value.

The signal xₜ(t) is the noisy version of x(t) transmitted by the real transmitter.

The signal x_{tc}(t) is the noisy signal xₜ(t) passing through the channel, which may apply a distortion and a time delay as well as may introduce the channel noise. x_{tc}(t) may be a noisier and more delayed version of xₜ(t).

The signal y(t) is x_{c}(t)—this is the signal the receiver receives, ignoring any internal noise of the receiver.

In some embodiments, the transmitter noise profile forms part of the independently derived channel model. The independently derived channel model may include expected spectral noise characteristics, including phase noise or amplitude noise behavior, in addition to amplitude and phase characteristics of the propagation channel.

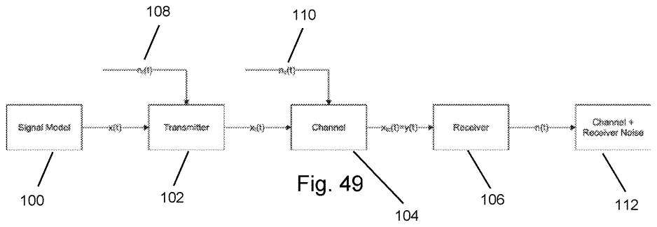

FIG. 49 illustrates the description above, showing a signal model 100, a transmitter 102, a channel 104, and a receiver 106, where transmitter noise nt(t) 108 and channel noise nc(t) 110 contribute to a resulting signal 112 with channel noise+receiver noise.

A receiver may desire to validate if there is an attacker in the middle, that is attempting to modify the channel.

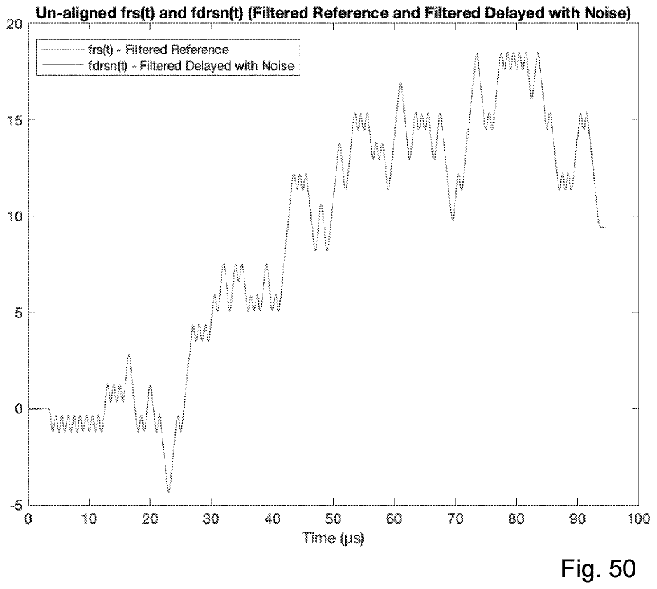

FIG. 50 shows a reference signal and a delayed reference signal with noise applied to it. It is visually challenging to see at this scale; however, the delayed reference signal lags the reference signal.

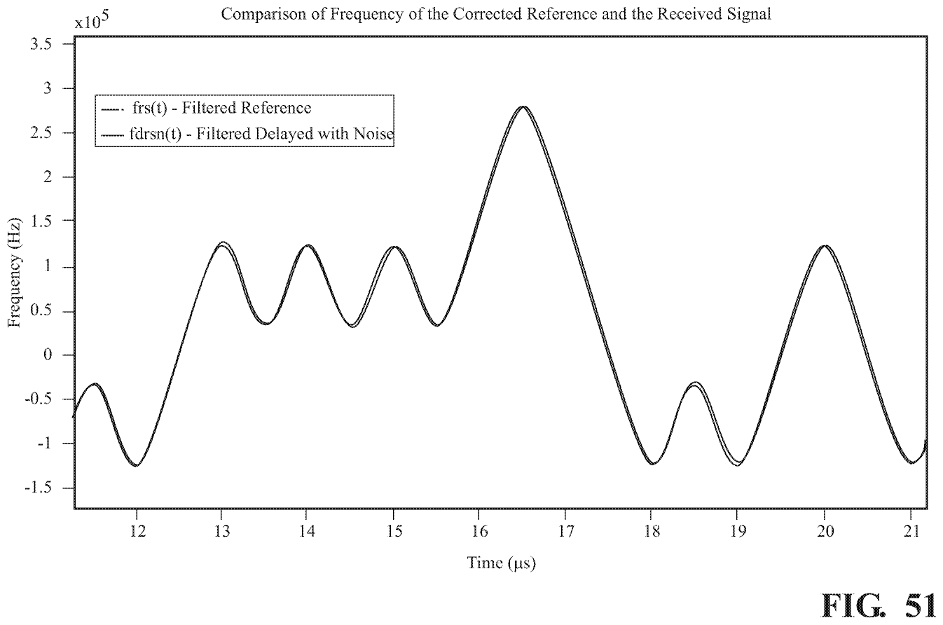

As depicted below in FIG. 51, zooming in, it is apparent that the delayed reference signal lags the reference signal, and that the delayed reference signal exhibits a slight wobble when compared to the reference signal.

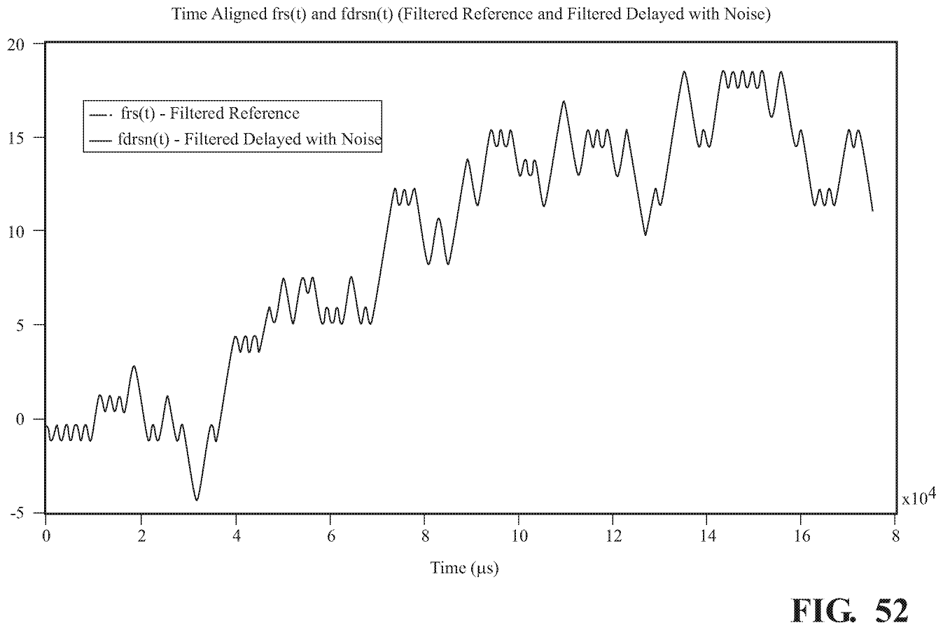

Using a correlation technique where a set of known symbols is cross correlated with both the reference and delayed copies of the signals, a time offset for each can be calculated. The offset could be an integer, aligned perfectly with a sample boundary, or fractional. Or based upon the received signal, a reference signal with a zero time delay offset can be built. FIG. 52 shows the result of performing a timing alignment of the reference and the delayed noisy signal.

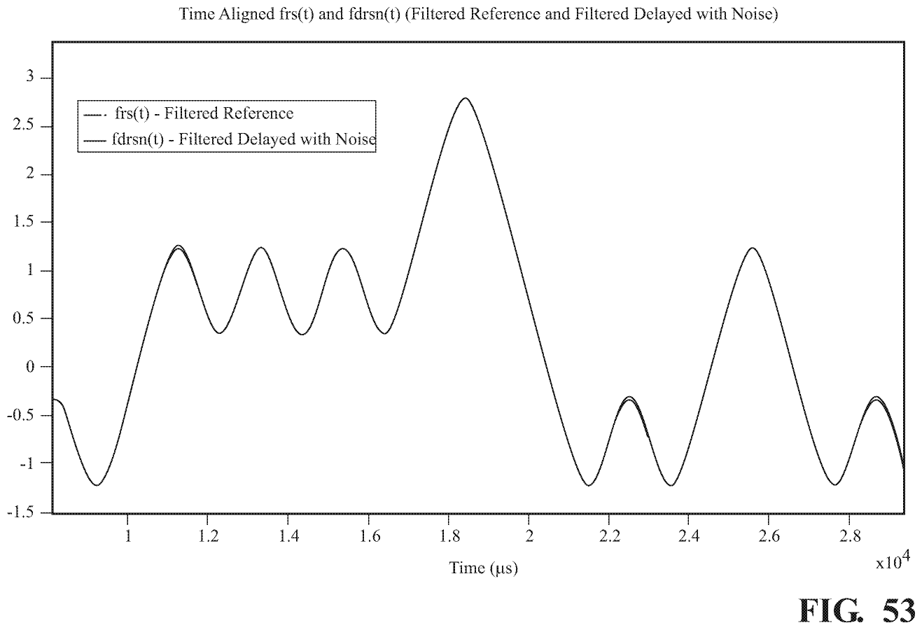

FIG. 53 is a zoomed in version of the reference signal and the delayed noisy reference signal. It is apparent that the average time of the signals can be identical; however, the wobble of the delayed noisy reference signal is more apparent. This wobble can be the result of the PLL Noise of the transmitter (in this case, we are assuming a perfect transmitter). Also, environmental noise could be a factor.

Now that the signals are time aligned, the noise can be computed.

Because frs(t) and fdrsn(t) are complex valued time domain objects, the reference can be subtracted from the noisy signal by the following equation:

noise(t)=fdrsn(t)·*frs(t)

More generally, frs(t) and fdrsn(t) are discrete valued sampled values. Therefore, they can be written:

noise[n]=frs[n]·*fdrsn[n]

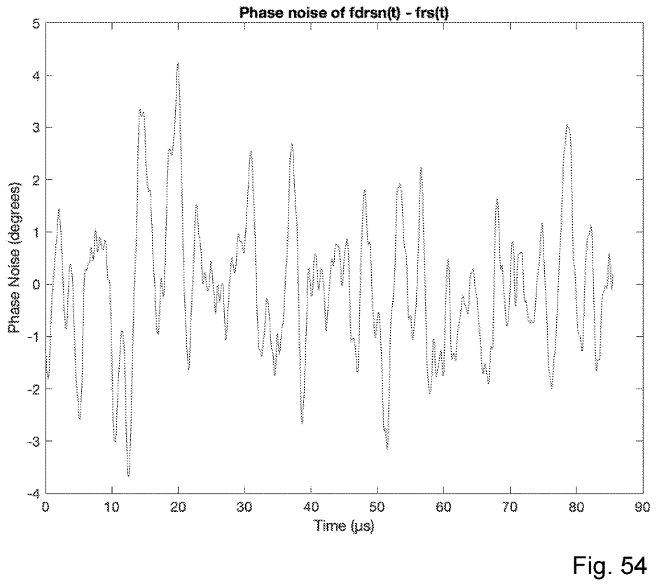

FIG. 54 shows the angle (in degrees) of the noise signal noise(t). It can be seen that multiple frequencies can contribute to the phase noise, and that in general, the lower frequency noise can be more powerful than the high frequency noise.

By taking the power spectrum of the noise using the FFT or other discrete Fourier transform algorithm and normalizing the power output, the noise power given the frequency bin size can be given for various frequency offsets. The noise power can be calculated by squaring the magnitude of each element of the FFT result then dividing by N², where N is the number of samples in noise signal.

The power spectrum can be converted to a bin size of 1 Hz by dividing the power spectrum by the frequency bin size. The frequency bin size can be given by taking the sampling rate of the noise signal and dividing by N.

The power spectrum can be converted to dB, making the units dBc/Hz by the following equation (PSD stands for Power Spectrum Density):

noise_{d}BcPerHz=10*log₁₀(PSD/1)

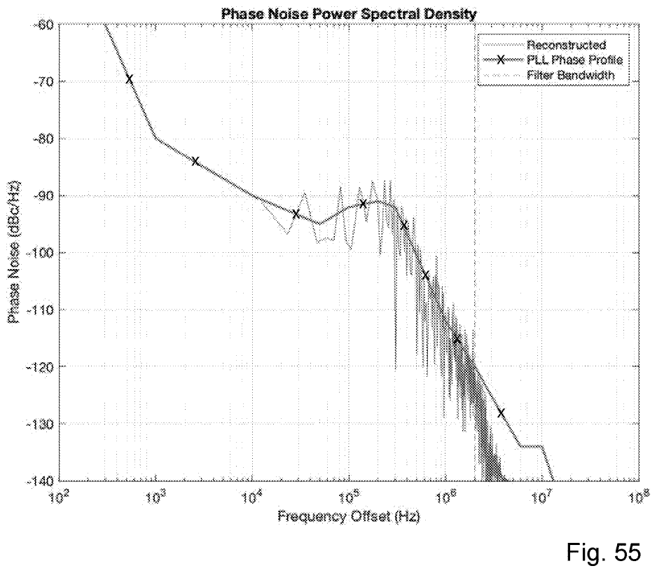

FIG. 55 shows that the phase noise profile (in solid line) can be extracted from the noise signal and that the noise profile can match the noise profile of the transmitter's PLL Phase Profile (shown as an ‘x’ line). That is, by time aligning the received signal with a perfect reference for the modulated signal, then subtracting the reference from the received signal to compute the phase noise, then converting the phase noise time series into frequency domain power spectrum in units of dBc/Hz, the phase noise of the transmitter's PLL can be estimated.

Also depicted in FIG. 55 is a vertical dashed line, showing the cut off frequency of the channel filter the receiver uses to reject adjacent channels. For frequencies higher than the cut off frequency, the solid line curve may no longer approximate the ‘x’ line curve.

A few things are apparent. If the receiver knows what the phase noise profile of the transmitter is, then it can be possible for the receiver to verify with some degree of certainty that transmitter PLL has the expected performance. That is, if the phase noise profile of the received signal does not match the curve, then the system may conclude that there is an attack present.

Also, the close in noise power may not have been effectively estimated, which may be primarily due to the receive signal not having a sufficient number of samples to provide the desired frequency bin size to achieve lower offset frequencies.

A method to improve upon this may include concatenating multiple received packets that have all been time aligned with their reference, or building one larger reference to match all the received packets. In order to concatenate the packets without causing high frequency discontinuities, the beginning phase of one packet can be set to the ending phase of the previous packet, and all elements in the received signal can be rotated the same amount as the first element. This can result in a smooth continuous unwrapped phase.

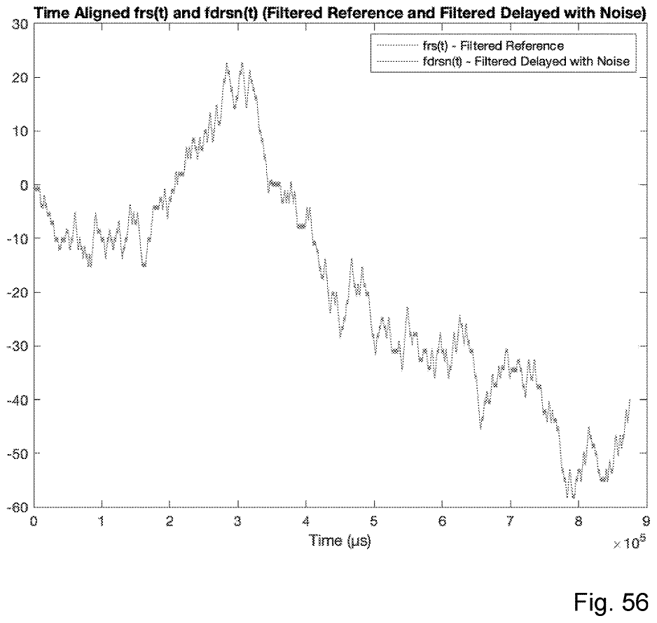

FIG. 56 depicts the unwrapped phase of multiple concatenated packets. This shows that the process of concatenating one packet onto the end of another with a smooth continuous transition can lead to a longer wave pattern to analyze.

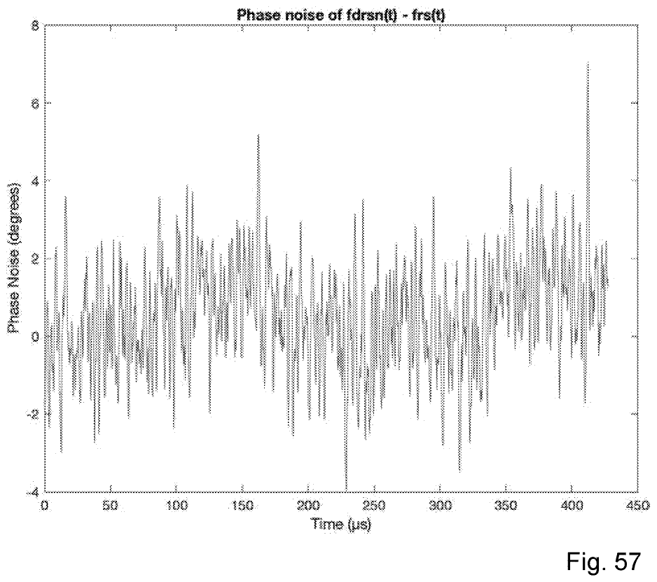

As depicted in FIG. 57, concatenating multiple packets can result in a longer time base of phase noise, which in turn can increase the frequency resolution of the FFT, which can make the first bin offset from DC closer in. This can enable more of the phase noise profile to be measured.

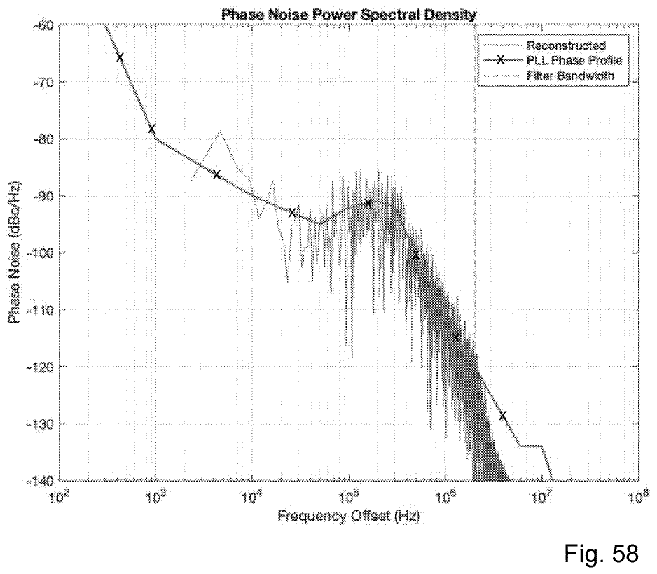

FIG. 58 depicts the result of 5 packets concatenated. As shown, the close in frequencies can have a smaller offset due to the larger number of samples creating a small bin size of the frequencies, allowing smaller frequencies to be measured.

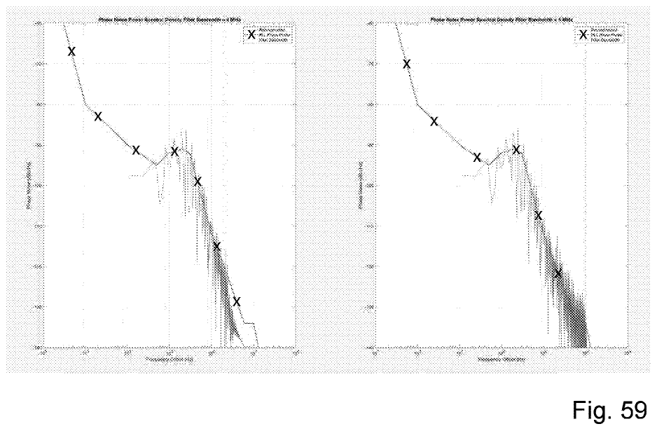

The effect of an exemplary channel filter is shown in FIG. 59.

As shown in FIG. 59, the wider channel filter on the right can allow more of the curve to be estimated (at the higher frequencies). One consideration can be the width of the channel filter. The wider the filter, the more of the phase noise from the transmitter's PLL can be observed.

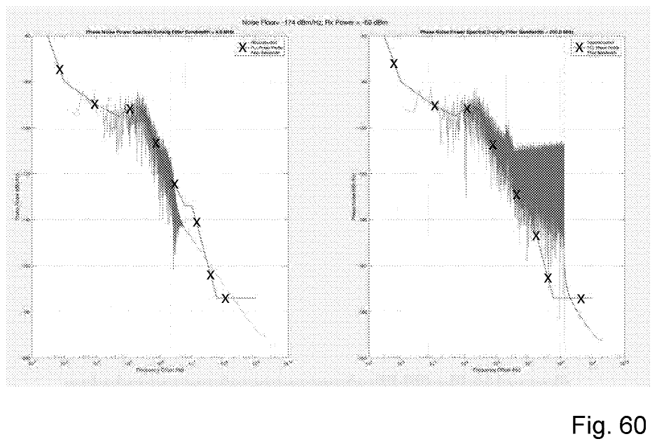

FIG. 60 shows the effect of an exemplary channel filter, but with the thermal noise.

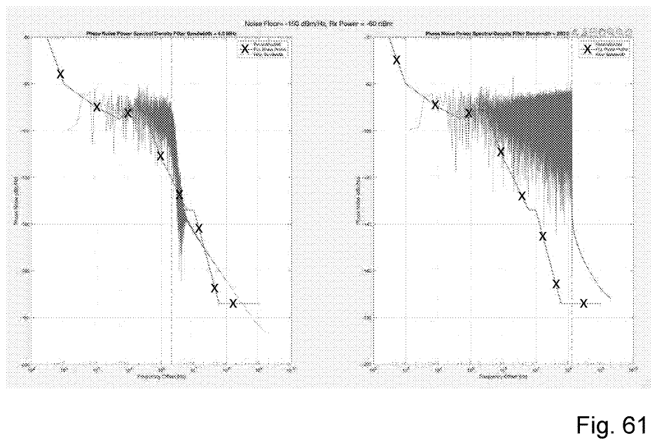

FIG. 61 shows the effect of an exemplary channel filter, but with a higher noise floor.

### IV.D. Detecting Glitches from an Attacker

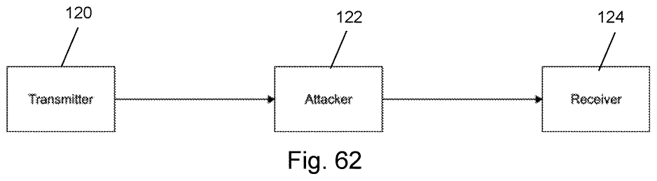

Consider an attacker that is listening to a legitimate transmitter and attempting to decode the symbols before the symbol is completed for the purpose of advancing the symbol in time; if performed successfully, the legitimate receiver may estimate the time of arrival of the signal as being earlier than would be expected considering the legitimate propagation delay. FIG. 62 depicts this concept, illustrating a legitimate transmitter 120, an attacker 122 attempting to advance symbol timing, and a legitimate receiver 124.

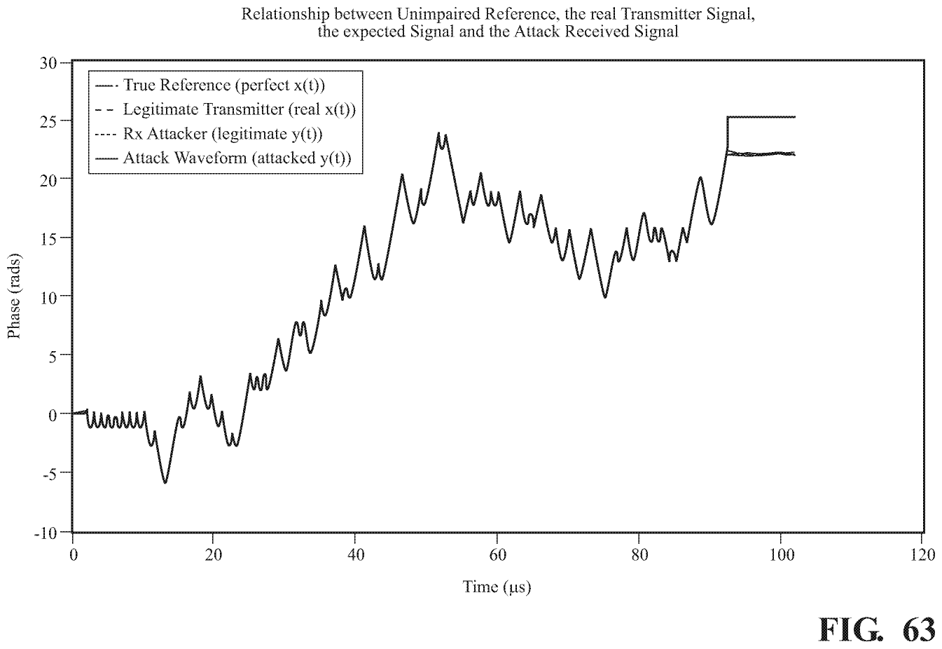

FIG. 63 shows several signals, all of which at the depicted scale are similar to each other except the output of the Attacker being different at the end of the depicted time frame. The True Reference is shown, which is x(t); this is the reference signal without any transmitter noise impairment. As described herein, the normal spectral noise profile can be measured and verified. The Legitimate Transmitter signal is also shown and which is x(t) with the transmitter impairments. The Legitimate Transmitter signal is the signal that an attacker can attack, and a time delayed version of the legitimate transmit signal can be what the legitimate receiver may receive under normal circumstances. The Legitimate Transmitter's signal is received by the attacker. In the example, there is zero delay added, because the purpose of the example is to describe the attack signals without complication of the delay. However, in reality, the phase can be rotated by the delay and a propagation delay can be present. And finally, the bold signal is the output of the Attacker, which can be the waveform sent to the legitimate receiver in an attempt to cause the legitimate receiver to estimate the time of arrival to be earlier than what is correct.

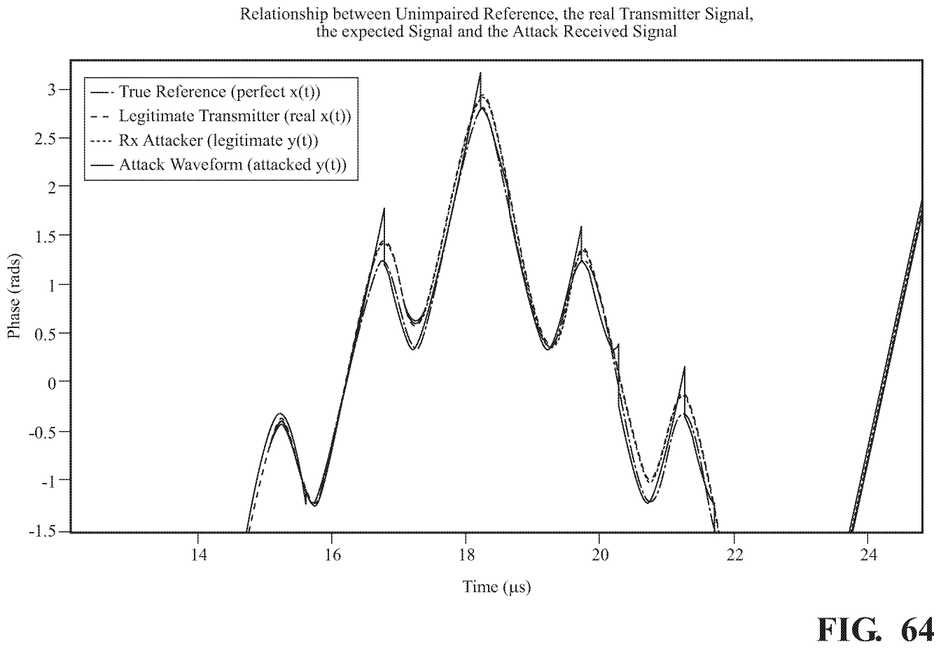

FIG. 64 shows in more detail the signals in FIG. 63 and as described above. It can be seen that the legitimate signal wobbles relative to the true reference signal. That is, the transmitter impairment that is attempting to make it more confusing and difficult for the attacker to decode the symbols can be causing the legitimate signal to deviate from the ideal reference. It was shown previously that the spectral content of this wobble can be measured. It also can be seen that the bold attack signal has glitches that appear as spikes with discontinuities. These glitches can be mistakes by the attacker attempting to decode the signal; during these glitches, the attacker may reverse its decision. It should be understood that in general, the bold attack signal can be on average more to the left than the legitimate signal. That is, the attacker could on average have advanced the timing. However, it may not be possible to advance the timing without also adding spectral content that is outside of the typical spectrum of the legitimate signal.

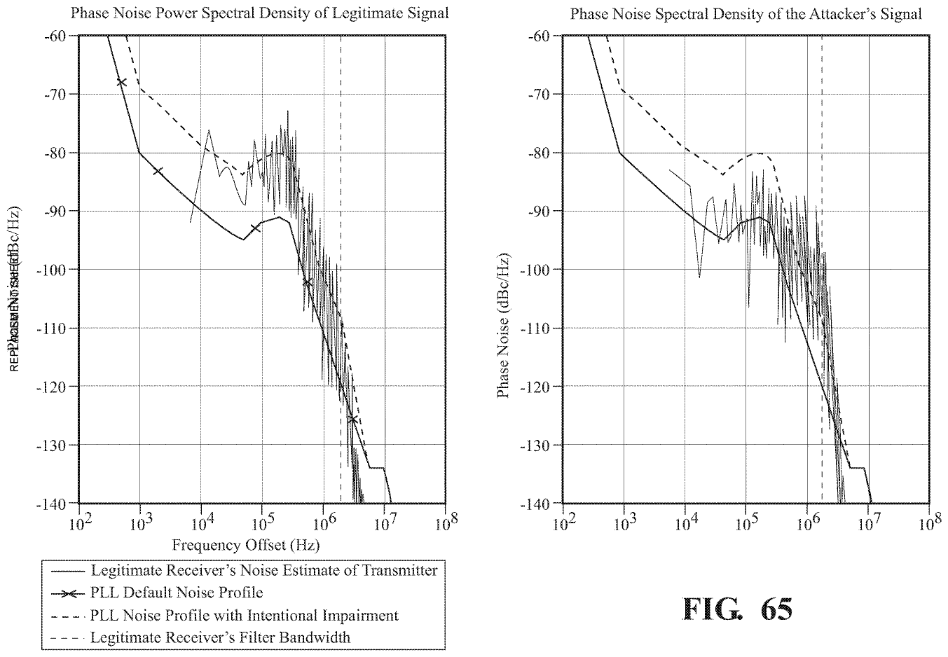

The legitimate receiver, or any receiver in the system attempting to confirm if an attack is present, may use less receive bandwidth than the true bandwidth of the bold Attack Waveform. However, as shown in FIG. 64, the sharp jumps in the bold Attack Waveform can have excess energy in higher frequency offsets from the channel center than the Legitimate Transmitter's signal. Even after the legitimate receiver filters the bold attack waveform, some excess energy outside of the envelope can exist. Looking for the excess energy at predetermined frequency offsets can be the basis of security. The ideal envelope of the legitimate transmitter can be known, either by design or by exchanging information prior to a ranging session. FIG. 65 shows the legitimate transmitter's noise profile (PLL Noise Profile with Intentional Impairment) in dashed line. This profile is described as dBc/Hz (decibels relative to carrier per Hz) at various offsets. That is a table of dBc values expressed at various frequency offsets in Hz. This noise profile can be distributed through the system, such that the profile is selected by a legitimate transmitter and the legitimate receiver(s) are aware of the currently selected profile. What is apparent in FIG. 65 is that absent an attack, the solid line signal representing the measured transmitter noise can approximate the expected noise profile. However, when an attacker is present, there may not be a good approximation of the dashed expected profile to the measured noise profile.

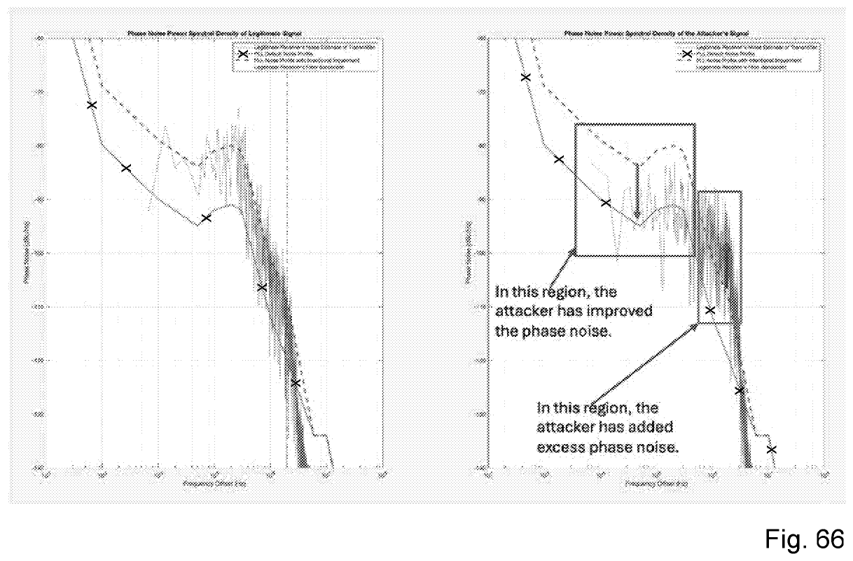

FIG. 66 illustrates some of the key points. For example, the closer in noise, as depicted in the range of roughly 10⁴ through 10⁶ Hz, the attacker can have improved the noise profile (the left box). The attacker might not always improve the noise profile; however, it is a possibility. FIG. 66 shows that a reduction in the noise profile from the expected noise profile can be sufficient to determine that there is an attack present and may be used by the system to make the determination that the system is being attacked. The second region of interest is centered around 10⁶ Hz (the right box). In this area, the attacker added additional energy, where the attacker may have tried to manipulate the symbols to appear earlier.

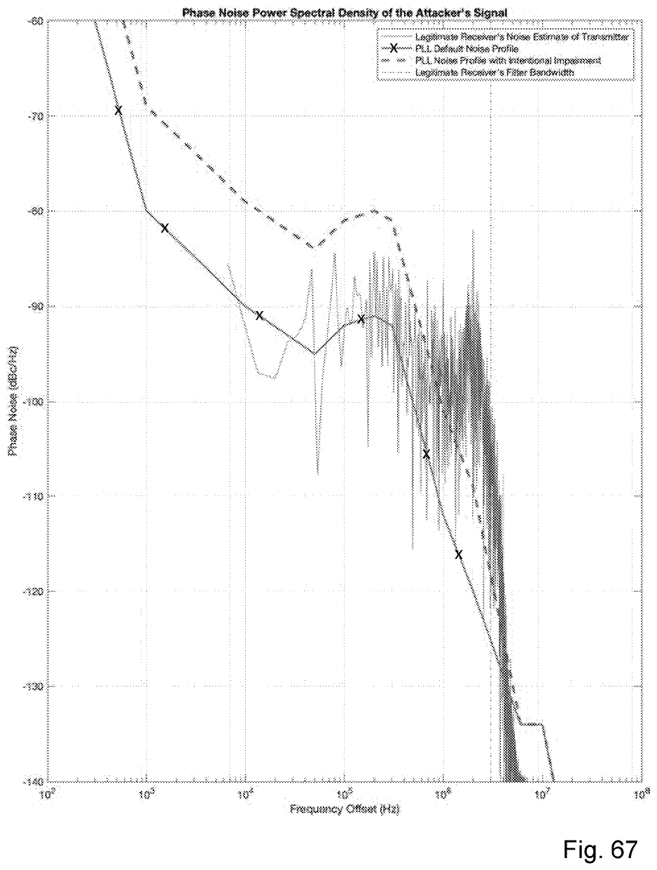

In FIG. 66, the legitimate receiver's filter bandwidth is 4 MHz. In FIG. 67, the legitimate receiver's bandwidth is 6 MHz. What is apparent in FIG. 67 is that the region of where there is excess energy is extended further to the right.

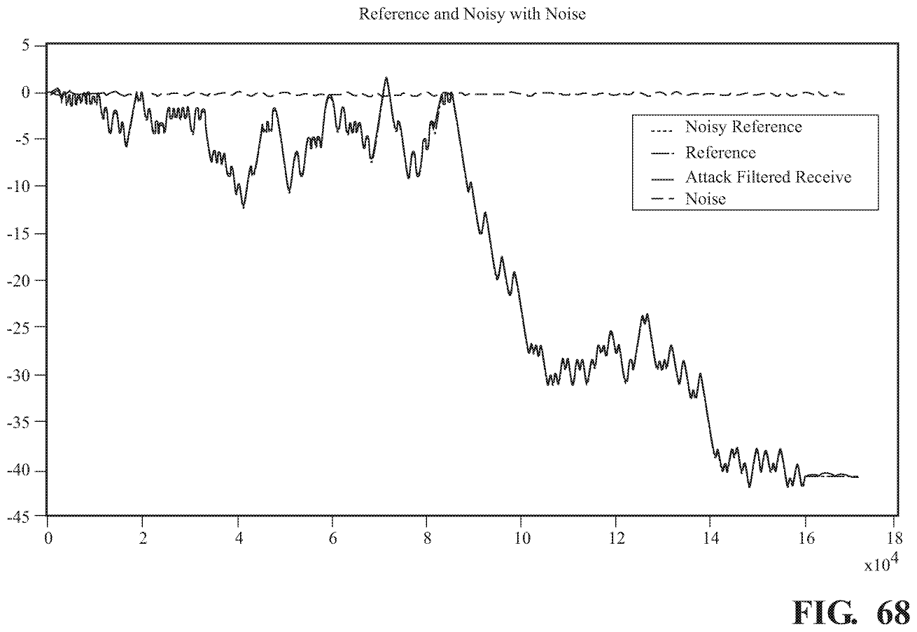

FIG. 68 shows the noisy reference (solid line), the perfect reference (solid line), the attack wave form (bold line) filtered by the legitimate receiver (the victim receiver in this situation), and the noise along the top of the plot.

By using the method described in the paragraphs above, an attacker may be required to reproduce the noise profile of the legitimate transmitter. Assuming the attacker has the ability to mimic the noise profile of the legitimate transmitter, the legitimate transmitter may mask its noise profile. That is, at intervals known by the legitimate transmitter and any confirming legitimate receiver, sections of the packet can be encoded using different noise profiles. In this manner, the overall packet can have a different noise profile than components of the packet. In one example, there may be two noise profiles that emphasis or de-emphasis noise at different frequency offsets. This emphasis may be slightly different noise levels at one offset, or raising or lowering the noise at different offsets, to create a different curve (the dashed line PLL Noise Profile with Intentional Impairment). During the first half of the packet, the first profile may be used. During the second half of the packet, the second profile is used. A naïve attacker without this knowledge might characterize the legitimate transmitter by averaging the entire packet. Instead, the legitimate receiver may confirm that the first and second half of the packet have different noise profiles, and that there is an approximate match to the corresponding expected profile during the first and second half of the packet.

The example above may not be considered the most secure version, since it may be possible to determine that there are two profiles and that the boundary between the profiles is 12 way through the packet. A more secure method may include cryptographically assigning symbol periods or blocks of symbol periods to 1 of N profiles.

Consider, for example, a packet containing 128 symbols. The symbols may be labeled S=1 to 128, and N=4, for 4 different noise profiles. % may be the modulo operator such that 1%2==1 and 2%2=0.

An algorithm could be to assign every 4^{th} symbol to one of the profiles, such as:
use Profile 1 if S %4==1,
use Profile 2 if S %4==2,
use Profile 3 if S %4==3, and
use Profile 4 if S %4==0.

An algorithm could assign every 4^{th} symbol to one of the profiles with a random offset RO, such as:
use Profile 1 if (S+RO) %4==1,
use Profile 2 if (S+RO) %4==2,
use Profile 3 if (S+RO) %4==3, and
use Profile 4 if (S+RO) %4==0.

An algorithm could assign profiles to blocks of symbols where the block size is B, with a random offset RO, such as:
use Profile 1 if (floor(S/B)+RO) %4==0,
use Profile 2 if (floor(S/B)+RO) %4==1,
use Profile 3 if (floor(S/B)+RO) %4==2, and
use Profile 4 if (floor(S/B)+RO) %4==3.

Selection of the parameters B and RO could be done by direct communication between the legitimate transmitter and legitimate receiver(s), or by the use of a deterministic random bit generator based upon cryptographic secret key material that only the legitimate transmitter and legitimate receiver(s) know.

Other algorithms that randomize the block size such that B varies from one block to the next can further make the transitions between one profile and the next more random and less predictable, increasing the ability for the legitimate receiver's confidence that there is no attacker present.

It is also possible to use a boundary between where the noise profiles are changed or are not aligned with an individual symbol. That is, B and RO may not be integers, and the offset and block size may contain a fraction of the symbol period.

Other types of metrics may be used. So far, the description in this section has been around confirming the noise profile using the single side band noise profile, where all the frequencies are positive. This can be a simplification, relying on the assumption that the noise profile of the legitimate transmitter is symmetric, meaning that for any given frequency offset there is an equal noise power in the positive and negative frequency directions. This can be typically true for devices operating normally. However, two facts are apparent. The first fact is the attacker may attack more rising or more falling edges depending on the symbol sequence and how the attacker is able to decode the symbols. This implies that the attack may have a bias. One way that a bias can be detected is by looking for an asymmetry between the noise spectrum of the positive and negative frequencies. If the legitimate transmitter is indeed symmetric as may be expected, the asymmetry may have been introduced by the attacker. A metric comparing positive and negative profile correlation match or a difference compared to a threshold at various offsets can be used to determine the degree to which there is an asymmetry. Converting the profile to linear power, integrating over a frequency range, and then optionally converting back into a dB scale before comparing to a threshold can also be an option for all the noise power profiles described herein. The second fact is that a legitimate transmitter may intentionally add asymmetry. The use of the methods described herein to confirm the noise profile could be applied to the positive and/or negative individually, or combined frequency range.

The point is that a legitimate transmitter can have a knowable noise profile that is updateable, and that the current selected profile can be shared amongst the system such that any legitimate receiver can know the profile. Further, it can be possible to reconstruct the noise profile from the packet, which can also be the Phase Based Ranging packet. The reconstructed noise profile can be compared to the expected noise profile, typically by comparing the integrated power over some range of frequencies and comparing to an expected power level.

### V. CONFIRMING SHAPE

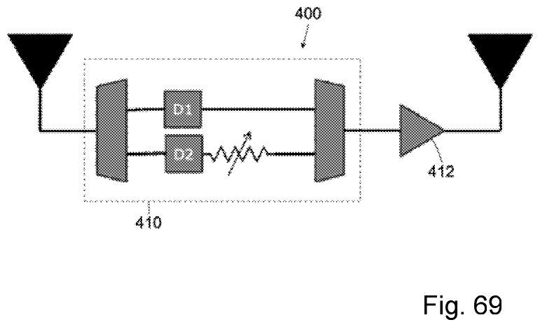

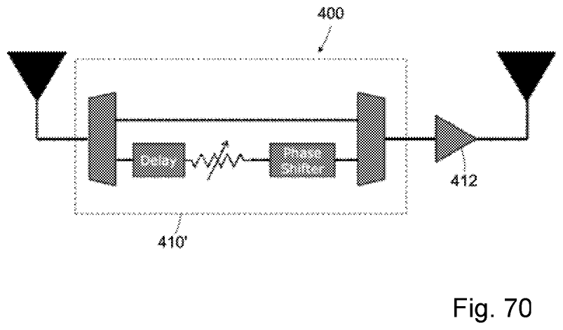

As disclosed in U.S. application Ser. No. 18/960,314, entitled SYSTEM AND METHOD FOR COUNTERING DISTANCE MANIPULATION ATTACKS, filed Nov. 26, 2024, to Golsch—the disclosure of which is incorporated by reference herein in its entirety—an attacker could implement an attack by modifying the channel. FIGS. 69-70 are figures from the referenced disclosure.

FIGS. 69-70 are not the only method an attacker could use to implement what can be called a Negative Group Delay filter. For example, Op Amps can also be used to create Negative Group Delay effects at a particular frequency. However, implementations of this type of filter can create a notch, and the notch can distort the channel in both amplitude and in phase. The methods described herein can be used to protect against an attack of this nature.

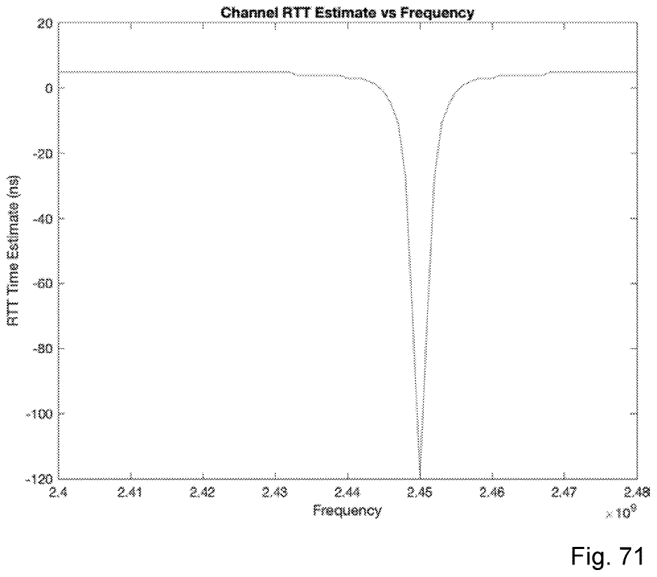

FIG. 71 shows an example of the effect attack from FIG. 70. The delay can be selected such that the lower path can be delayed 10 ns relative to the upper path, the phase shifter can be set to zero, and the gain resistor value can be set such that the lower path has 94% the amplitude of the upper path. FIG. 71 shows the notch effect regarding the RTT timing estimate with the center located approximately at 2450 MHz.

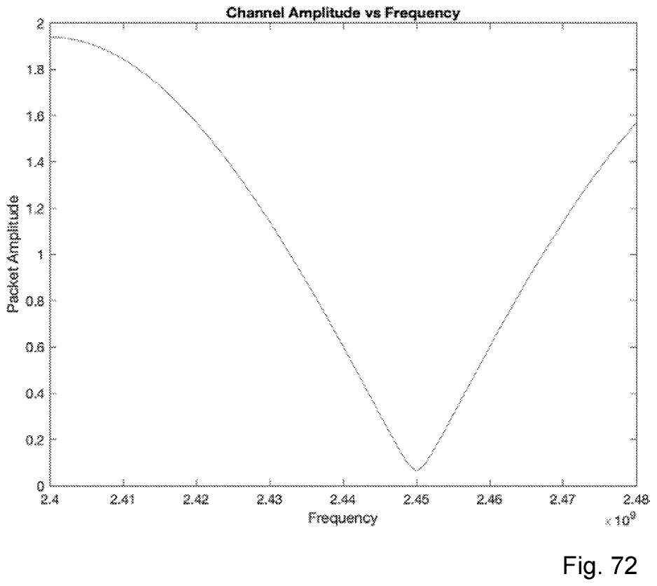

FIG. 72 shows that the channel can have a deep fading hole centered at approximately 2450 MHz, where the amplitude reaches a minimum, near total cancellation.

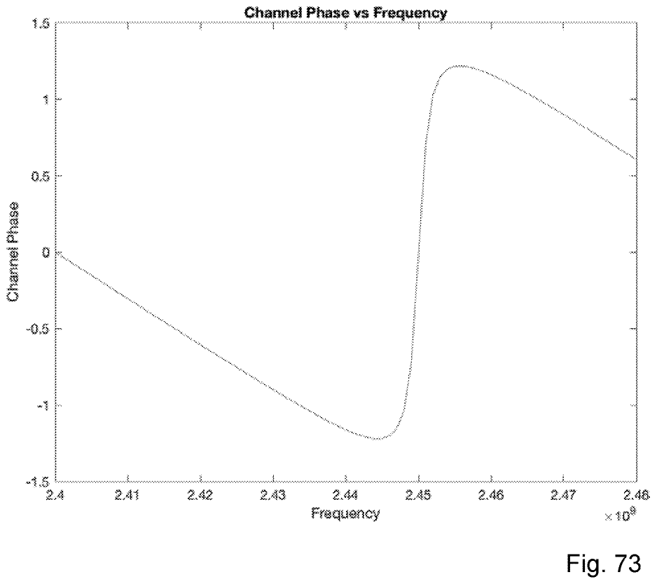

FIG. 73 shows that the group delay can be most negative (i.e. the slope of the phase is most positive) around 2450 MHz. This can correspond to the minimum amplitude and the most negative RTT estimates.

It can be seen in FIGS. 71-73 that the amplitude and phase can vary by the frequency. The attack hardware can be tuned to attack different frequencies, but relying upon the negative group delay inside the notch of the filter may introduce phase and amplitude errors that are frequency dependent.

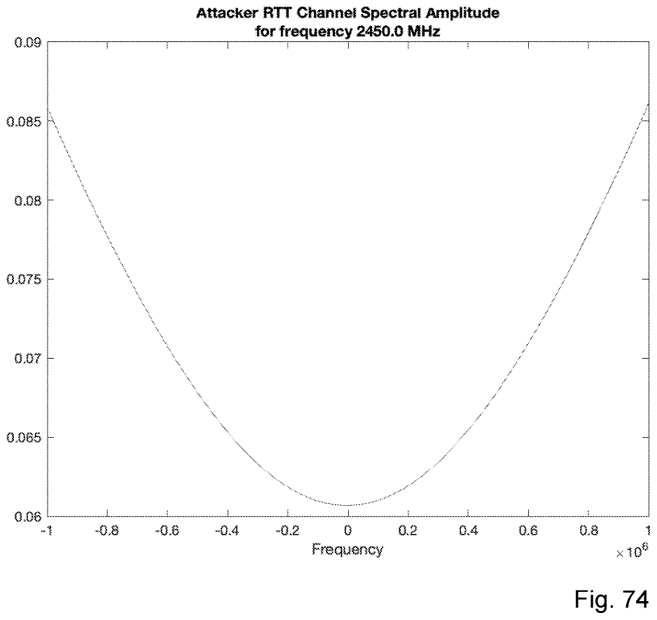

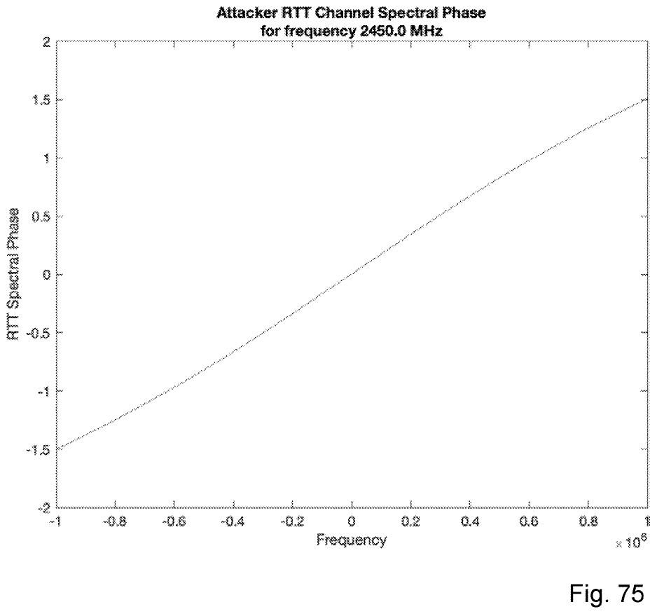

FIGS. 74-75 show an exemplary result of extracting the RTT Channel using the methods described previously at 2450 MHz, where the slope of the phase is most positive, and where the minimum in amplitude is achieved. FIG. 74 is of the amplitude of the channel as obtained by taking the frequency domain representation of the reference and of the received signal, and extracting the channel as previously described.

What can be seen in FIG. 74 is that the minimum amplitude is at approximately 0 Hz. This can correspond to the channel center, which is 2450 MHz. Also, it is noticeable that the amplitude is not flat and is approximately symmetric and approximately parabolic. This type of effect may be noticeable if the attacker tuned the attack hardware such that the notch of the attacker's filter was the channel center. After the legitimate receiver receives the packet, it can perform amplitude and phase checks, but perhaps more powerfully it can extract the channel and look for linearity of the channel's amplitude. Flatness of the channel may be desired, but the shape of the RTT channel amplitude should match the shape of the independent channel measurement, which may typically be from Phase Based Ranging measurements. This highly non-linear curve in amplitude could be a marker that the signal has passed through a notch filter.

FIG. 75 represents the same configuration as FIG. 74; however, the phase of the RTT channel is examined.

It is also apparent that there is an upward slope, which can correspond to the group delay being negative. As previously described, the slope itself could be an indicator of suspicious behavior, and it could be verified against the slope of the independently derived channel model such as the Phase Based Ranging measurements. But as previously described, if a timing error is made in the estimation of the start time of the reference signal, the slope of the measured RTT channel may change. However, more subtly, the phase response of the RTT channel phase in FIG. 75 is not linear, despite any error in estimation that causes an error in slope estimation.

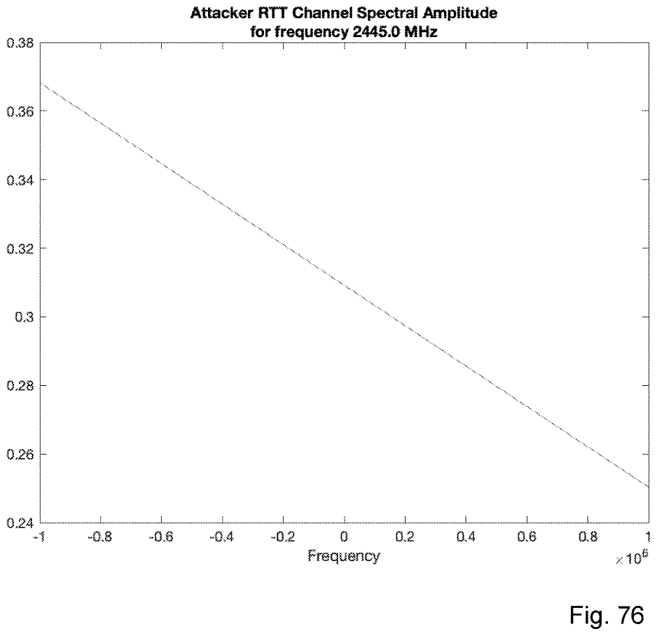

FIG. 76 shows the amplitude for a different frequency 2445 MHz. It is noticeable that there is a significant slope to the amplitude. This can indicate that the attacker has tuned the notch to the right of the frequency being attacked, which in this case could be 2445 MHz. If the slope were positive, the notch could be to the left. So again, the fact that the amplitude is not approximately uniform over the band of the RTT packet can indicate that packet has passed through the region close to the notch, and this could be used as a criterion to determine an attacker is present.

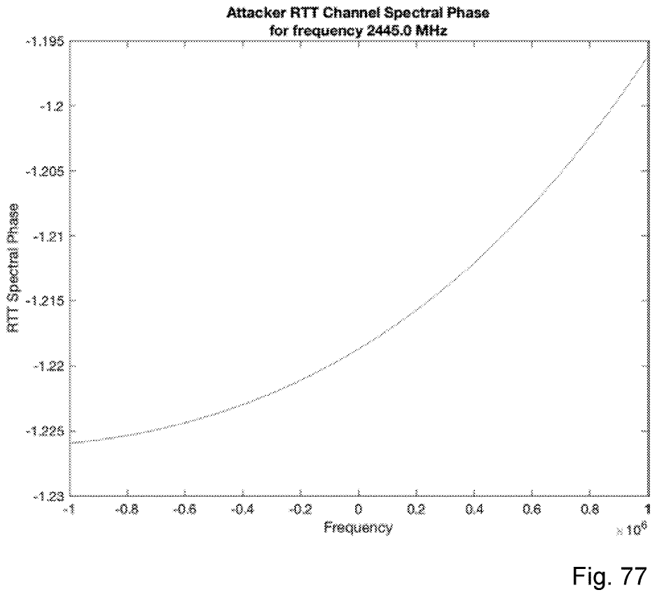

FIG. 77 shows the phase response of the RTT channel at 2445 MHz. It can now be observed that the phase response exhibits a negative group delay, since the slope is curving towards a more and more positive trajectory. Again, this could be an effect of the signal passing through part of the notch, but not the center. This is likely what an attacker would do to avoid the most apparent distortions of the notch. However, even in this case, an identifiable non-linearity of the channel phase is observed.

In FIGS. 74-77, different portions of the notch were inspected. It can be seen that for each frequency, there can be a non-linearity in either the amplitude of the channel over frequency, the phase of the channel over frequency, or both. The extent to which there is a non-linearity can be a good estimate of the severity of potential distortion of a negative group delay filter used by an attacker. Any suitable method for determining linearity as a numeric value can be used to produce a metric. This metric can be compared directly to a threshold to determine if the signal has passed through a filter that is considered insecure or not. Or the metric can also be computed for the expected channel measured independently, such as through phase-based ranging. The RTT channel metric and the independent metric then can be compared, by any method such as subtracting one from the other to compute the difference. The difference, or absolute value of the difference, can be compared to a threshold to determine the extent to which the metrics agree; a low agreement (large difference), for example, can be used as the basis to determine an attacker is present.

### VI. MULTI RECEIVER AND MULTI-CHANNEL CONFIRMATION

A receiver can use a channel filter and an adjacent filter. An illustrative arrangement is shown below:

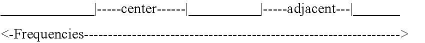

A receiver with multiple front ends can be configured for adjacent and center. The center channel can be the channel of the legitimate signal from the legitimate transmitter. The adjacent channel can be any other frequency band that is outside of the frequency band required to receive the legitimate signal. The purpose of the adjacent channel can be to allow the receiver to receive spectral energy of an attack signal. Because the attacker could be attempting to advance the timing of the legitimate signal, it may be impossible to do so without introducing frequencies higher than the spectral content of the legitimate signal. The legitimate signal often must follow some spectral mask to comply with regulatory and to avoid adding energy into the adjacent channels. An attacker often must violate this mask. By the addition of the adjacent receive channel, the spectral content within the adjacent channel could be measured. If the attacker places excess energy into the adjacent channel band, the receiver can measure the spectral power and compare it to an expected threshold. The adjacent channel also can act as a method to measure the background noise. The adjacent channel may simply be a continuation of the center frequency; it may be on one side, the other, or both. Multiple adjacent channels might be used. If more than one adjacent channel is used, the adjacent channels may partially or wholly overlap so that the spectrum of the overlapping regions may be compared to confirm if they match. The noise profile of the legitimate transmitter can be known, and the adjacent channel can be used to measure the noise profile at arbitrary offsets, which may not be knowable by the attacker. The confirming receiver or receivers may randomly choose adjacent channels to measure, so it may be difficult for an attacker to attempt to exclude adding energy into a specific band. Thus, the receiving system may be able to confirm a larger portion of the spectrum of the legitimate transmitter. Excessive power in an adjacent channel based upon its offset to the center frequency may be used as an input to tune the security algorithms or may be used as a criterion to decide an attacker is present. Likewise, mismatches in adjacent channel overlapping sections can be used to enhance the noise profile tuning of any security algorithm or as a criterion to decide an attacker is present.

In one embodiment, the adjacent channel measurements form part of the comparison between the estimated channel model and the independently derived channel model. Deviations in spectral energy outside an expected spectral mask may be incorporated into the attack detection metric.

A system with multiple receivers can be configured to listen to N−1 adjacent channels, assuming each receiver is only to tune to a signal channel at a single instant in time.

Furthermore, for a system of multiple receivers, each receiver may have a slightly different channel to the transmitter being confirmed. However, if the noise in the channel is such that both receivers can observe the transmission for the legitimate transmitter, each receiver can measure the noise profile of the transmitter according to the methods described herein. By making the observation, both the time domain noise profile (that is, the phase noise profile) and the frequency noise profile (that is, the single side band noise profile) can be compared. Each receiver can receive a similar noise profile if both receivers have a decent Signal to Noise Ratio of the received signal from the legitimate transmitter. Methods of autocorrelation, cross correlation, subtracting one profile to the other and performing variance, root mean error, full range (max-min), % of measurements within some range, etc. are all reasonable approaches to comparing one profile to the other. Multiple receivers may be able to closely agree on the noise profile of the legitimate device in both the time domain and frequency domain. Often, it is generally assumed that the confirming receiver is tuned to the same channel as the legitimate receiver; however, only sufficient overlap of the channel may be required if post processing is used.

Also, because the difference in multipath between the legitimate transmitter and each of the receivers is different, a few possibilities exist. First, phase and amplitude distortions that can be introduced by the different channels can differ; therefore, signatures of the phase/amplitude error can be checked by the methods described herein. Second, if a reasonable estimate of the channel model exists for the transmitter to each receiver, using the methods described herein, a time domain correction to the phase noise profile can be created to more accurately measure the noise of the transmitter, by removing the effect of the channel. The time domain representation can then be the basis for the frequency domain representation. The frequency domain representation of the amplitude and/or phase distortion caused by the multipath may be taken, and the spectral content may be subtracted from the measured spectral content of the noise.

An attacker may try to gain control of the antenna or antennas on one of the radios in the system. In this way, the attacker may attempt to remove any artifacts between the legitimate transmitter and the legitimate receiver, such that the SNR of the attack is improved. The legitimate signal being received by the legitimate receiver could be considered noise from the attacker's perspective. Therefore, the attacker may attempt to block the path or partially block the RF path. A method for detecting this is to have one or multiple devices in the system transmit simultaneously as the legitimate transmitter, but on a different channel—e.g., a companion signal. If the legitimate receiver can tune its receiver to receive both the legitimate signal and the companion signal and uniquely identify each, and the receiver has a good estimate of the channel effects and distortion of the channel between the companion signal transmitter and itself, the attacker could by virtue of partially blocking the path modify the channel between the companion signal transmitter and the legitimate receiver. Therefore, the system can protect itself by the following exemplary method:
1. Measure, in a trusted environment, the channel between each of the nodes in the system, or know the channel through a priori information, such as modeling or characterization in a test environment. The channel model can become a reference.
2. During reception of a purported signal that the system may need to classify as legitimate or an attack, one or more transmit nodes can transmit during the time slot of the legitimate signal on a different channel (the companion signal).
   a. The receiver can receive the purported signal and perform packet and/or channel level security checks (e.g. confirm noise, confirm channel, perform correlation (NADM) to a reference looking for glitches).
   b. The receiver (which can be either the radio receiving the legitimate signal or any radio sufficiently close to the legitimate receiver) can receive the companion signal and optionally perform packet level and/or channel level security checks. The receiving node can look for the effects in the channel in the received signal, and if the effects do not match the reference, the system may use this as a criterion to judge that an attacker is present.
3. If a receiver is unable to simultaneously receive on the legitimate and companion signal channels, and there is no suitably nearby radio that can be used to implement a simultaneous receive, it is possible to perform step 2 above in a time division manner. That is, either a short time before or a short time after, the legitimate transmitter may transmit, receive, or transmit/receive in any order, a packet or a set of packets spanning a single frequency or a set of frequencies, to establish the channel effects between the legitimate receiver and any confirming node. If the channel does not match the reference, the system may use this as a criterion to judge that an attacker is present.

### VII. PRACTICAL CONSIDERATIONS

As used herein, x(t) and y(t) are commonly used, and interchangeably at times, to mean continuous time and discrete time, or real value and complex valued. The interpretation of x(t) and y(t) are based on the context of the paragraph and section. Generally, x(t) and y(t) are discrete time signals that are complex, and sometimes x(t) and y(t) refer to the unwrapped phase, differentiated phase, or absolute phase of the complex signal.

As used herein, FFT and IFFT are mentioned as algorithms, which can be the common implementation of the Discrete Fourier Transform (DFT) algorithm; however, when used in this document, they should be interpreted as any Fourier or Inverse Fourier algorithm, whether it is discrete or continuous, based on the context of the signal.

Also as used herein, linear fit is mentioned often. To avoid describing the various best fit algorithms, which there are numerous, linear fit or best fit is used herein. This generally refers to the common practice of taking an organized set of X, Y data and performing a fit algorithm. Perhaps the most common technique is the linear regression. Some suitable algorithms include: Ordinary Least Squares Regression, Total Least Squares, Orthogonal Regression, Least Absolute Deviations/Huber Regression, Ridge Regression, or Bayesian Linear Regression. Each of these algorithms can produce a fit metric, such as R², Adjusted R², Root Mean Squared Error (RMSE), Mean Absolute Error (MAE), etc. Each of these metrics may be used to describe the linearity of the channel. Each metric can be compared to a threshold.

Also, because it was demonstrated herein that errors in estimation may result in differing slopes, it may be appropriate to perform detrending or alignment before computing the metric. More generically, this may be because it was demonstrated that the channel may have a curve to it. Checking for linearity may also be extended generically to checking the shape of a curve, to compare the shape of one channel model such as that obtained from Phase Based Ranging or UWB Channel Impulse Response to the local channel model of modulated packets. This may be done by the following exemplary algorithms: Nonlinear Least Squares such as Levenberg-Marquardt, Polynomial Regression, Spline Fitting such as B-splines or Cubic Splines, Radial Basis Function, or Gaussian Process Regression. Each of these algorithms can produce a numeric metric of the quality of the fit, some of which have already been listed. Some additional metrics include: Chi-squared, Normalized Cross-Correlation, Dynamic Time Warping, Max Error, and Peak Deviation. Any of these metrics can be suitable as the basis for comparing to a threshold. The list is not intended to be exhaustive, but may be informative of the potential algorithms.

Another thing to note is impairments. In real systems, the transmitter and the receiver may have different clocks that operate at different frequencies. This can introduce an error that is typically called Carrier Frequency Offset (CFO). The CFO can create a trend in the phase of the signal with respect to time; this can be due to the two devices not agreeing on the exact center frequency of the channel, and some residual rotational frequency can remain within the receiver. The CFO value may need to be removed before performing the calculations described herein. Channel Sounding itself can attempt to reduce the CFO to a small number to minimize the effects. CFO can also be measured in mode-0 packets, and CFO estimates can be obtained directly from the Phase Based Ranging measurements in methods known to a person of ordinary skill in the art. As used herein, the CFO is measured and estimated, and the effect of the CFO is removed by applying the appropriate counteracting rotation vector to cancel out the CFO vector. That is, the CFO effect can be added to x(t) or it can be removed from y(t).

Other impairments also can exist, such as Modulation Index (MI) errors. In such an error, the transmitter may bias towards a higher frequency deviation in either the 1 or 0 symbol direction. This can present itself like a CFO error, so it is worth having a good estimate of the CFO using another method and then measuring or characterizing the devices MI error. The effect of the MI error can be used as a device signature, as it can show up in the spectrum; therefore, it is applicable to leave the MI error present in y(t) when comparing to x(t). It is also possible to add the expected MI error to x(t) or remove it from y(t), or to leave it present. Likewise, the device may exhibit a positive or negative deviation in frequency that is symmetric to the bit transitions; this may not result in an effect that will look like CFO but will cause frequency overshoots or undershoots relative to the expected deviation for the symbol. Again, these can act as a signature, since they will show up spectrally; however, they can also be added to x(t) or removed from y(t).

There are also IQ imbalances or intermediate frequency residual errors which can be estimated and removed in the same method described above. Any type of impairment that can be measured and estimated can optionally be corrected before performing the analysis.

Further, the receiver itself can have some noise and impairments. These can and often should be characterized and calibrated in the receiver to the extent possible. However, some residual noise of impairments can remain. The statistical analysis of the fit of the noise profiles and of the shape of the curves in the RTT packet channel may be taken into account for the nature of the uncalibrated residual noise or impairments of the receiver. As used herein, RTT packet means any modulated data packet for which timing information exists or there is a desire or need to test hypothesis timing information by testing various candidate tau values. This can also be extended to where the tau value may be the time difference of two or more receivers observing the same packet(s).

Also the figures involving the Single Side Band profiles were produced by time aligning the signals and then subtracting one signal from another and looking at the spectrum, which is primarily focused on the phase of the signal. The amplitude variation may be considered, which often can be expected to be constant or nearly constant. For each instance herein where the phase of the signal is extracted and analyzed, the amplitude of the signal can also be analyzed by substituting phase with amplitude. Amplitude and phase may also be considered together or in conjunction with each other.

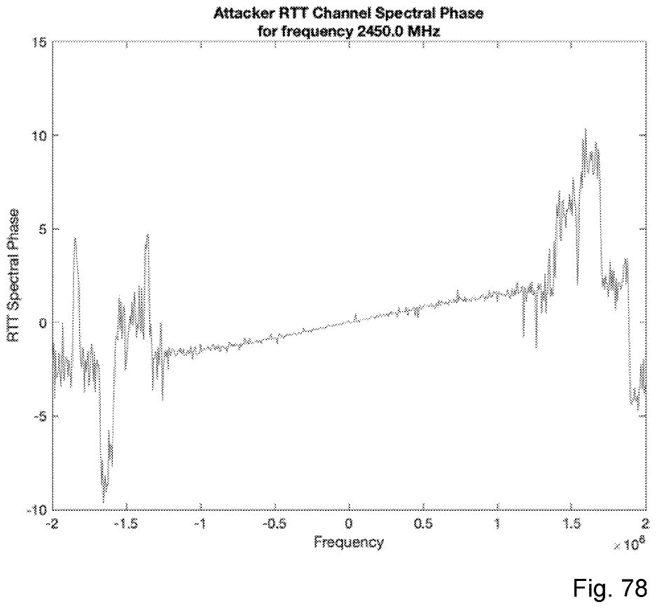

Further, there may be an effective bandwidth for which the phase and amplitude information of the channel can be extracted, which can correspond to the bandwidth of the signal. For example, as shown in FIG. 78, the bandwidth of the transmitted signal can be 2 MHz, and an effective range where the channel extraction is valid can be only slightly wider than 2 MHz, from ~=−1.2 MHz to +1.2 MHz.

### VIII. SYSTEM CONSIDERATIONS

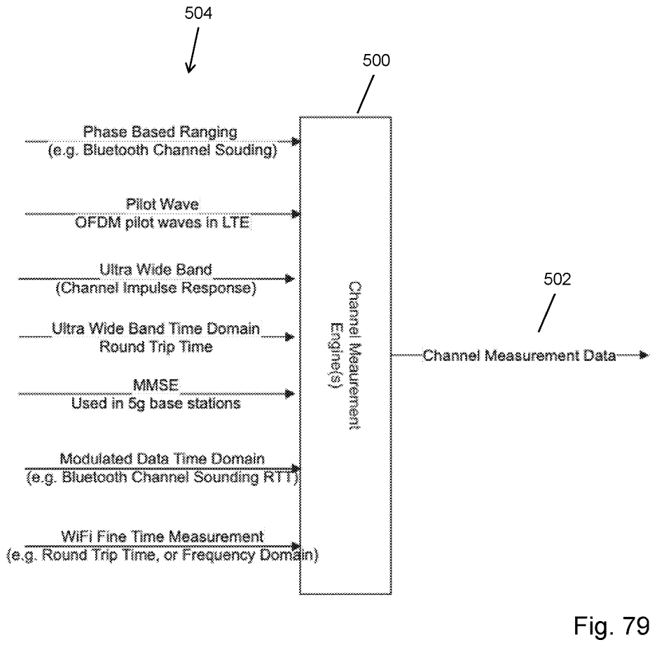

A system in accordance with the present disclosure can have the capability to take channel measurements or can have access to measurements taken outside the system and communicated to the system. FIG. 79 shows one or more channel measurement engines 500 configured to generate channel measurement data 502 from one or more independent channel measurement techniques 504. Either time domain or frequency domain channel measurements may be obtained regardless of the source. Herein, the result of Phase Based Ranging is an example of a Frequency Domain Channel measurement; there is a Complex value per Frequency describing the amplitude and phase of the channel for a given frequency. Examples of the time domain channel measurement include the Channel Sounding Round-trip time and Ultra-Wide Band (used in the Fine Ranging (FiRa) and Car Connectivity Consortium (CCC) specifications).

Once Channel Measurement Data has been obtained, it can be either used directly or converted into an alternative model. The Channel Model can be described by:
1. An Impulse Response in the time domain, in which convolution in the time domain can be required to compute the distortion of the signal;
2. An Impulse Response in the frequency domain, in which case multiplication of the channel response with the frequency domain representation of the signal and conversion back into the time domain can be required to compute the distortion of the signal;
3. Distance/Delay, Amplitude, and Phase information for N paths, where for each path, a delayed, phase rotated, and/or scaled version of the signal can be computed and summed with all other paths in the time domain to compute the signal distortion, which then can be converted into the frequency domain if necessary.

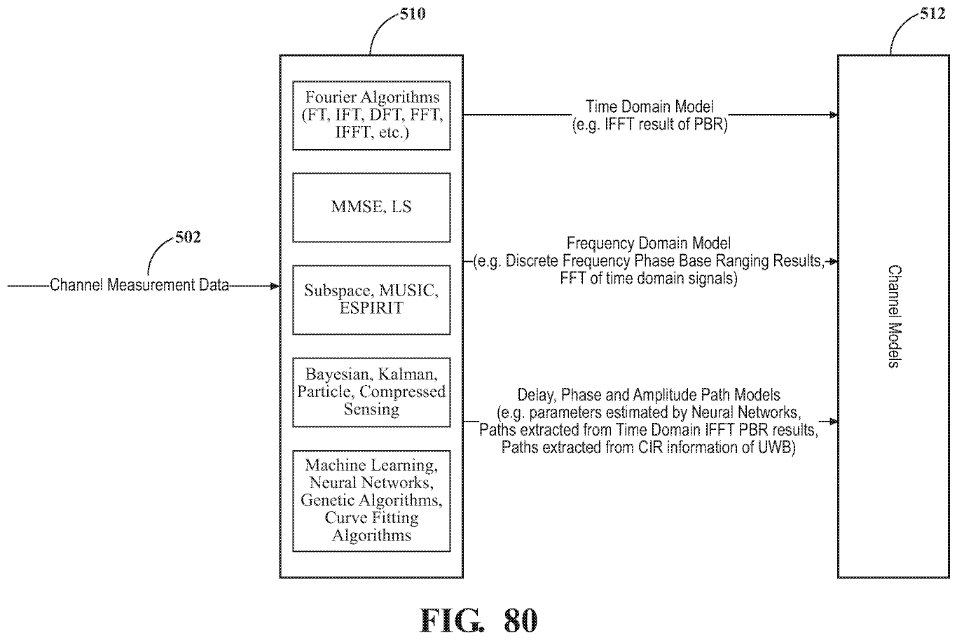

FIG. 80 shows channel measurement data 502 being processed by a channel model generation module 510 to produce one or more channel model(s) 512 representing the channel in time-domain, frequency-domain, or path-based form. Not shown in the diagram is a pass through, which may include some filtering of data to smooth the data, discard invalid or low-quality measurements, averaging, interpolation, upsampling, downsampling, etc.

The models above may not be computed within the system boundary and may be communicated to the system via a link, for example a secure link that has established trust and role authorization. This may be a wireless link or a physical wired link. Example wireless links include Bluetooth, Wi-Fi, etc. Examples of physical wired links include Ethernet and local vehicle buses such as CAN, LIN, etc. Herein, the Channel Model refers to a time domain or a frequency domain, or an intermediate Channel Model such as the Path, Phase, and Amplitude Model, which are generally interconvertible. The Channel Sounding, UWB, Wi-Fi, FTM Round-trip time Stamps can be considered a reduced Delay, Phase, and Amplitude Path Model. The Phase and Amplitude may not be directly measured or may involve collecting information from various sources.

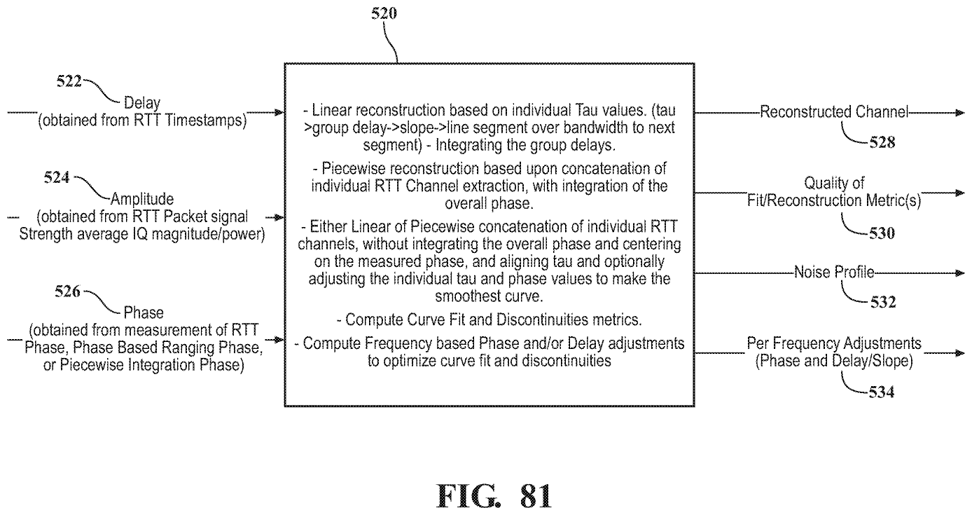

FIG. 81 describes a reconstruction module 520 configured to receive delay information 522, amplitude information 524, and phase information 526, and to produce a reconstructed channel model 528 along with quality metric(s) 530, noise profile information 532, and per-frequency adjustment values 534. FIG. 81 illustrates that the system can take information Delay, Amplitude, or Phase information; this may come as part of a single measurement source or as disparate measurement sources. By using the mathematics and concepts described herein, a channel can be reconstructed. As an example, Phase Based Ranging can result in a single complex number per frequency. When the phase of the complex numbers are unwrapped, the derivative of the slope can be the group delay, which can be directly convertible into Delay; the magnitude of the complex number can be the Amplitude; and the Phase can be the angle of the complex number. Therefore, Phase Based Ranging results may be self contained. Alternatively, RTT packets may only contain Delay and Amplitude. In such a case, Phase may need to be obtained from another source, or even the amplitudes may need to be cross referenced with another source such as Phase Based Ranging.

The system may reconstruct the channel through these sources. For example, the RTT Delay can be converted into a slope, and the slope can be piecewise stitched together as earlier described. Alternatively, the RTT local channel can be extracted from the received modulated data, by creating the appropriate time shifted reference and extracting the channel. The reconstructed channel may also contain a noise profile and a metric or set of metrics that describe the quality of the reconstructed channel. The noise profile may also be computed at this step by subtracting the time aligned reference signal and computing the time domain and frequency domain representation of the noise and comparing to an expected profile. A time domain profile could be checked by alignment and correlation if the transmitter and receiver agreed a priori on the time domain noise profile. Also, all the inputs could span several packets or transmissions and be concatenated together as described herein. At this stage, or at a later stage, optimization of the metric can be performed by trying to align each segment such that the discontinuity from one segment is minimized, by adjusting the vertical offset by changing the average phase of the segment, and by modifying the slope by updating the tau value. This stage can also output the adjustments made that may minimize the curve fit error metrics. These adjustments can be later used to update the measurement data if necessary.

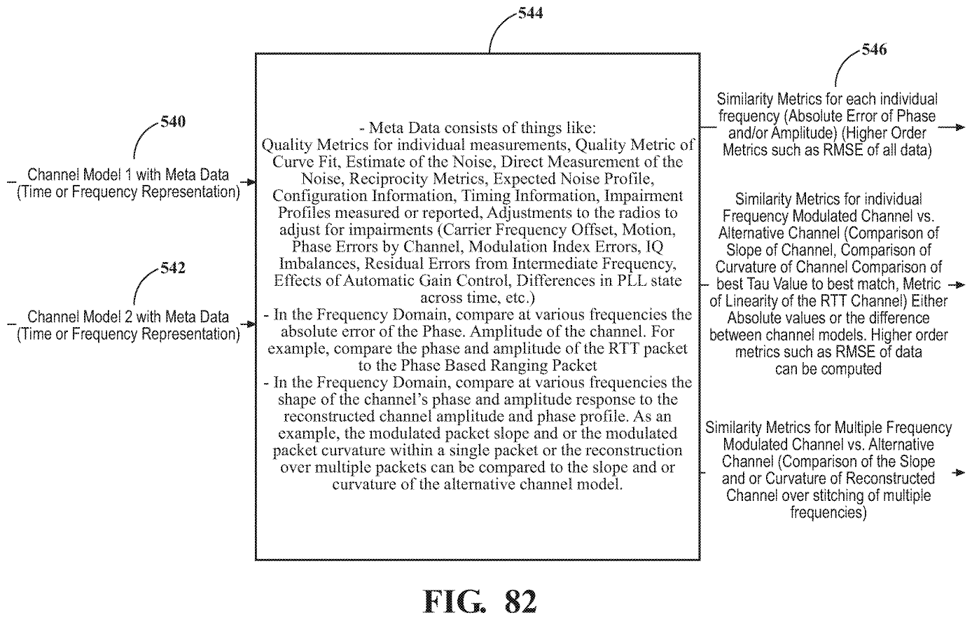

In FIG. 82, a first channel model 540 and a second channel model 542 are provided to a comparison module 544, which can generate one or more similarity metric(s) 546 which can be indicative of agreement between the channel models. The first channel model 540 may typically be a measured channel model, such as the channel model measured from Phase Based Ranging; this may be the one-way phase and amplitude response of the channel. The second channel model 542 may be a reconstructed or partially reconstructed channel from modulated data. As shown previously, modulated data can be used to check for distortion that the channel causes, and portions of the channel can be recovered from modulated data. The comparison module 544 can take the channels along with all available meta data, which may be measured impairments, expectations of the channel and noise, configuration data, as well as quality metrics associated with the noise and fit of the channel to expected values. The comparison module 544 then can inspect the Phase or Amplitude of each sample individually. The comparison module 544 can also inspect each local modulated data channel individually by comparing the slope and curvature, phase, and amplitude for the frequencies in the alternative channel where there is a valid overlap, which may be more or less equal to the signal bandwidth. Quality metrics 546 that can describe the degree of match of the curves by comparing the slope and shape can be produced. Internal metrics looking for the noise and smoothness of the reconstructed channel can also be produced. When taking the FFT of the reference and the received signal, noise can propagate through the FFT operation, which may lead to disturbances in what should otherwise be a smooth continuous curve. And finally, fit of multiple segments of the channel over multiple modulated data packets can be compared using the same method of comparing the shape of the segment of the reconstructed channel with the overlap with the alternative channel. However, additional metrics can be used and become available; for example, discontinuities between sections can be used to gauge confidence in the reconstructed model. One channel may be subtracted from the other to obtain an error in the channel estimates. A perfect match can result in zero error. Segments of the channel that have low match can be excluded or can be adjusted (finding a better tau, or a better phase offset). The lack of or presence of adjustments can be used as a decision about the quality of the similarity of the channel models.

Although not depicted in FIG. 82, the time domain representations can also be compared in a similar fashion. For example, the Phase Based Ranging results can be converted to a path, amplitude, and phase model for multiple paths. The frequency domain representation of the channel can be reconstructed from the paths, and this can be fed back into the block described above and compared to original phase based ranging measurements. This can act as a quality metric of how well the time domain representation using discrete paths matches the raw measurements. If there is a good match, this can help reject some of the frequency to frequency measurement noise.

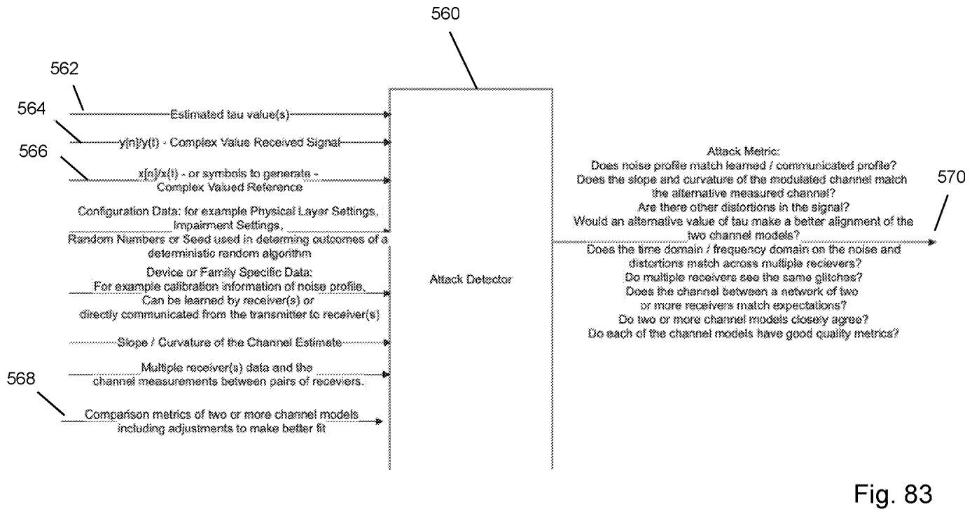

FIG. 83 shows an attack detector 560 configured to receive a tau input 562, a received signal input 564, a reference signal input 566, and a channel comparison input 568, and to generate an attack metric 570. There may be additional content described herein that is not included in FIG. 83, so generally any concept described herein that can be converted into a numeric score can be used in an attack decision metric. The attack metric 570 can be used by the system to either enable or disable certain features based on the confidence that that signal(s) used to locate a device are secure or have been tampered with. The Attack Metric 570 can be a Boolean True/False value, an enumerated value, or a floating point value. In one embodiment, if the difference between the estimated channel model and the independently derived channel model exceeds a threshold indicative of channel manipulation, a security action may be initiated, including disabling ranging functionality, reducing trust level, logging a security event, requesting re-authentication, or switching carrier frequency.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. A method of securing a communication channel between a first device and a second device, the method comprising:
transmitting, by the first device, a plurality of transmit signals over the communication channel, the plurality of transmit signals including at least a first transmit signal at a first carrier frequency and a second transmit signal at a second carrier frequency different from the first carrier frequency;
receiving, by the second device, a corresponding plurality of receive signals resulting from propagation of the plurality of transmit signals over the communication channel, the plurality of receive signals including at least a first receive signal resulting from propagation of the first transmit signal over the communication channel and a second receive signal resulting from propagation of the second transmit signal over the communication channel;
estimating, based on at least the first receive signal, a first frequency-domain channel response associated with the first carrier frequency;
estimating, based on at least the second receive signal, a second frequency-domain channel response associated with the second carrier frequency;
generating an estimated channel model by combining the first frequency-domain channel response and the second frequency-domain channel response into a unified frequency-domain channel response characterizing channel behavior across a frequency range spanning at least the first carrier frequency and the second carrier frequency;
obtaining an independently derived channel model for the communication channel; and
comparing the estimated channel model with the independently derived channel model.

2. The method of claim 1, wherein estimating the first frequency-domain channel response comprises computing a frequency-domain relationship between an estimated first transmit signal and the first receive signal.

3. The method of claim 2, wherein the estimated first transmit signal is based on demodulated data from the first receive signal.

4. The method of claim 2, wherein the frequency-domain relationship comprises a ratio of a frequency-domain representation of the first receive signal to a frequency-domain representation of the estimated first transmit signal.

5. The method of claim 1, wherein the plurality of transmit signals comprises round-trip time (RTT) packets exchanged between the first device and the second device.

6. The method of claim 1, wherein combining the first frequency-domain channel response and the second frequency-domain channel response comprises:
determining a first line of best fit representing the first frequency-domain channel response over a first frequency band associated with the first carrier frequency;
determining a second line of best fit representing the second frequency-domain channel response over a second frequency band associated with the second carrier frequency;
applying an offset to at least one of the first line of best fit and the second line of best fit to reduce a phase discontinuity at a boundary between the first frequency band and the second frequency band; and
joining, after applying the offset, the first line of best fit and the second line of best fit across the first frequency band and the second frequency band.

7. The method of claim 1, wherein comparing the estimated channel model with the independently derived channel model comprises detecting that a difference in at least one of a channel phase, channel slope, channel group delay, and channel amplitude between the estimated channel model and the independently derived channel model exceeds a threshold indicative of channel manipulation.

8. The method of claim 7, further comprising initiating a security action when the threshold indicative of channel manipulation is exceeded.

9. The method of claim 1, further comprising updating the estimated channel model based on the comparison between the estimated channel model and the independently derived channel model.

10. The method of claim 1, further comprising determining a confidence metric for the communication channel based on the comparison between the estimated channel model and the independently derived channel model.

11. The method of claim 1, wherein the independently derived channel model is generated using channel measurements obtained independently of the plurality of transmit signals.

12. The method of claim 1, wherein the independently derived channel model is generated using phase-based ranging.

13. A system for securing a communication channel, the system comprising:
a receiver configured to receive a plurality of receive signals resulting from propagation of a plurality of transmit signals over the communication channel, the plurality of transmit signals including at least a first transmit signal at a first carrier frequency and a second transmit signal at a second carrier frequency different from the first carrier frequency, the plurality of receive signals including at least a first receive signal resulting from propagation of the first transmit signal over the communication channel and a second receive signal resulting from propagation of the second transmit signal over the communication channel; and
a control system coupled to the receiver, the control system configured to:
estimate, based on at least the first receive signal, a first frequency-domain channel response associated with the first carrier frequency;
estimate, based on at least the second receive signal, a second frequency-domain channel response associated with the second carrier frequency;
generate an estimated channel model by combining the first frequency-domain channel response and the second frequency-domain channel response into a unified frequency-domain channel response characterizing channel behavior across a frequency range spanning at least the first carrier frequency and the second carrier frequency;
obtain an independently derived channel model for the communication channel; and
compare the estimated channel model with the independently derived channel model.

14. The system of claim 13, wherein estimating the first frequency-domain channel response comprises computing a frequency-domain relationship between an estimated first transmit signal and the first receive signal.

15. The system of claim 14, wherein the estimated first transmit signal is based on demodulated data from the first receive signal.

16. The system of claim 14, wherein the frequency-domain relationship comprises a ratio of a frequency-domain representation of the first receive signal to a frequency-domain representation of the estimated first transmit signal.

17. The system of claim 13, wherein the plurality of transmit signals comprises round-trip time (RTT) packets.

18. The system of claim 13, wherein combining the first frequency-domain channel response and the second frequency-domain channel response comprises:
determining a first line of best fit representing the first frequency-domain channel response over a first frequency band associated with the first carrier frequency;
determining a second line of best fit representing the second frequency-domain channel response over a second frequency band associated with the second carrier frequency;
applying an offset to at least one of the first line of best fit and the second line of best fit to reduce a phase discontinuity at a boundary between the first frequency band and the second frequency band; and
joining, after applying the offset, the first line of best fit and the second line of best fit across the first frequency band and the second frequency band.

19. The system of claim 13, wherein comparing the estimated channel model with the independently derived channel model comprises detecting that a difference in at least one of a channel phase, channel slope, channel group delay, and channel amplitude between the estimated channel model and the independently derived channel model exceeds a threshold indicative of channel manipulation.

20. A method of securing a communication channel, the method comprising:
receiving a plurality of receive signals resulting from propagation of a plurality of transmit signals over the communication channel, the plurality of transmit signals including at least a first transmit signal at a first carrier frequency and a second transmit signal at a second carrier frequency different from the first carrier frequency, the plurality of receive signals including at least a first receive signal resulting from propagation of the first transmit signal over the communication channel and a second receive signal resulting from propagation of the second transmit signal over the communication channel;
estimating, based on at least the first receive signal, a first frequency-domain channel response associated with the first carrier frequency;
estimating, based on at least the second receive signal, a second frequency-domain channel response associated with the second carrier frequency;
generating an estimated channel model by combining the first frequency-domain channel response and the second frequency-domain channel response into a unified frequency-domain channel response characterizing channel behavior across a frequency range spanning at least the first carrier frequency and the second carrier frequency;
obtaining an independently derived channel model for the communication channel; and
comparing the estimated channel model with the independently derived channel model.
